(19) United States
(12) Patent Application Publication
(10) Pub. No.: US 2020/0102254 A1
(43) Pub. Date: Apr. 2, 2020

(54) BIOFERTILIZER AND METHODS OF MAKING AND USING SAME

(71) Applicant: President and Fellows of Harvard College, Cambridge, MA (US)

(72) Inventors: Kelsey Sakimoto, Cambridge, MA (US); Daniel G, Nocera, Winchester, MA (US); Pamela Ann Silver, Cambridge, MA (US); Chong Liu, Cambridge, MA (US); Brendan Cruz Colon, Cambridge, MA (US)

(73) Assignee: President and Fellows of Harvard College, Cambridge, MA (US)

(21) Appl. No.: 16/614,133

(22) PCT Filed: May 17, 2018
(86) PCT No.: PCT/US2018/033170

§ 371 Date: Nov. 15, 2019

Related U.S. Application Data
(60) Provisional application No. 62/507,509, filed on May 17, 2017.

(51) Int. Cl. C05F 17/20; C25B 1/04; C25B 1/00; C25B 11/04; C05F 11/08

(52) U.S. Cl. CPC C05F 17/20; C25B 1/04; C05F 11/08; C25B 11/0478; C25B 1/003

(57) ABSTRACT

The disclosure provides a bioreactor system for conducting nitrogen fixation with renewable electricity to produce an engineered soil microbiome enriched in ammonia and carbon. The disclosure further provides an inorganic-biological hybrid bioreactor system that couples the generation of H₂ by electricity-dependent H₂O-splitting with the nitrogen-fixing capabilities of autotrophic, N₂-fixing microorganisms to cultivate NH₃-enriched and/or carbon-enriched biomass. The disclosure also provides methods for using NH₃-enriched and/or carbon-enriched biomass for applications, such as, biofertilizers for improving the characteristics and performance of soils, e.g., to enhance the yield of agricultural crops. The disclosure further provides biofertilizers, as well as engineered soils and seeds augmented with a biofertilizer.

### RELATED APPLICATIONS AND INCORPORATION BY REFERENCE

This application claims priority to U.S. Provisional Patent Application Ser. No. 62/507,509, filed on May 17, 2017 entitled “AMMONIA SYNTHESIS METHODS AND SYSTEMS” and hereby incorporates its entire contents herein by reference. This application also refers to International Application No. PCT/US2017/037447 entitled “AMMONIA SYNTHESIS METHODS AND SYSTEMS,” filed on Jun. 14, 2017 and published as WO 2018/009315 A1 on Jan. 11, 2018, the entire contents of which are hereby incorporated by reference. This application still further refers to International Application No. PCT/US2016/051621 entitled “CARBON FIXATION SYSTEMS AND METHODS,” filed Sep. 14, 2016 and published as WO 2017/048773 A1 on Mar. 23, 2017, the entire contents of which are hereby incorporated by reference.

### GOVERNMENT LICENSE RIGHTS

This invention was made with government support under Grant N00014-11-1-0725 awarded by the Office of Naval Research Multidisciplinary University Research Initiative, and Grant FA9550-09-1-0689 awarded by The Air Force Office of Scientific Research. The government has certain rights in the invention.

### FIELD

The disclosure relates biofertilizers and methods for making same. The disclosure further relates to a bioreactor system for conducting nitrogen fixation with renewable electricity to produce an engineered biofertilizer enriched in ammonia and carbon, and to the use of the biofertilizer to enrich soils and/or soil microbiomes, and to enhance crop yields and other characteristics.

### BACKGROUND

The reduction of N₂ into NH₃ is essential for maintaining the global biogeochemical nitrogen (N) cycle (1). Fixed, organic nitrogen in food, biomass, and waste is eventually returned to the atmosphere as N₂ through biological denitrification. As a ubiquitous, synthetic nitrogenous fertilizer, NH₃ synthesized from atmospheric N₂ via the Haber-Bosch process has been added to agricultural soils to drive global increases in crop yields (2). Despite its high efficiency and scalability, the Haber-Bosch process unsustainably employs natural gas as a H₂ feedstock, operates at high temperatures and pressures, and relies on a significant infrastructure for NH₃ distribution (1).

By contrast, a distributed approach toward NH₃ synthesis from renewable energy sources at ambient conditions would enable on-site deployment and reduce CO₂ emissions. To this end, significant effort has been devoted to promoting the reduction of nitrogen to NH₃ with the use of transition metal catalysts (3-5), electrocatalysts (6), photocatalysts (7-11), purified nitrogenases (N₂ases) (11, 12), and heterotrophic diazotrophs (13, 14), potentially powered by renewable energy and operating at ambient conditions. Such approaches, however, typically use sacrificial reductants to drive conversion at low turnover or suffer poor selectivity.

More broadly, the limitations of synthetic NH₃ as a fertilizer have become apparent in recent years as decreasing efficiency of fertilizer use, coupled to environmental damage, has provided an imperative for the development of sustainable biofertilizers (15, 16). Soil microorganisms facilitate efficient nutrient uptake and recycling (17), pathogen resistance (18), environmental adaptation (19), and long-term soil productivity (15). However, the diminished yields of organic/sustainable agriculture have demonstrated that nutrient cycling alone, accentuated by natural variabilities in the soil microbiome, is insufficient to meet an increasing worldwide food demand (20). Attempts to establish robust, productive soil communities through microbial inocula have shown promise (21), but the limited natural flow of organic carbon into these soils results in a bottleneck in the biological activity of these largely heterotrophic biomes (22).

### SUMMARY

The disclosure relates to a bioreactor system for conducting distributed nitrogen fixation with renewable electricity to produce an engineered biofertilizer enriched in ammonia and carbon, and to the use of the biofertilizer to enrich soils and/or soil microbiomes, and to enhance crop yields and other characteristics. The disclosure further relates to an inorganic-biological hybrid bioreactor system that couples the generation of H₂ by electricity-dependent H₂O-splitting with the nitrogen-fixing capabilities of autotrophic, N₂-fixing microorganisms to cultivate NH₃-enriched and/or carbon-enriched biomass. Still further, the disclosure relates to methods, materials, and systems for carrying out an electro-augmented nitrogen cycle. The disclosure also relates to the use of NH₃-enriched and carbon-enriched biomass for applications, such as, biofertilizers for improving the characteristics and performance of soils, e.g., to enhance the yield of agricultural crops.

The inventors have demonstrated the synthesis of NH₃ from N₂ and H₂O at ambient conditions in a single reactor by coupling hydrogen generation from catalytic water splitting to a H₂-oxidizing bacterium Xanthobacter autotrophicus, which performs N₂ and CO₂ reduction to furnish solid biomass which may function as an engineered biofertilizer. Living cells, e.g., X. autotrophicus or a biomass comprising X. autotrophicus cells may be directly applied as a biofertilizer to improve growth of radishes, a model crop plant, by up to ˜1,440% in terms of storage root mass. The NH₃ generated from nitrogenase (N₂ase) in cells, such as X. autotrophicus, can be diverted from biomass formation to an extracellular ammonia production with the addition of a glutamate synthetase inhibitor. This approach can be powered by renewable electricity, enabling the sustainable and selective production of ammonia and biofertilizers in a distributed manner.

In still another embodiment, the specification provides a method of producing a biofertiziler in a bioreactor, comprising: (a) generating H₂ in a bioreactor comprising one or more microorganisms which express a hydrogenase and a nitrogenase, wherein the bioreactor further comprises a source of N₂ and CO₂; and (b) growing the one or more microorganisms in the bioreactor in the presence of the H₂ to produce a biomass.

In various embodiments, the biomass is enriched with ammonia. In various embodiments, the concentration of ammonia in the biomass is 1-1000 pmol, 0.5-100 nmol, 50-1000 nmol, 0.5 μmol-100 μmol, 50 μmol-1000 μmol, 0.5 mmol-100 mmol, or more.

In certain embodiments, the biomass is enriched with at least between 1-2-fold, or 2-4-fold, or 4-8-fold, or 8-16-fold, or 16-32-fold the ammonia levels found in a native soil microbiome.

In various other embodiments, the biomass is enriched with a carbon energy source, e.g., polyhydroxyalkanoic acid (PHA). In certain embodiment, the PHA is polyhydroxybutyric acid (PHB).

The bioreactor can be a single-chamber bioreactor, e.g., as shown in FIG. 7A. However, the bioreactor system disclosed herein embraces any suitable configuration as would be envisioned by one or ordinary skill in the art which would be sufficient to perform the functions herein described.

The bioreactor can also be a multi-chamber bioreactor, e.g., as shown in FIG. 7B. However, the bioreactor system disclosed herein embraces any suitable configuration as would be envisioned by one or ordinary skill in the art which would be sufficient to perform the functions herein described.

In some embodiments, the one or more microorganisms are of a single type, e.g., where the microorganisms comprise a single culture of the same isolate, species, or otherwise.

In other embodiments, the one or more microorganisms are of two or more types, e.g., where the microorganisms comprise a co-culture of more than one isolate, species, or otherwise.

The disclosed system also contemplates bioreactor cultures wherein the hydrogenase and a nitrogenase are expressed from the same microorganism cell.

The disclosed system may also utilize a bioreactor with co-cultures wherein the hydrogenase and a nitrogenase are expressed from difference microorganisms.

In various embodiments, the microorganism can be bacteria, archea, or fungi.

In certain embodiments, the one or more microorganism is X. autotrophicus. In other embodiments, the one or more microorganisms can include Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

In various embodiments, the N₂ and CO₂ are obtained from the environment. The bioreactor can comprise a means to obtain the N₂ and CO₂ from the environment, e.g., gas tubing and/or a pump to push or pull gases.

In various embodiments, the step of generating H₂ in the bioreactor is by water-splitting.

The water-splitting can be powered by electricity.

The water-splitting can be powered directly in the format of a buried junction (i.e., artificial leaf)

The electricity can be renewable electricity, such as solar or sunlight based electricity and can be generated by one or more photovoltaic cells.

The bioreactor in various embodiments can comprise photovoltaic cells.

The bioreactor may also comprise an anode and a cathode, i.e., a pair of electrodes, that are capable of catalyzing water-splitting in the presence of a voltage. The electrodes may comprise or be prepared from one or more catalysts (e.g., cobalt-phosphate (Co-Pi) and cobalt-phosphorous (Co—P)).

The anode can be an oxygen evolving electrode (OER). The cathode can be a hydrogen evolving electrode (HER). The anode and/or the cathode can be coated with a catalyst.

In some embodiments, the catalyst is capable of minimizing the production of reactive oxygen species (ROS) during water-splitting.

In some embodiments, ROS resistant bacteria may be employed.

In certain embodiments, the bioreactor comprises electrodes comprising Co-Pi and Co—P water-splitting catalysts.

In other embodiments, the method can comprise inhibiting the assimilation of ammonia into biomass. In various embodiments, ammonia assimilation into biomass is inhibited by inhibiting the activity of glutamine synthetase. The glutamine synthetase inhibitor can be any suitable inhibitor, including methionine sulfoximine and phosphinothricin.

In other embodiments, the method further involves the step of harvesting the biomass for use as a biofertilizer.

In various embodiments, the biomass is a microbial liquid suspension produced in a bioreactor described herein.

In other embodiments, the biomass is solid microbial material produced in a bioreactor described herein.

In various embodiments, the disclosure provides a biofertilizer comprising biomass produced by and obtained from a bioreactor of the disclosure. In certain embodiments, the biomass may be in form of a liquid, e.g., a microbial liquid suspension. In certain other embodiments, the biomass may be in the form of a solid. In various preferred embodiments, the biomass comprises a microorganism capable of H₂-oxidation coupled with N₂ and CO₂ reduction to form a biomass (e.g., a liquid suspension or a solid biomass). In certain embodiments, the assimilation of ammonia (formed from the reduction of N₂ by nitrogenase expressed by the microorganism) can be diverted from being metabolically channeled into biomass formation by inhibiting glutamine synthetase (GS) (which blocks ammonia assimilation), thereby causing the accumulated intracellular ammonia to be transported out of the cell into the extracellular environment, i.e., the media of the bioreactor. Accordingly, in certain embodiments, the biofertilizer may comprise the biomass (i.e., the bacterial cells themselves) and the liquid culture or media environment that comprises the released amounts of extracellular ammonia.

In certain embodiments, the biofertilizer may be directly applied, added, or otherwise mixed with soil. In various preferred embodiments, the biofertilizer comprises X. autotrophicus cells.

In other embodiments, the biomass produced in the bioreactor disclosed in the specification can be used as a biofertilizer for applications that include enhancing a soil microbiome (e.g., by mixing the biofertilizer directly with existing soil microbiome in the soil, or by adding the biofertilizer to the soil). The biofertilizer can be added to soil or soil microbome in situ, i.e., directly in the field or on a farm. The biofertilizer can also be combined with naturally occurring soil ex vivo, i.e., by removing soil desired to be treated, mixing it with an effective amount of the biofertilizer, and returning it to the location from where the soil was removed.

Methods of enriching soils and/or soil microbiomes may also comprise additionally contacting the soil microbiome or soil with PHB-producing bacteria, such as R. eutorpha. Without being bound by theory, it is thought the PHB provides additional carbon-based energy source to “feed” the existing naturally occurring soil microbiome.

Methods of enriching soils and/or soil microbiomes may also comprise additionally contacting the soil microbiome or soil with a microorganism that expresses both a nitrogenase and accumulates PHB, such as X. autotrophicus. Without being bound by theory, it is thought the microorganism when directly added to the soil provides additional carbon-based energy source to “feed” the existing naturally occurring soil microbiome.

In other embodiments, the biomass produced in the bioreactor disclosed in the specification can be used as a biofertilizer for applications that include increasing crop yields and/or enhancing one or more plant characteristics (e.g., by mixing the biofertilizer directly with existing soil microbiome in the soil, or by adding the biofertilizer to the soil). The biofertilizer can be added to soil or soil microbome in situ, i.e., directly in the field or on a farm. The biofertilizer can also be combined with naturally occurring soil ex vivo, i.e., by removing soil desired to be treated, mixing it with an effective amount of the biofertilizer, and returning it to the location from where the soil was removed.

Methods of increasing crop yields and the like may also comprise additionally contacting the soil microbiome or soil with PHB-producing bacteria, such as R. eutorpha. Without being bound by theory, it is thought the PHB provides additional carbon-based energy source to “feed” the existing naturally occurring soil microbiome.

Methods of increasing crop yields and the like may also comprise additionally contacting the soil microbiome or soil with a microorganism that expresses both a nitrogenase and accumulates PHB, such as X. autotrophicus. Without being bound by theory, it is thought the microorganism when directly added to the soil provides additional carbon-based energy source to “feed” the existing naturally occurring soil microbiome and result in increased crop yields and other improved plant characteristics (e.g., faster growth, larger-sized fruits and vegetables).

Crops and plants that may be treated by the biofertilizer disclosed herein include, but are not limited to, wheat, corn, soybean, rice, potatoes, sweet potatoes, cassava, sorghum, yams, and plantains.

The disclosure further relates in various embodiments to a system for generating a biofertilizer, comprising a bioreactor, culture medium, at least one pair of water-splitting electrodes capable of generating H₂ from water and an applied electrical current, and a culture of one or more microorganisms which express a hydrogenase and a nitrogenase and are capable of metabolically coupling H₂-oxidation with nitrogen-fixation to produce NH₃.

In various embodiments, the bioreactor can comprise a source of renewable electricity, such as solar power.

In various embodiments, the bioreactor comprises one of more photovoltaic cells capable of providing solar-based electricity to the water-splitting electrodes at a sufficient voltage.

In various embodiments, the sufficient voltage is at least between 0.1 V and 0.2 V, 0.4 V, 0.8 V, 1.0 V, 2.0 V, 3.0 V, 4.0 V, 5.0 V, 6.0 V, 7.0 V, 8.0 V, 9.0 V, 10.0 V, 20.0 V, 30.0 V, 40.0 V, 50.0 V, 60.0 V, 70.0 V, 80.0 V, 90.0 V, and 100.0 V.

In certain embodiments, the system for producing a biofertilizer may comprise X. autotrophicus.

In certain other embodiments, the system for producing a biofertilizer may comprise Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

In various embodiments of the system for producing a biofertilizer, the NH₃ is produced intracellularly and becomes assimilated into biomass.

In various other embodiments of the system for producing a biofertilizer, the NH₃ is produced intracellularly but does not become assimilated into biomass due to the inhibition of glutamine synthetase. In such embodiments, the system may comprise one or more inhibitors of glutamine synthetase. In such embodiments, the NH₃ may be transferred from the intracellular environment to the extracellular environment, i.e., accumulates in the culture medium.

In various other embodiments of the system, the bioreactor further comprises a source of N₂ and CO₂, e.g., via gas lines.

In various embodiments of the system, the one or more microorganisms undergo growth in the bioreactor to form a biomass. The biomass can in some embodiments remain as a microbial liquid suspension. In other embodiments, the biomass can be a solid biomass.

In other aspects, the disclosure provides a biofertilizer comprising an effective amount of X. autotrophicus for enhancing a soil microbiome. The biofertilizer, in some embodiments, can further comprise an effective amount of a PHB-producing organism which does not also fix nitrogen.

In other aspects, the disclosure provides a biofertilizer comprising an effective amount of X. autotrophicus for increasing crop yields. The biofertilizer, in some embodiments, can further comprise an effective amount of a PHB-producing organism which does not also fix nitrogen.

In still other aspects, the disclosure provides a plant seed comprising a coating of an effective amount of X. autotrophicus.

In other embodiments, the plant seed may be coated with an effective amount of a biofertilizer prepared in accordance with the methods and systems disclosed herein.

The plant seed can from any plant. For example, the plant seed can be a radish plant seed. The plant seed a wheat, corn, soybean, rice, potato, sweet potato, cassava, sorghum, yams, radish, or plantain plant seed.

The disclosure also provides a method for improving crop yield comprising preincubating a plant seed with an effective amount of X. autotrophicus before sowing the plant seed.

In other aspects, the disclosure provides a method for improving crop yield comprising preincubating a plant seed with an effective amount of a biofertilizer produced in accordance with the method of claim 1 before sowing the plant seed.

In still other aspects, the disclosure relates to augmented soils for growing plants or crops wherein the soils are augmented with an effective amount of a biofertilizer as described herein. In certain embodiments, the biofertilizer comprises X. autotrophicus. In other embodiments, the biofertilizer comprises Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof. In still other embodiments, the soils are combined with biofertilizer prepared in accordance with a method or system described herein.

In certain embodiments, the augmented soils are further combined with R. eutropha or another PHB-producing microorganism.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 provides various schematics and images describing various embodiments of the biofertilizer-generating bioreactor described herein and its use to enrich the soil microbiome to improve soil quality and agriculture yield. (A) provides a schematic of the electro-augmented nitrogen cycle that comprises a bioreactor system for generating biofertilizer biomass (enriched with NH₃ and/or carbon (e.g., polyhydroxybutyrate)) through H₂-fueled nitrogen fixation and CO₂ reduction metabolic processes (e.g., Calvin cycle) in a bioreactor culture of microorganisms (e.g., X. autotrophicus). As depicted in the bioreactor, a constant voltage (Eₐₚₚₗ) is applied between CoPᵢ OER (annode, left electrode) and Co—P HER (cathode, right electrode) electrodes which drives water splitting to produce H₂. In various embodiments, the electricity is renewable electricity, e.g., sunlight. As further shown in (A), the H₂ases (hydrogenases) of an autotrophic microorganism, e.g., X. autotrophicus, oxidizes the generated H₂, driving both CO₂ reduction in the Calvin cycle (via the RuBisCo enzyme) and N₂ fixation to generate NH₃. The generated NH₃ is typically incorporated into biomass (pathway “1”) within the cells of the bioreactor, but can also diffuse extracellularly inside the bioreactor by inhibiting biomass formation (pathway “2”) (for example, a glutamine synthetase inhibitor may be added to the bioreactor). This process can be powered by renewable, sunlight-derived electricity and by taking N₂ and CO₂ from the environment. The bioreactor culture of microorganisms, e.g., X. autotrophicus, forms an electro-generated biofertilizer which may be harvested from the bioreactor and then added to soils to improve soil properties (e.g., to improve soil microbiome) and consequently plant health, growth and/or yield. The pathway of natural N cycling/N₂ fixation is indicated, with line width denoting relative flux of these pathways. Red pathways indicate carbon cycling; blue pathways indicate N cycling. (B) provides a parallel schematic of a biofertilizer-generating bioreactor comprising an OER (“oxygen evolution reaction”) and HER (“hydrogen evolution reaction”) electrode, a current (Eₐₚₚₗ), active electro-induced H₂ production, and H₂-fueled nitrogen fixation (conversion of N₂ to NH₃ by microbial-expressed nitrogenases) and CO₂ reduction via the Calvin cycle into biomass, as described and shown in (A). In (C), the electro-induced reaction of water-splitting is depicted. For each of two molecule of water, the OER anode (e.g., CoPi) catalyzes the formation of four protons and a molecule of oxygen. The four protons are then catalyzed to form two molecules of H₂ at the HER cathode (e.g., Co—P alloy). The electrodes can be coated with materials which limit or eliminate the production of harmful reactive species. (D) depicts one embodiment of the use of the biofertilizer-generating bioreactor described in (A) in the application of healthy microbiome maintenance to sustainably improve agricultural yields and reliability. A typical naturally-occurring soil microbiome is depicted at the left of the drawing. As the soil over time and use becomes depleted of organic carbon (low soil organic carbon (SOC)), the soil develops a “starved soil microbiome.” This condition can be rectified and even improved over a healthy naturally-occurring soil by introducing the electro-generated biofertilizer into the soil, thereby providing a healthy soil microbiome, and thereby enhancing plant-beneficial functions. (E) depicts an embodiment of the electro-induced biofertilizer bioreactor system, conceptualized as a “bionic leaf,” wherein high-efficiency photovoltaics take the place of natural photosynthesis in plants, to electrically drive the formation of H₂ vis-à-vis water splitting, which then drives nitrogen fixation and CO₂ reduction through the Calvin cycle into biomass. Overall, the efficiency of the electro-induced biofertilizer reactor system is about 10% in the product of biomass, as compared to less than 1% efficiency in the production of microbial biomass in the naturally occurring plant microbiome. (F) similarly depicts the electro-induced nitrogen cycle driven by the bioreactor of the disclosure, which includes the production of a more robust soil microbiome.

FIG. 2 depicts N₂ reduction on the CoPi|Co—P|X. autotrophicus hybrid bioreactor system. (A) plots the OD₆₀₀, the concentration of total N content (“Ntotal”), and soluble N content (“N_{soluble}”) are plotted against the amount of charge passed through duration of experiments (days 0-5). n≥3; error bars denote SEM. (B) depicts the change of Ntotal and OD₆₀₀ under different experimental conditions in 5-day experiments. “No AEM” indicates a single-chamber reaction without an anion-exchange membrane. *, not applicable because no bacteria were introduced. n≥3; error bars denote SEM. (C) depicts the results of a qualitative gas chromatography comparison of the whole-cell acetylene reduction with 100-ppm standard sample. t, incubation time after C₂H₂ injection. (D) Linear scan voltammetry (line, 10 mV s−1) and chronoamperometry (circle, 30-min average) of Co—P HER cathode in X. autotrophicus medium, iR corrected. The thermodynamic values of HER and NRR (EHER, ENRR) are displayed. (E) Contributions of voltage drops within the applied Eₐₚₚₗ=3.0 V, as calculated SI Appendix. ηHER and ηOER, overpotentials of HER and OER. a.u., arbitrary units. (F) depicts N₂ reduction on the CoPi|Co—P|X. autotrophicus hybrid bioreactor system in a separate experiment. The graph plots the OD₆₀₀, the concentration of total N content (“Nₜₒₜₐₗ”), and soluble N content (“N_{soluble}”) are plotted against the amount of charge passed through duration of experiments (days 0-5). n≥3; error bars denote SEM.

FIG. 3 is a schematic diagram of NH₃ production in an extracellular media in a bioreactor culture wherein intracellular glutamine synthetase is inhibited (e.g., by adding a GS inhibitor). By inhibiting GS, the nitrogenase-produced ammonia (e.g., formed by the electro-driven process of a bioreactor of the disclosure) does not become assimilated into the biomass through glutamate synthesis. Instead, the ammonia becomes transported out of the cell into the extracellular or medium of the culture.

FIG. 4 shows the production of ammonia in extracellular media. Shown is a graph of OD₆₀₀, the amount of charge passed through, the concentration of total nitrogen content (Nₜₒₜₐₗ) and NH₃/NH₄⁺ extracellular content (NH₃) plotted against time (i.e., during a 5-day bioreactor experiment).

FIG. 5 demonstrates the plant-beneficial effects of applying the electro-induced biomass or biofertilizer comprising X. autotrophicus formed in a bioreactor of the disclosure to an exemplary crop, e.g., radishes. (A) Yields of radish storage roots from biofertilization with different amounts of X. autotrophicus biomass/biofertilizer (X. a) (n=12 radishes per treatment) in as-supplied potting media. No X. a: OD₆₀₀=0, Low X. a: OD₆₀₀=0.03, Med. X. a: OD₆₀₀=0.3, High X. a: OD₆₀₀=3.0, applied at t=7, 14 d. Corresponding dry masses and shoot masses are given in FIG. 10A-C. Significance (P value) calculated by a two-tailed, heteroscedastic Student's t test. (B) Photographs of radishes from (A). (C) Extracellular NH4+ release from live and dead X. autotrophicus biofertilizer after 7 d in 50 mM NaCl starvation conditions. Dead cells were prepared by 70% EtOH sterilization. 0×: OD₆₀₀=0, 1×: OD₆₀₀=0.5, 10×: OD₆₀₀=5 (n=3 biological replicates). (D) Growth yields of radish seeds with and without seed sterilization by hypochlorite treatment, and preinoculation with and without X. autotrophicus (n=15) biofertilizer. Experiments conducted in sterilized potting medium. (E) Growth yields of radish seeds sterilized and inoculated with X. autotrophicus, B. japonicum, V. paradoxus, or no inoculation, fertilized at t=7, 14 d with X. autotrophicus biofertilizer in sterilized potting medium. All error bars indicate the SD centered on the arithmetic mean.

FIG. 6 shows the production of ammonia in extracellular media in coordination with FIGS. 3 and 4. The ¹H NMR spectrum evolution of generated NH₄⁺ under ¹⁵N-enriched and naturally abundant N₂. Time counted as the duration after providing ¹⁵N₂. * denotes resonances for the internal standard of H—CON(CH₃)₂. Gln, glutamine; Glu, glutamic acid.

FIG. 7 is a photograph depicting different embodiments of a bioreactor experimental set-up. (A) shows a single-chamber bioreactor electrochemical cell having a two-electrode configuration. The flow pattern of the gas inlet and outlet are displayed. (B) shows a dual-chamber bioreactor electrochemical cell having a three-electrode configuration. An anion-exchange membrane (AEM) was installed to separate the two chambers. WE, working electrode; CE, counter electrode; RE, reference electrode.

FIG. 8 depicts various aspects of bioelectrochemical assays that can be used to assay cells. (A) Schematics of colorimetric assay for fixed nitrogen. The definitions of Nₜₒₜₐₗ, N_{soluble}, and N_{NH3} are listed in Methods herein in the Examples. (B) Spot assay of Co₂⁺-containing X. autotrophicus plates. Dilutions of X. autotrophicus cultures were exposed to different Co₂⁺ concentrations on minimal media plates for at least three days. At a 1/1000 dilution, the toxicities of transition metals are visible when the concentration of Co²⁺ is higher than 50 μM (IC⁵⁰˜50 μM). (C) i-V characteristics of the CoPi|Co—P catalyst system in different media. Linear scan voltammetry (line, 10 mV sec−1) and chronoamperometry (circle, 30 min average) of the CoPi|Co—P water-splitting catalyst system (i.e., the bioreactor) are displayed in medium for the growth of Ralstonia (blue) and Xanthobacter (red). The total concentrations of phosphate buffer in these two solutions are 36 mM for Ralstonia medium and 9.4 mM for Xanthobacter medium.

FIG. 9 shows H2 on X. autotrophicus growth. (A) microbial growth comparison under different H₂-feeding methods. The OD₆₀₀ in the hybrid device (blue) and the amount of charge passed through (yellow) are plotted versus the duration of experiments. The OD₆₀₀ under a H₂/02/CO₂/N₂ mixture (10/4/10/76) (green, “high [H₂]”) was plotted for comparison. Experiments were conducted with nitrogen-free inorganic minimal medium. Here the charge and OD₆₀₀ values of hybrid system in nitrogen-free medium are the same as the data shown in FIG. 2A. (B) shows COPASI simulation results. Simplified biochemical models are analyzed to provide a qualitative understanding for the difference in microbial growth between water-splitting biosynthetic systems (red, “water splitting”) and under 10% H₂ (yellow, “High [H₂]”). The biochemical model involves hydrogenases (reaction 1), nitrogenases (reaction 2), and the other anabolisms (reaction 3).

FIG. 10 provides results for X. autotrophicus radish growth yields. (A) Dry masses for data presented in FIG. 5A (top graph). Fresh ((A), bottom graph) and dry ((B), top graph) masses of storage root and shoots for data presented in FIG. 5A. (B) (lower graph) Effect of B. japonicum and V. paradoxus preinoculation/biopriming on sterilized and unsterilized radish seeds. Significance (p value) calculated by a two-tailed, heteroscedastic Student's t-test. All error bars indicate the standard deviation centered on the arithmetic mean.

FIG. 11 is a characterization of X. autotrophicus biofertilizer. (A) Viability (measured by CFU mL−1) and NH₄⁺ and PO₄³⁻ release under starvation conditions. (B) PO₄³⁻ release under varying combinations of live and dead X. autotrophicus, complementary to FIG. 5B. (C), (D) Growth yields for unfertilized, unsterilized radishes grown in new or previously used potting media, w/and w/o autoclaving. (E) Radish total mass yields grown in reused soil w/and w/o previous X. autotrophicus biofertilization. (F) Growth of X. autotrophicus in DUM at different dilutions in deionized water under an autotrophic atmosphere as detailed in the Methods. (G) Relative growth of X. autotrophicus in DUM of different N and P loadings after 7 days autotrophic growth. All points plotted as the arithmetic mean and the standard deviation of n=3 biological replicates.

FIG. 12 depicts the enhancement of soil microbiomes with PHB-containing microorganisms. (A) depicts the electro-augmented nitrogen cycle of FIG. 1A, further comprising PHB-accumulating bacteria, which release carbon-stores that feed the microbiome for plant-beneficial function. (B) is an electron micrograph of X. autotrophicus showing stores of nitrogen and phosphorus inclusions (“PP” or double-starred) and stores of PHB inclusion bodies (“P” or single-starred). The PHB inclusion bodies function as an onboard “fat” reserve and energy source for itself as well as for other soil microbiome organisms once release from the cell. X. autotrophicus grows on H₂/CO₂ and fixes atmospheric nitrogen to ammonia. (C) shows the results of adding Ralstonia eutropha cells to the microbiome as an additional supplement. R. eutropha is a PHB-accumulating organism (i.e., PHB-rich) but does not fix nitrogen (i.e., nitrogenase-free), unlike X. autotrophicus. Addition of R. eutropha cells was shown to produce a 30% increase in the growth of radishes, but only in the presence of plant-beneficial fungal co-inoculant (mycorrhizal co-inoculant). Thus, PHB-containing organisms provide energy to fungi and other soil microbes, but is not plant-beneficial on its own. It was found that higher plant growth yields are achieved when the same inoculant microorganism contains both the PHB-function and a nitrogenase system for nitrogen fixation, e.g., as with X. autotrophicus.

### DEFINITIONS

As used herein, a “glutamine synthetase” (or “GS”) takes its meaning as accepted in the art. It is an enzyme catalyzing formation of glutamine from glutamate and ammonium ion, is one of the most important enzymes in nitrogen metabolism. Due to glutamine synthetase activity, inorganic nitrogen is incorporated in the cell metabolism and is further used in biosynthesis of several highly important metabolites.

As used herein, an “inhibitor of glutamine synthetase” takes its meaning as accepted in the art. The currently described inhibitors of GS can be divided into two broad categories. The first group are the small and highly polar amino acid analogues exemplified by two of the most widely used GS inhibitors, methionine sulfoximine (MSO), and phosphinothricin (PPT). These inhibitors target the amino acid-binding site, which is highly conserved in both bacterial and eukaryotic GSs. Consequently, selectivity issues may arise with this type of compound [13]. Inhibitors in the second class are typically larger, more hydrophobic heterocycles that compete with ATP. Importantly, the nucleotide-binding site is less conserved, and so inhibition via binding at this site is more likely to result in selective inhibitors. Further details of GS inhibitors can be found in the art, for example, in Mowbray et al., Molecules, 213, 19, 13161-13176, which is incorporated herein by reference.

As used herein, the term “effective amount” in terms of a biofertilizer will depend upon a variety of factors, including percent viability of cells in the biofertilizer, concentration of cells in the biofertilizer, and the levels of nutrients, including ammonia and carbon sources (e.g., PHB), and whether the biofertilizer is in the form of a liquid cell suspension or comprises a solid biomass component. A person of ordinary skill in the art will be able to determine an effective amount taking into account these variables. For purposes of the instant disclosure, an effective amount of a biofertilizer means an amount of the biofertilizer that is sufficient to result in an enhanced property or characteristic of a soil microbiome and/or a crop or plant that is statistically greater than the same property or characteristic in the absence of the biofertilizer, such as, increased crop yield, increased fruit or vegetable yield or root storage mass, increased carbon and/or nitrogen availability in the microbiome. Preferably, the property or characteristic (e.g., crop yield) enhanced by the biofertilizer should be observed with at least a 5%, or preferably at least a 6%, or 7%, or 8%, or 9%, or 10%, or 25%, or 50%, or 75%, or 100%, or 200%, or 300%, or 400%, or 500%, or 1000%, or 1250%, or 1500%, or 2000%, or more increase over the same property or characteristic established in the absence of the biofertilizer.

As used herein, the term “microbiome” refers to the microorganisms living in a particular environment, including in the soil surrounding and/or interacting with the root of a plant.

As used herein, the term “biofertilizer” refers to preparation containing living cells or latent cells of microorganisms that help plants (e.g., crop plants) grow in the soil. The term may also refer to a preparation containing living cells or latent cells of microorganisms that help to feed and/or enhance the soil microbiome.

As used herein, the term “water-splitting” is the general term for a chemical reaction in which water is separated into oxygen and hydrogen.

As used herein, the term “hydrogenase” refers to the enzyme which catalyzes the reversible oxidation of molecular hydrogen (H₂) and is typically coupled to the reduction of electron acceptors, such as oxygen, carbon dioxide, and atmospheric nitrogen (N₂), in the case of certain nitrogen-fixing bacteria which express the enzyme nitrogenase.

As used herein, the term “nitrogenase” refers to enzymes that are produced by certain specialized bacteria called nitrogen-fixing bacteria, such as cyanobacteria and Xanthobacter (e.g., X. autotrophicus), which are responsible for reducing atmospheric nitrogen (N₂) to ammonia (NH₃) as part of the nitrogen cycle.

### DETAILED DESCRIPTION

Unlike more traditional production methods, catalytic NH₃ synthesis from N₂ has been reported with transition metal complexes, electrocatalysts, photocatalysts, nitrogenase, and heterotrophic diazotrophs. However, these approaches typically provide limited turnovers and use sacrificial chemicals as reductants. Consequently, the Inventors have recognized that it may be desirable to enable a selective NH₃ synthesis from N₂ and H₂O at ambient conditions. This may help enable a distributed approach towards NH₃ synthesis at ambient conditions, which may also be integrated with different forms of power including renewable energy sources. Possible benefits associated with such a production approach may include enabling on-site production and deployment of ammonia while also reducing CO₂ emissions as compared to more traditional production methods.

In view of the above, the inventors have recognized the benefits associated with using a reactor-based arrangement including a solution with one or more types of bacteria that include one or more enzymes useful in the production of ammonia. Specifically, in one embodiment, a system for producing ammonia may include a reactor with a chamber containing a solution. The solution may include dissolved hydrogen, carbon dioxide, and nitrogen. In some embodiments, the ammonia may be stored within the biomass of the one or more types of bacteria. However, in some embodiments, the solution may also include a glutamine synthetase inhibitor in the solution which may at least partially prevent the uptake of ammonia into the biomass of the bacteria and facilitate the release of at least a portion of the ammonia extracellularly into the solution. The solution may also include one or more forms of autotrophic diazotroph bacteria in the solution. During use, the autotrophic diazotroph bacteria metabolize compounds within the solution to produce ammonia. Specifically, the bacteria may include nitrogenase, such as RuBisCO, and hydrogenase enzymes that utilize nitrogen, carbon dioxide, and hydrogenase to form the desired ammonia. Appropriate autotrophic diazotroph bacteria include Xanthobacter autotrophicus, Bradyrhizobium japonicum, or any other appropriate bacteria capable of metabolizing the noted compounds to produce ammonia.

In view of this background, the disclosure relates to a bioreactor system for conducting nitrogen fixation with renewable electricity to produce an engineered biofertilizer enriched in ammonia and carbon, and to the use of the biofertilizer to enrich soils and/or soil microbiomes, and to enhance crop yields and other characteristics. The disclosure further relates to an inorganic-biological hybrid bioreactor system that couples the generation of H₂ by electricity-dependent H₂O-splitting with the nitrogen-fixing capabilities of autotrophic, N₂-fixing microorganisms to cultivate NH₃-enriched and/or carbon-enriched biomass. Still further, the disclosure relates to methods, materials, and systems for carrying out an electro-augmented nitrogen cycle. The disclosure also relates to the use of NH₃-enriched and carbon-enriched biomass for applications, such as, biofertilizers for improving the characteristics and performance of soils and the treatment of crops, e.g., to enhance the yield of agricultural crops. The disclosure also relates to augmented soils that are enriched with the biofertilizers disclosed herein, as well as to augmented plant seeds with have been pre-treated with the biofertilizers disclosed herein prior to sowing them.

The inventors have surprisingly demonstrated the synthesis of NH₃ from N₂ and H₂O at ambient conditions in a single reactor by coupling hydrogen generation from catalytic water splitting to a H₂-oxidizing bacterium, e.g., Xanthobacter autotrophicus, which performs N₂ and CO₂ reduction to solid biomass which may function as an engineered biofertilizer. Living cells, e.g., X. autotrophicus or a biomass comprising X. autotrophicus cells may be directly applied as a biofertilizer to improve growth of radishes, a model crop plant, by up to ˜1,440% in terms of storage root mass. The NH₃ generated from nitrogenase (N₂ase) in cells, such as X. autotrophicus, can be diverted from biomass formation to an extracellular ammonia production with the addition of a glutamate synthetase inhibitor. This approach can be powered by renewable electricity, enabling the sustainable and selective production of ammonia and biofertilizers in a distributed manner.

### Bioreactor

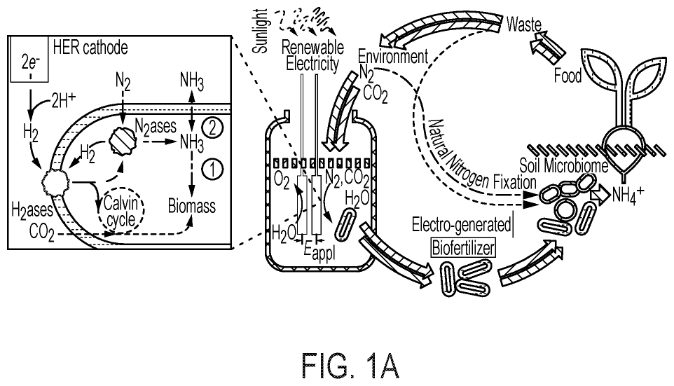

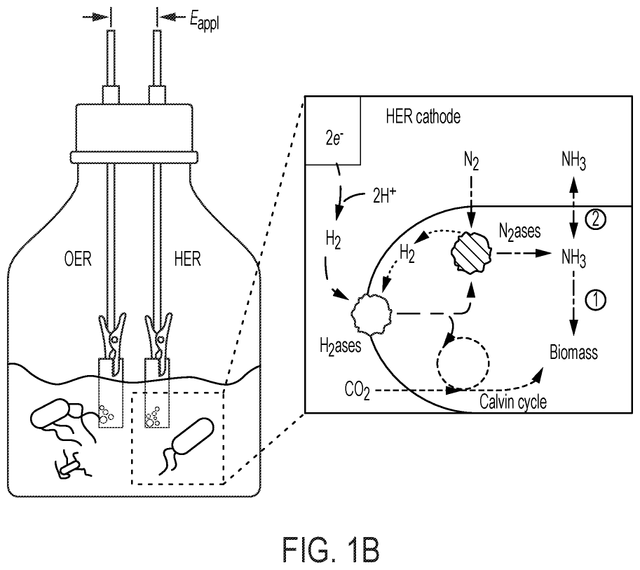

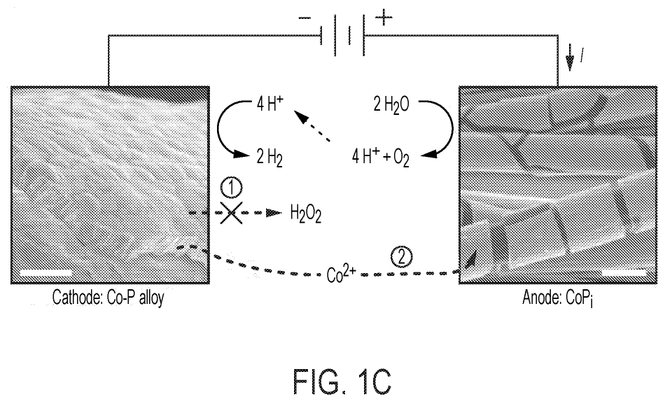

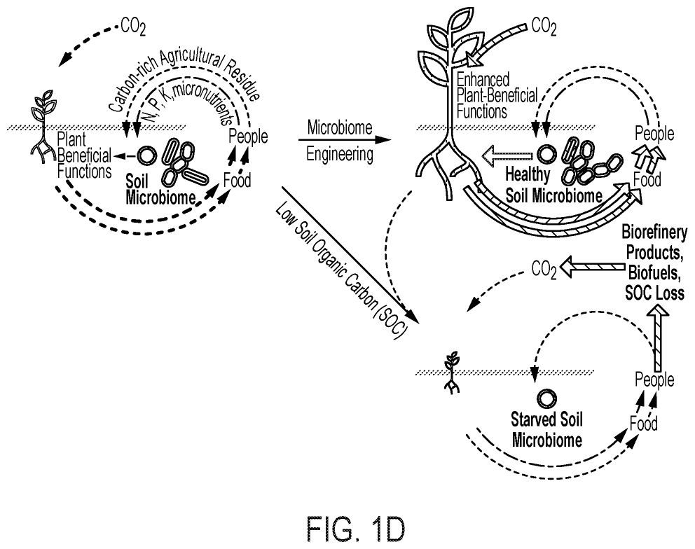

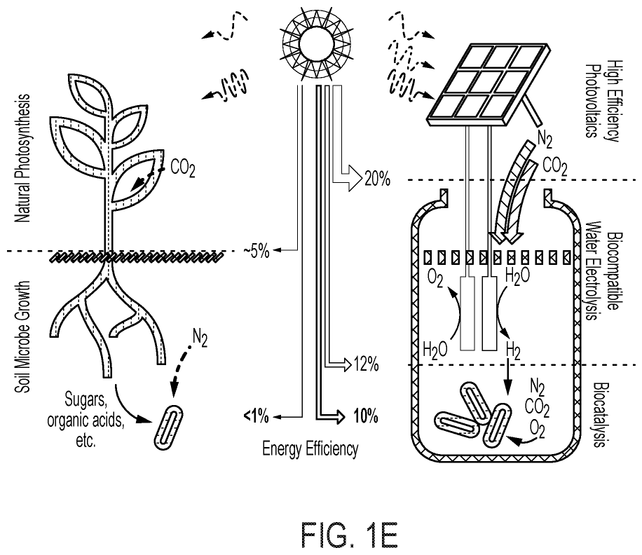

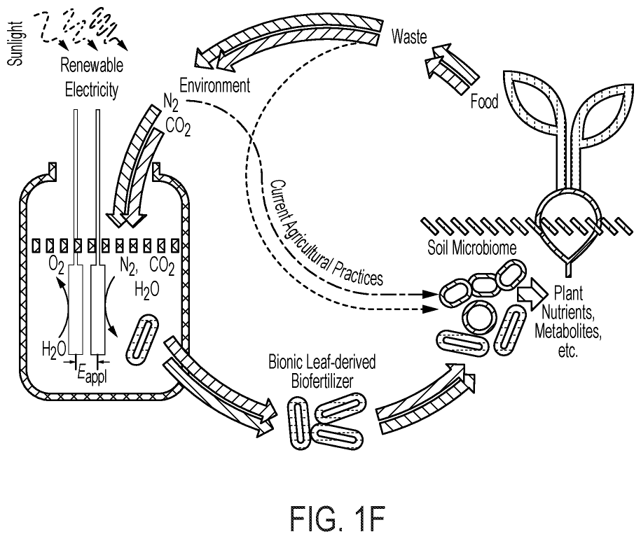

FIG. 1 outlines the general features of a bioreactor embraced by the instant disclosure. A bioreactor can comprise one or more chambers for containing and growth microorganisms, one or more pairs of electrodes capable of catalyzing a water-splitting reaction to produce hydrogen, wherein the water-splitting reaction is driven or powered by electricity. The electricity can be generated from renewable resources, e.g., sunlight or solar power. The bioreactor may also include one or more means for obtaining and/or introducing a source of nitrogen and carbon dioxide. The bioreactor also may comprise microorganisms equipped with hydrogenases for reducing the hydrogen generated from the water-splitting reaction, which then drives in metabolic coordination the fixation of the nitrogen gas to form ammonia, and the reduction of carbon dioxide through the Calvin cycle to form biomass. In certain embodiments, the ammonia may be blocked from being metabolically incorporated into biomass by inhibiting a key metabolic function, such as glutamine synthetase.

In one embodiment, a system includes a reactor chamber containing a solution. The solution may include hydrogen (H₂), carbon dioxide (CO₂), bioavailable nitrogen, and a bacteria. Gasses such as one or more of hydrogen (H₂), carbon dioxide (CO₂), nitrogen (N₂), and oxygen (O₂) may also be located within a headspace of the reactor chamber, though embodiments in which a reactor does not include a headspace such as in a flow through reactor are also contemplated. The system may also include a pair of electrodes immersed in the solution. The electrodes are configured to apply a voltage potential to, and pass a current through, the solution to split water contained within the solution to form at least hydrogen (H₂) and oxygen (O₂) gasses in the solution. These gases may then become dissolved in the solution. During use, a concentration of the bioavailable nitrogen in the solution may be maintained below a threshold nitrogen concentration that causes the bacteria to produce a desired product. This product may either by excreted from the bacteria and/or stored within the bacteria as the disclosure is not so limited.

Concentrations of the above noted gases both dissolved within a solution, and/or within a headspace above the solution, may be controlled in any number of ways including bubbling gases through the solution, generating the dissolved gases within the solution as noted above (e.g. electrolysis/water splitting), periodically refreshing a composition of gases located within a headspace above the solution, or any other appropriate method of controlling the concentration of dissolved gas within the solution. Additionally, the various methods of controlling concentration may either be operated in a steady-state mode with constant operating parameters, and/or a concentration of one or more of the dissolved gases may be monitored to enable a feedback process to actively change the concentrations, generation rates, or other appropriate parameter to change the concentration of dissolved gases to be within the desired ranges noted herein. Monitoring of the gas concentrations may be done in any appropriate manner including pH monitoring, dissolved oxygen meters, gas chromatography, or any other appropriate method.

The bioreactor may also comprise an anode and a cathode, i.e., a pair of electrodes, that are capable of catalyzing water-splitting in the presence of a voltage. The electrodes may comprise or be prepared from one or more catalysts (e.g., cobalt-phosphate (Co—Pi) and cobalt-phosphorous (Co—P)). In various embodiments, the bioreactor may be configured with an exterior-located water-splitting system comprising water-splitting electrodes and a source of electricity (e.g., renewable solar-based electricity).

The anode can be an oxygen evolving electrode (OER). The cathode can be a hydrogen evolving electrode (HER). The anode and/or the cathode can be coated with a catalyst.

In some embodiments, the catalyst is capable of minimizing the production of reactive oxygen species (ROS) during water-splitting.

In certain embodiments, the bioreactor comprises electrodes comprising Co—Pi and Co—P water-splitting catalysts.

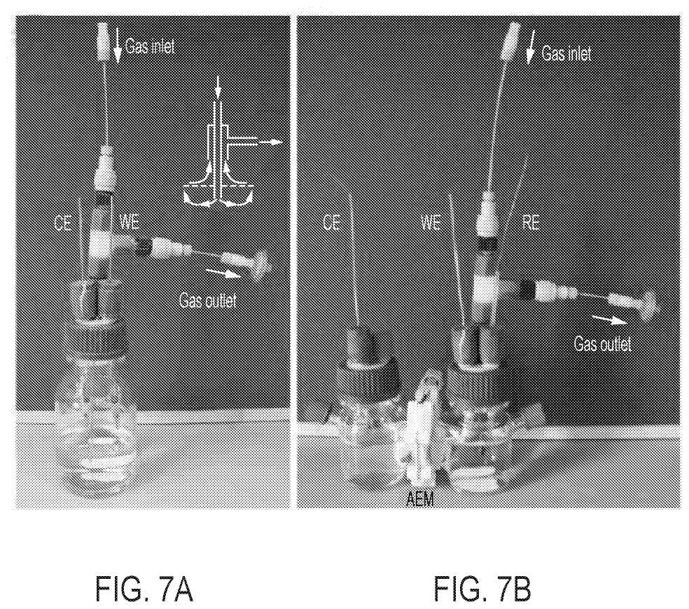

Exemplary configuration of bioreactors of the disclosure are depicted in FIG. 7, including a single-chamber and a dual-chamber system. The methods and systems of the invention also contemplate a bioreactor system comprising an exterior-located water-splitting system comprising water-splitting electrodes and a source of electricity (e.g., renewable electricity). In such embodiments, the exterior-located water-splitting system may be capable of catalyzing the water-splitting reaction to generate hydrogen, which may then be transported or otherwise transferred by any suitable means (e.g., gas tubing and/or a pump system) to the bioreactor for use as hydrogen-based fuel to grow the bioreactor microorganisms. Further, in other embodiments, a source of premanufactured hydrogen, such as a cylinder of hydrogen gas, may be used as the disclosure is not limited to only embodiments in which water is split to form hydrogen in combination with the disclosed bioreactors.

In various embodiments, the bioreactors will comprise various gasses. As noted above, in one embodiment, the composition of a volume of gas located in a headspace of a reactor may include one or more of carbon dioxide, oxygen, hydrogen, and nitrogen. A concentration of the carbon dioxide may be between 10 volume percent (vol %) and 100 vol %. However, carbon dioxide may also be greater than equal to 0.04 vol % and/or any other appropriate concentration. For example, carbon dioxide may be between or equal to 0.04 vol % and 100 vol %. A concentration of the oxygen may be between 1 vol % and 99 vol % and/or any other appropriate concentration. A concentration of the hydrogen may be greater than or equal to 0.05 vol % and 99%. A concentration of the nitrogen may be between 0 vol % and 99 vol %.

As also noted, in one embodiment, a solution within a reactor chamber may include water as well as one or more of carbon dioxide, oxygen, and hydrogen dissolved within the water. A concentration of the carbon dioxide in the solution may be between 0.04 vol % to saturation within the solution. A concentration of the oxygen in the solution may be between 1 vol % to saturation within the solution. A concentration of the hydrogen in the solution may be between 0.05 vol % to saturation within the solution provided that appropriate concentrations of carbon dioxide and/or oxygen are also present.

As noted previously, and as described further below, production of a desired end product by bacteria located within the solution may be controlled by limiting a concentration of bioavailable nitrogen, such as in the form of ammonia, amino acids, or any other appropriate source of nitrogen useable by the bacteria within the solution to below a threshold nitrogen concentration. However, and without wishing to be bound by theory, the concentration threshold may be different for different bacteria and/or for different concentrations of bacteria. For example, a solution containing enough ammonia to support a Ralstonia eutropha population up to an optical density (OD) of 2.3 produces product at molar concentrations less than or equal to 0.03 M while a population with an OD of 0.7 produces product at molar concentrations less than or equal to 0.9 mM. Accordingly, higher optical densities may be correlated with producing product at higher nitrogen concentrations while lower optical densities may be correlated with producing product at lower nitrogen concentrations. Further, bacteria may be used to produce product by simply placing them in solutions containing no nitrogen. In view of the above, an optical density of bacteria within a solution may be between or equal to 0.1 and 12, 0.7 and 12, or any other appropriate concentration including concentrations both larger and smaller than those noted above. Additionally, a concentration of nitrogen within the solution may be between or equal to 0 and 0.2 molar, 0.0001 and 0.1 molar, 0.0001 and 0.05 molar, 0.0001 and 0.03 molar, or any other appropriate composition including compositions greater and less than the ranges noted above.

While particular gasses and compositions have been detailed above, it should be understood that the gasses located with a headspace of a reactor as well as a solution within the reactor may include compositions and/or concentrations as the disclosure is not limited in this fashion.

Depending on the embodiment, an inhibitor may be included in a solution to at least partially prevent the uptake of ammonia into the biomass of the bacteria. Thus, at least a portion of the ammonia produced by the bacteria may be excreted into the solution. In one specific embodiment a glutamine synthetase (GS) inhibitor such as glufosinate (PPT), methionine sulfoximine (MSO), or any other appropriate inhibitor may be used.

In some embodiments, a solution placed in the chamber of a reactor may include water with one or more additional solvents, compounds, and/or additives. For example, the solution may include: inorganic salts such as phosphates including sodium phosphates and potassium phosphates; trace metal supplements such as iron, nickel, manganese, zinc, copper, and molybdenum; or any other appropriate component in addition to the dissolved gasses noted above. In one such embodiment, a phosphate may have a concentration between 9 and 50 mM.

The bioreactor in various embodiment may comprise a microbial growth media. Any suitable media is contemplated. Microbial growth media are well known in the art and generally are designed to meet the nutritional requirements of the organisms to be grown in the media. Examples include, but are not limited to, tryptic soy broth, alkaline peptone water, alkaline salt transport medium, taurocholate peptone transport medium, anaerobic media, Castaneda medium, Pike's medium, and trypticase soy broth, and the like.

The above noted concentrations of dissolved gases may be controlled in any number of ways including bubbling gases through the solution, generating the dissolved gases within the solution (e.g. electrolysis), or any other appropriate method of controlling the concentration of dissolved gas within the solution. Additionally, the various methods of controlling concentration may either be operated in a steady-state mode with constant operating parameters, and/or a concentration of one or more of the dissolved gases may be monitored to enable a feedback process to actively change the concentrations, generation rates, or other appropriate parameter to change the concentration of dissolved gases to be within the desired ranges noted above. Monitoring of the gas concentrations may be done in any appropriate manner including pH monitoring, dissolved oxygen meters, gas chromatography, or any other appropriate method.

Gas sources may correspond to any appropriate gas source capable of providing a pressurized flow of gas to the chamber through the inlet including, for example, one or more pressurized gas cylinders. While a gas source may include any appropriate composition of one or more gasses, in one embodiment, a gas source may provide one or more of hydrogen, nitrogen, carbon dioxide, and oxygen. The flow of gas provided by the gas source may have a composition equivalent to the range of gas compositions described above for the gas composition with a headspace of the reactor chamber. Further, in some embodiments, the gas source may simply be a source of carbon dioxide. Of course embodiments in which a different mix of gases, other including different gases and/or different concentrations than those noted above, is bubbled through a solution or otherwise input into a reactor chamber are also contemplated as the disclosure is not so limited. Additionally, the gas source may be used to help maintain operation of a reactor at, below, and/or above atmospheric pressure as the disclosure is not limited to any particular pressure range.

The above noted one or more gas inlets and outlets may also include one or more valves located along a flow path between the gas source and an exterior end of the one or more outlets. These valves may include for example, manually operated valves, pneumatically or hydraulically actuated valves, unidirectional valves (i.e. check valves) may also be incorporated in the one or more inlets and/or outlets to selectively prevent the flow of gases into or out of the reactor either entirely or in the upstream direction into the chamber and/or towards the gas source.

While the use of inlet and/or outlet gas passages have been described above, embodiments in which there are no inlet and/or outlets for gasses are present are also contemplated. For example, in one embodiment, a system including a sealable reactor may simply be flushed with appropriate gasses prior to being sealed. The system may then be flushed with an appropriate composition of gasses at periodic intervals to refresh the desired gas composition in the solution and/or headspace prior to resealing the reactor chamber. Alternatively, the head space may be sized to contain a gas volume sufficient for use during an entire production run.

### Water-Splitting

The bioreactors disclosed herein in various embodiments are configured to achieve water-splitting to produce hydrogen (H₂). Thus, the bioreactors of the invention may comprise one or more water-splitting systems. The water-splitting systems may be configured and housed within the bioreactors themselves, or located exterior to the bioreactors. Thus, hydrogen formed from the water-splitting reaction may be produced by water-splitting occurring inside the bioreactor, or in a separate system located exteriorly to the bioreactor and wherein the hydrogen therein produced is transported to the bioreactor for use as hydrogen-based fuel for the microorganisms inside the bioreactor.

It should be understood that while a particular type of water-splitting system and components have been described herein, any suitable water-splitting system may be used and/or configured to supply hydrogen to a bioreactor. For example, a water-splitting system may generally comprise at least one pair of water-splitting electrodes and a source of electricity, which in some embodiment may be a renewable source of electricity (e.g., solar-based power). Further, the electrodes, source of electricity, and other appropriate components may be provided in any number of different configurations and/or may use any number of different types of materials as the disclosure is not limited in this fashion.

In some embodiments, hydrogen may be provided to a solution using the electrolysis of water, i.e., water splitting. Depending on the particular embodiment, a power source may be connected to a first electrode and a second electrode that are at least partially immersed in a solution within a reactor chamber. The power source may correspond to any appropriate source of electrical current that is applied to the electrodes. However, in at least one embodiment, the power source may correspond to a renewable source of energy such as a solar cell, wind turbine, or any other appropriate source of current though embodiments in which a non-renewable energy source is used are also contemplated. In either case, a current from the power source is passed through the electrodes and solution to evolve hydrogen and oxygen. The current may be controlled to produce a desired amount of hydrogen and/or oxygen production at a desired rate of production. In one embodiment, the electrodes may be coated with, or formed from, a water splitting catalyst to further facilitate water splitting and/or reduce the voltage applied to the solution. For example, the electrodes may be made from one or more of a cobalt-phosphorus alloy, cobalt phosphate, cobalt oxide, cobalt hydroxide, cobalt oxyhydroxide, or any other appropriate material. In one specific embodiment, the first and second electrodes may correspond to a cathode including a cobalt-phosphorus alloy and an anode including cobalt phosphate. However, embodiments in which other types of anodes and/or cathodes are used are also contemplated as the disclosure is not so limited.

In instances where a phosphorus based anode and/or cathode is used, such as a cobalt-phosphorus alloy and/or a cobalt phosphate, a phosphate buffer may be included in the solution. Appropriate phosphates include, but are not limited to, sodium phosphates and potassium phosphates. Without wishing to be bound by theory, it is believed that during electrolysis of the water, phosphorus and/or cobalt is extracted from the electrodes. The reduction potential of leached cobalt is such that formation of cobalt phosphate from phosphate available in the solution is energetically favored. Cobalt phosphate formed in solution then deposits onto the anode at a rate linearly proportional to free cobalt phosphate, providing a self-healing process for the electrodes. A concentration of phosphate may be between 9 and 50 mM though other concentrations may also be used as the disclosure is not so limited.

In embodiments where hydrogen is produced using water electrolysis, a voltage applied to a pair of electrodes immersed in a solution may be limited to be between first and second voltage thresholds. In one such embodiment, the voltage applied to the electrodes may be greater than or equal to about 1.8 V, 2 V, 2.2 V, 2.4 V, or any other appropriate voltage. Additionally, the applied voltage may be less than or equal to about 3 V, 2.8 V, 2.6 V, 2.4 V, or any other appropriate voltage. Combinations of the above noted voltage ranges are contemplated including, for example, a voltage applied to a pair of electrodes that is between 1.8 V and 3 V. However, it should be understood that voltages both greater than and less than those noted above, as well as different combinations of the above ranges, are also contemplated as the disclosure is not so limited. For example, it is envisioned that other catalysts that enable a water splitting voltage closer to the ideal splitting voltage of 1.23 V may also be used.

As noted previously, in some embodiments, a flow of gas may be introduced to a solution contained within a reactor chamber to dissolve a desired ratio of gases in the solution. For example, in one embodiment, a system may include one or more gas sources that are fluidly connected to one or more gas inlets associated with the chamber. The gas inlets are arranged to bubble the gas through the solution. For example, a one-way valve may be fluidly connected to an inlet to the chamber bottom, a tube connected to a gas source may have an end immersed in the solution within the chamber, or the system may use any other appropriate arrangement to introduce the gases to the solution. Thus, when a gas source provides a pressurized flow of gas to the chamber, the gas is introduced into the solution where it bubbles up through the solution dissolving at least a portion of the gas therein.

While a gas source may correspond to any appropriate type of gas, in one embodiment, a gas source may provide one or more of hydrogen (e.g., hydrogen produced by water-splitting by a water-splitting system), nitrogen, carbon dioxide, and oxygen. Additionally, a total flow of gases provided by one or more gas sources to a solution within a reactor chamber may have any appropriate composition of gases. However, in one embodiment, a flow of gas may contain between 10 and 99.46% nitrogen, 0.04 and 90% carbon dioxide, and/or 0.5% and 5% oxygen. Of course embodiments in which a different mix of gases is bubbled through a solution including different gases and/or different concentrations both greater than and less than those noted above are also contemplated as the disclosure is not so limited.

In some embodiments, the electrodes may be coated with, or formed from, a water splitting catalyst to further facilitate water splitting and/or reduce the voltage applied to the solution. In some embodiments, the catalysts may be coated onto an electrode substrate including, for example, carbon fabrics, porous carbon foams, porous metal foams, metal fabrics, solid electrodes, and/or any other appropriate geometry or material as the disclosure is not so limited. In another embodiment, the electrodes may simply be made from a desired catalyst material. Several appropriate materials for use as catalysts include, but are not limited to, one or more of a cobalt-phosphorus (Co—P) alloy, cobalt phosphate (CoPᵢ), cobalt oxide, cobalt hydroxide, cobalt oxyhydroxide, a NiMoZn alloy, or any other appropriate material. As noted further below, certain catalysts offer additional benefits as well. For example, in one specific embodiment, the electrodes may correspond to a cathode including a cobalt-phosphorus alloy and an anode including cobalt phosphate, which may help to reduce the presence of reactive oxygen species and/or metal ions within a solution. A composition of the CoPᵢ coating and/or electrode may include phosphorous compositions between or equal to 0 weight percent (wt %) and 50 wt %. Additionally, the Co—P alloy may include between 80 wt % and 99 wt % Co as well as 1 wt % and 20 wt % P. However, embodiments in which different element concentrations are used and/or other types of catalysts and/or electrodes are used are also contemplated as the disclosure is not so limited. For example, stainless steel, platinum, and/or other types of electrodes may be used.

In instances where electrodes are run at high enough rates and/or for sufficient durations, concentration gradients may be formed within a solution in a reactor chamber. Accordingly, it may be desirable to either prevent and/or mitigate the presence of concentration gradients in the solution. Therefore, in some embodiments, a system may include a mixer such as a stir bar 24 illustrated in FIG. 1A. Alternatively, a shaker table, and/or any other way of inducing motion in the solution to reduce the presence of concentration gradients may also be used as the disclosure is not so limited.

While above embodiments have been directed to an isolated reactor chamber, embodiments in which a flow-through reaction chamber with two or more corresponding electrodes immersed in a solution that is flowed through the reaction chamber and past the electrodes are also contemplated. For example, in one possible embodiment, one or more corresponding electrodes may be suspended within a solution flowing through a chamber, tube, passage, or other structure. Similar to the above embodiment, the electrodes are electrically coupled with a corresponding power source to perform water splitting as the solution flows past the electrodes. Such a system may either be a single pass flow through system and/or the solution may be continuously flowed passed the electrodes in a continuous loop though other configurations are also contemplated as well.

### Culture Conditions

In various embodiment, the bioreactor cultures are grown at ambient conditions, i.e., the common, prevailing, and unregulated atmospheric and whether conditions in a room or place in which the bioreactor is operated.

In various other embodiments, the bioreactor cultures can be grown under one or more controlled conditions, including temperature, pressure, pH, and oxygen levels.

The skilled person will have wide knowledge of the various growth parameters that may be adjusted during operation of a bioreactor of the invention. All such possibilities are herein envisioned without requiring undue experimentation.

### Microorganisms

The present disclosure contemplates any suitable species, strain, or isolate microorganism for use in preparing a biofertilizer using the methods and systems disclosed herein.

In various embodiments, the microorganisms are nitrogen-fixing microorganisms.

In embodiments, the microorganisms express nitrogenase.

In still other embodiments, the microorganisms express hydrogenase.

In still other embodiments, the microorganisms express nitrogenase and hydrogenase.

In still other embodiments, the microorganisms express a carbon-assimilating pathway (e.g., Calvin-cycle).

In still other embodiments, the microorganisms accumulate or produce polyhydroxyalkanoic acids (PHAs), including polyhydroxybutyric acid (PHB), as carbon-energy reserves.

In still other embodiments, the microorganisms express nitrogenase (i.e., nitrogen-fixing), express hydrogenase (i.e., autotrophic, hydrogen-eating bacteria), and optionally produce PHB (or another PHA).

In some embodiments, the microorganism is X. autotrophicus. In other embodiments, the microorganism is A. eutropha. In still other embodiments, the microorganism is Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

The microorganisms used in any of the biofertilizers, methods, and systems described herein may include one or more mutant microorganisms, which may comprise one or more beneficial phenotypes or traits, e.g., resistance to reactive oxygen species (RORs). The term “mutant” refers to a microorganism obtained by direct mutant selection but also includes microorganisms that have been further mutagenized or otherwise manipulated (e.g., via the introduction of a plasmid). Accordingly, embodiments include mutants, variants, and or derivatives of the respective microorganism, both naturally occurring and artificially induced mutants. For example, mutants may be induced by subjecting the microorganism to known mutagens, such as N-methyl-nitrosoguanidine, using conventional methods. Conventional methods are available for obtaining or otherwise constructing desirable mutants of any bacteria or microorganism (e.g., a ROR-resistant bacteria). The mutants also encompass those with enhanced PHA or PHB production capabilities.

The bioreactors disclosed herein may operate with mono-cultures (i.e., one type of bacteria) or with co-cultures (i.e., two or more types of bacteria).

### Methods/Uses

The bioreactors, resulting biofertilizers, and certain microorganisms themselves (e.g., X. autotrophicus with or without R. eutropha or another PHB-producing organism) can be used for various applications that include, for example, “feeding” or revitalizing a depleted soil microbiome to improve the properties and characteristics thereof, treating a crop to improve yields or other characteristics, produce engineered soils that can be used for growing plants, and pre-treating seeds for improve plant or crop yield or other properties, among other applications.

In various embodiments, the disclosure provides a biofertilizer comprising biomass produced by and obtained from a bioreactor of the disclosure. In certain embodiments, the biomass may be in form of a liquid, e.g., a microbial liquid suspension. In certain other embodiments, the biomass may be in the form of a solid. In various preferred embodiments, the biomass comprises a microorganism capable of H₂-oxidation coupled with N₂ and CO₂ reduction to form a biomass (e.g., a liquid suspension or a solid biomass). In certain embodiments, the assimilation of ammonia (formed from the reduction of N₂ by nitrogenase expressed by the microorganism) can be diverted from being metabolically channeled into biomass formation by inhibiting glutamine synthetase (GS) (which blocks ammonia assimilation), thereby causing the accumulated intracellular ammonia to be transported out of the cell into the extracellular environment, i.e., the media of the bioreactor. Accordingly, in certain embodiments, the biofertilizer may comprise the biomass (i.e., the bacterial cells themselves) and the liquid culture or media environment that comprises the released amounts of extracellular ammonia.

In certain embodiments, the biofertilizer may be directly applied, added, or otherwise mixed with soil. In various preferred embodiments, the biofertilizer comprises X. autotrophicus cells.

In other embodiments, the biomass produced in the bioreactor disclosed in the specification can be used as a biofertilizer for applications that include enhancing a soil microbiome (e.g., by mixing the biofertilizer directly with existing soil microbiome in the soil, or by adding the biofertilizer to the soil). The biofertilizer can be added to soil or soil microbome in situ, i.e., directly in the field or on a farm. The biofertilizer can also be combined with naturally occurring soil ex vivo, i.e., by removing soil desired to be treated, mixing it with an effective amount of the biofertilizer, and returning it to the location from where the soil was removed.

Methods of enriching soils and/or soil microbiomes may also comprise additionally contacting the soil microbiome or soil with PHB-producing bacteria, such as R. eutorpha. Without being bound by theory, it is thought the PHB provides additional carbon-based energy source to “feed” the existing naturally occurring soil microbiome.

Methods of enriching soils and/or soil microbiomes may also comprise additionally contacting the soil microbiome or soil with a microorganism that expresses both a nitrogenase and accumulates PHB, such as X. autotrophicus. Without being bound by theory, it is thought the microorganism when directly added to the soil provides additional carbon-based energy source to “feed” the existing naturally occurring soil microbiome.

In other embodiments, the biomass produced in the bioreactor disclosed in the specification can be used as a biofertilizer for applications that include increasing crop yields and/or enhancing one or more plant characteristics (e.g., by mixing the biofertilizer directly with existing soil microbiome in the soil, or by adding the biofertilizer to the soil). The biofertilizer can be added to soil or soil microbiome in situ, i.e., directly in the field or on a farm. The biofertilizer can also be combined with naturally occurring soil ex vivo, i.e., by removing soil desired to be treated, mixing it with an effective amount of the biofertilizer, and returning it to the location from where the soil was removed.

Methods of increasing crop yields and the like may also comprise additionally contacting the soil microbiome or soil with PHB-producing bacteria, such as R. eutorpha. Without being bound by theory, it is thought the PHB provides additional carbon-based energy source to “feed” the existing naturally occurring soil microbiome.

Methods of increasing crop yields and the like may also comprise additionally contacting the soil microbiome or soil with a microorganism that expresses both a nitrogenase and accumulates PHB, such as X. autotrophicus. Without being bound by theory, it is thought the microorganism when directly added to the soil provides additional carbon-based energy source to “feed” the existing naturally occurring soil microbiome and result in increased crop yields and other improved plant characteristics (e.g., faster growth, larger-sized fruits and vegetables).

Crops and plants that may be treated by the biofertilizer disclosed herein include, but are not limited to, wheat, corn, soybean, rice, potatoes, sweet potatoes, cassava, sorghum, yams, and plantains.

In various embodiments, the methods and bioreactor systems described herein involve the treatment and/or application of a biofertilizer to a soil and/or soil microbiome. For example, in some embodiments, a biofertilizer comprising X. autotrophicus cultivated or prepared in accordance with a bioreactor system described herein, may be directly applied or otherwise mixed with soil at a site, e.g., the soil of a crop field. In other embodiments, a biofertilizer comprising X. autotrophicus cultivated or prepared in accordance with a bioreactor system described herein, may be directly applied or otherwise mixed with soil that has been removed from a site, e.g., the soil of a crop field, and subsequently, after mixing, returned to the site. In still other embodiments, cultures of various microorganisms-preferably nitrogen-fixing and PHB-accumulating microorganisms—may be directly applied or otherwise mixed with soil at a site, e.g., the soil of a crop field. In yet other embodiments, cultures of various microorganisms-preferably nitrogen-fixing and PHB-accumulating microorganisms—may be directly applied or otherwise mixed with soil that has been removed from a site, e.g., the soil of a crop field and subsequently, after mixing, returned to the site.

In various embodiments, the amount of microorganisms (e.g., in the form of a biofertilizer) that may be added is preferably of a sufficient number to result in an improvement of at least one characteristic of the soil and/or the resulting plants grown in the soil (e.g., the increase in yield of a plant, fruit, vegetable, or root (e.g., radish) as compared to the plant grown in non-treated conditions). One of ordinary skill in the art can determine without undue experimentation the amount of biofertilizer (e.g., in terms of total number of microorganism cells added) needed to produce a desired change in at least one characteristic of the soild and/or the resulting plant growth.

In one embodiment, the method of treating a soil comprises adding to a unit of soil (e.g., measured in cubic volume) an effective number of microorganisms (e.g., of a biofertilizer described herein) that are sufficient to result in an increase in plant growth or yield.

In one embodiment, a method for treating 50 mL/6.5 cm² of soil with a concentration of 4×10⁶ cells/mL (i.e., an OD₆₀₀=0.01) in water (e.g., irrigation water), which corresponds to adjusting the treated soil cell density to 2×10⁶ cells/g of dry soil. In one embodiment, this treatment level is a lower threshold level, below which does not lead to a measurable increase in plant growth or yield

In another embodiment, a method for treating 50 mL/6.5 cm² of soil with a concentration of 4×10⁹ cells/mL (i.e., an OD₆₀₀=10.0) in water (e.g., irrigation water), which corresponds to adjusting the treated soil cell density to 2×10⁹ cells/g of dry soil.

For use in treatment methods, the concentration of cells of a biofertilizer can be routinely determined by measuring the optical density at 600 nm with a visible wavelength spectrometer, and converted to cells/mL with a conversion factor of 3.8×10⁶ CFU/mL for OD₆₀₀=1.0 by a colony forming unit assay and (see Examples for further description).

In various embodiments, the methods of treating a soil with a biofertilizer described herein increases the concentration of the naturally-occurring soil bacterium by a factor of about 10²-10⁵ (100-100,000-fold increase over the natural abundance).

In certain embodiments, the methods of treating a soil with a biofertilizer described herein increases the concentration of the naturally-occurring soil bacterium by a factor of about 10²-10³ (100-1,000-fold increase over the natural abundance).

In certain other embodiments, the methods of treating a soil with a biofertilizer described herein increases the concentration of the naturally-occurring soil bacterium by a factor of about 10³-10⁴ (1,000-10,000-fold increase over the natural abundance).

In still other embodiments, the methods of treating a soil with a biofertilizer described herein increases the concentration of the naturally-occurring soil bacterium by a factor of about 10⁴-10⁵ (10,000-100,000-fold increase over the natural abundance).

In yet other embodiments, the methods of treating a soil with a biofertilizer described herein increases the concentration of the naturally-occurring soil bacterium by a factor of about 10-10⁶ (10-1,000,000-fold increase over the natural abundance).

In yet other embodiments, the methods of treating a soil with a biofertilizer described herein increases the concentration of the naturally-occurring soil bacterium by a factor of about 10¹, or 10², or 10³, or 10⁴, or 10⁴, or 10⁵, or 10⁶, or 10⁷, or 10⁸, or 10⁹, or 10¹⁰ or more.

Engineered Soils

In other embodiments, the disclosure provides engineered soils that have been modified to include an effective amount of a biofertilizer of the invention. Engineered soils that are modified by the methods and biofertilizers described herein can include commercial soil products, including potting soils, garden soils, and any other category of consumer soils for home or commercial plant, flower, or garden-related plantings. Such engineered soils may also comprise other typical components including, compost (which refers specifically to decayed food and plant waste), mulch, and/or some type of bulking material that holds water well, e.g., peat or coir. Such soils may also comprise other fertilizers and supplementary ingredients to aid drainage, like perlite and composted bark, may also be included. The engineered soils that may be prepared using the biofertilizer of the invention may also include naturally-occurring soils which are treated either in-ground (i.e., directly in the crop field) or removed from a site, treated, and then returned to the site as the modified engineered soil.

For purposes of this application, it is understood that “mulch” means any material applied to the surface of an area of soil for any number of purposes, including plant growth enhancement, moisture conservation, improvement of soil health and fertility, weed growth reduction, or visual appeal enhancement. Mulch can include any type of biodegradable natural fiber, including wood, paper, grass, hay, straw, pellets, organic residues, rubber, plastic, or rock and gravel. In certain embodiments, the mulch can be wood mulch from wood of any type, including hardwood, softwood, or recycled wood. The wood mulch can be ground wood mulch of any grind size or mix of grind sizes or chipped wood mulch of any chip size or mix of chip sizes. The pellet mulch can be made up of natural fiber pellets or any other known pellet for a mulch product. According to certain implementations, the organic residue mulch can be made of grass clippings, leaves, hay, straw, shredded bark, whole bark nuggets, sawdust, shells, woodchips, shredded newspaper, cardboard, or any other known organic residue used in mulch products. In one embodiment, the rubber mulch can be made from recycled tire rubber or any other known type or source of rubber that is used in mulch products. Further, the plastic sheet mulch can be any known mulch product in the form of a plastic sheet, including, for example, the type of plastic sheet mulch used in large-scale vegetable farming. In certain embodiments, mulch is any functional ground cover.

For purposes of this application, it is understood that “potting soil” also known as potting mix, or potting compost, means any material or medium in which to grow plants. Some common ingredients used in potting soil are peat, composted bark, soil, sand, sandy loam (combination of sand, soil and clay), perlite or vermiculate and recycled mushroom compost or other aged compost products although many others are used and the proportions vary hugely. Most commercially available potting soils have their pH fine-tuned with ground limestone, some contain small amounts of fertilizer and slow-release nutrients. Potting soil recipes are known e.g. from U.S. 2004/0089042 A1. Commercially available potting soil is sterilized, in order to avoid the spread of weeds and plant-borne diseases. Packaged potting soil often is sold in bags ranging from 1 to 50 kg.

Any soil may be modified with the biofertilizers described herein. Examples of soils, e.g., potting soils, can be found described in US20170080446, US20160289130, US20040089042, and US20030010076, each of which are incorporated herein by reference.

In various embodiments, the engineered soils comprise or are modified with an amount of biofertilizer that increases the concentration of the naturally-occurring soil bacterium by a factor of about 10²-10⁵ (100-100,000-fold increase over the natural abundance).

In other embodiments, the engineered soils comprise or are modified with an amount of biofertilizer that increases the concentration of the naturally-occurring soil bacterium by a factor of about 10²-10³ (100-1,000-fold increase over the natural abundance).

In certain embodiments, the engineered soils comprise or are modified with an amount of biofertilizer that increases the concentration of the naturally-occurring soil bacterium by a factor of about 10³-10⁴ (1,000-10,000-fold increase over the natural abundance).

In still other embodiments, the engineered soils comprise or are modified with an amount of biofertilizer that increases the concentration of the naturally-occurring soil bacterium by a factor of about 10⁴-10⁵ (10,000-100,000-fold increase over the natural abundance).

In yet other embodiments, the engineered soils comprise or are modified with an amount of biofertilizer that increases the concentration of the naturally-occurring soil bacterium by a factor of about 10¹-10⁶ (10-1,000,000-fold increase over the natural abundance).

In various embodiments, the engineered soils comprise or are modified with an amount of biofertilizer that increases the concentration of the naturally-occurring soil bacterium by a factor of about 10¹, or 10², or 10³, or 10⁴, or 10⁴, or 10⁵, or 10⁶, or 10⁷, or 10⁸, or 10⁹, or 10¹⁰, or more.

In some embodiments, the soils may comprise biofertilizer-added microorganisms which may comprise X. autotrophicus. In other embodiments, the microorganisms may include A. eutropha. In still other embodiments, the microorganisms may include Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

The microorganisms used in any of the biofertilizers, methods, and systems, and soils, or seeds described herein may include one or more mutant microorganisms, which may comprise one or more beneficial phenotypes or traits, e.g., resistance to reactive oxygen species (RORs). The term “mutant” refers to a microorganism obtained by direct mutant selection but also includes microorganisms that have been further mutagenized or otherwise manipulated (e.g., via the introduction of a plasmid). Accordingly, embodiments include mutants, variants, and or derivatives of the respective microorganism, both naturally occurring and artificially induced mutants. For example, mutants may be induced by subjecting the microorganism to known mutagens, such as N-methyl-nitrosoguanidine, using conventional methods. Conventional methods are available for obtaining or otherwise constructing desirable mutants of any bacteria or microorganism (e.g., a ROR-resistant bacteria). In certain embodiments, the mutants are capable of enhanced PHA or PHB production.

The concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

### Examples

In order that the invention described herein may be more fully understood, the following examples are set forth. It should be understood that these examples are for illustrative purposes only and are not to be construed as limiting this invention in any manner.

### Materials and Methods for the Examples

All chemicals were used as received. Cobalt nitrate hexahydrate (Co(NO₃)₂. 6H₂O), boric acid (H₃BO₃), sodium chloride (NaCl), cobalt chloride hexachloride (CoCl₂. 6H₂O), calcium carbide (CaC₂), phosphinothricin (PPT, ammonium glufosinate), ¹⁵N₂ (5 liter, 98% ¹⁵N), and the gas analytical standard that contains 1% analytes (501662), and chemicals not otherwise specified were purchased from Sigma-Aldrich. Methylphosphonic acid and 316 stainless steel mesh was supplied from Alfa Aesar. Avcarb 1071 HCB carbon cloth was purchased from Fuel Cell Earth. Anion exchange membrane (AMI-7001S) was kindly provided by Membranes International. The 3 nitrogen primary standards, ammonia p-toluenesulfonic acid (ammonia PTSA), glycine PTSA and nicotinic acid PTSA were purchased from Hach Company (2277800).

X. autotrophicus 7CT (ATCC 35674) was cultured at 30° C. based on reported procedures (1,2). Individual colonies were picked from nutrient agar plates and inoculated into nutrient broth media for overnight growth (8 g L⁻¹ nutrient broth, with 15 g L⁻¹ agar added for nutrient plates). Cultures were centrifuged and re-suspended in NH3-supplemented minimal medium (Table 4) and placed in a Vacu-Quick jar filled with H₂ (8 in Hg) and CO₂ (2 in Hg) with air as balance. After adaptation to an autotrophic metabolism, X. autotrophicus was harvested for experiments. The catalysts for the HER and the OER were fabricated as in previous work (2). B. japonicum (ATCC 10324) and V. paradoxus (ATCC 17713) were cultured in nutrient broth until OD₆₀₀ 0.5˜1.0.

Radish seeds (Cherry Belle) were obtained commercially (Atlee Burpee), as was potting media (PRO-MIX HP MYCORRHIZAE, Premier Tech Horticulture). When called for, radish seeds were sterilized by treatment with 5% NaOCl for 5 min at ˜200 seeds per 10 mL followed by rinsing 3× with 50 mM NaCl solutions. Potting media was sterilized by autoclaving for 1 hr at 121° C. Seeds were preinoculated/bioprimed by incubation with the appropriate bacterium for 24 hr in nutrient broth at an OD₆₀₀=0.25 and 200 seeds per 10 mL at 30° C.

X. autotrophicus was also cultured in DUM (Table 5) under autotrophic growth conditions (20 in Hg gas mix (H₂/CO₂/N₂, 12/10/78), 10 in Hg air, refilled daily) in the same manner as adaptation to autotrophic metabolism described above.

### Electrochemical Characterization.

A Gamry Interface 1000 potentiostat was used for electrochemical characterization. A conventional three-electrode setup was employed for the analysis of individual electrodes with Pt counter electrode and Ag/AgCl (1 M KCl) reference electrode; while a two-electrode setup similar as the one in the bioelectrochemical reactor was used to benchmark the pair of water-splitting electrodes. Electrochemical impedance spectroscopy (EIS) was applied to extract the series resistance (Rs) of the device in the two-electrode configuration. Frequencies between 500 kHz and 100 Hz (10 mV amplitude) were scanned at open-circuit conditions, and Rs was determined from the minimal Zreal extracted from Nyquist plots.

Owing to the differences in medium composition and reactor design, voltage drops from the electric resistivity of solution are variable among experiments. The ohmic resistances (Rs) determined from EIS are: (i) Rs=84±10Ω(n=28). Single-chamber configuration with nitrogen-free medium; (ii) Rs=320±30Ω(n=4). Dual-chamber configuration with nitrogen-free medium; and (iii) Rs=32±7Ω(n=24). Single-chamber configuration with medium used in previous work for Ralstonia eutropha (2).

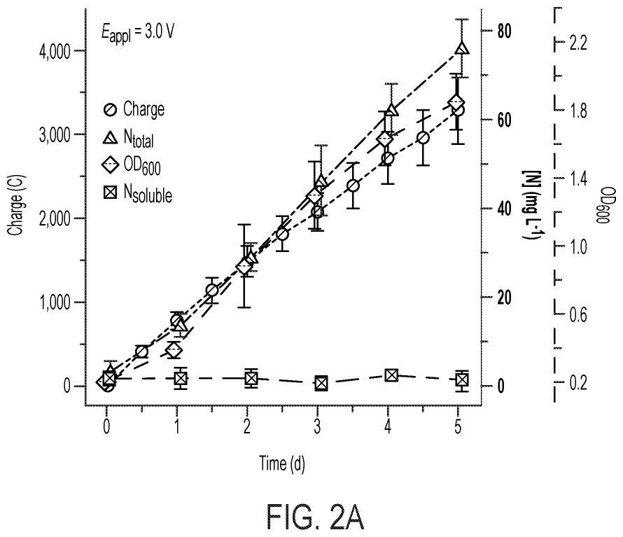

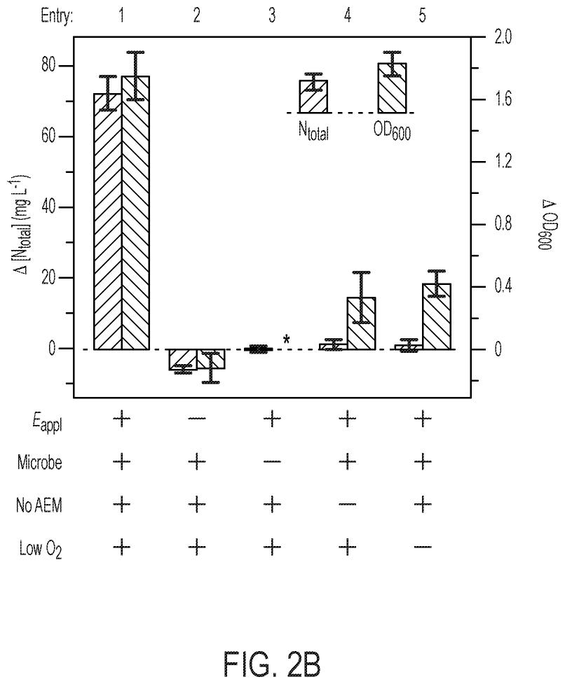

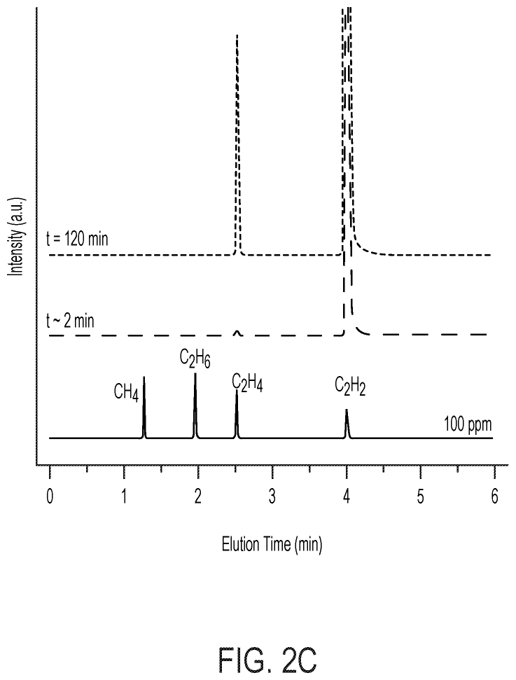

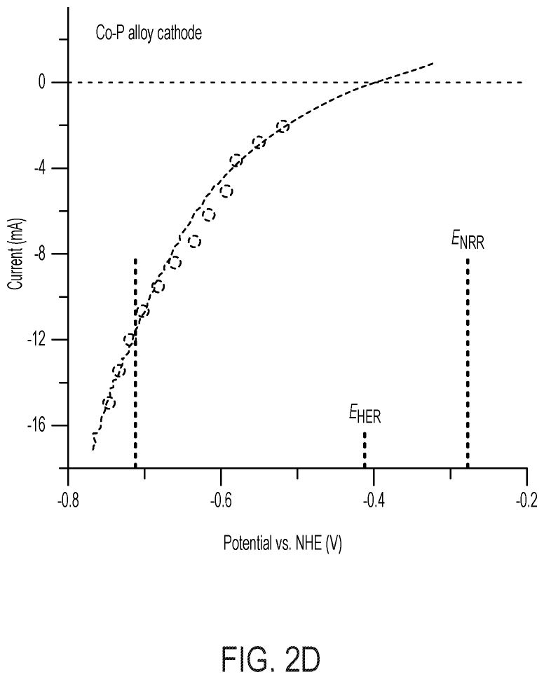

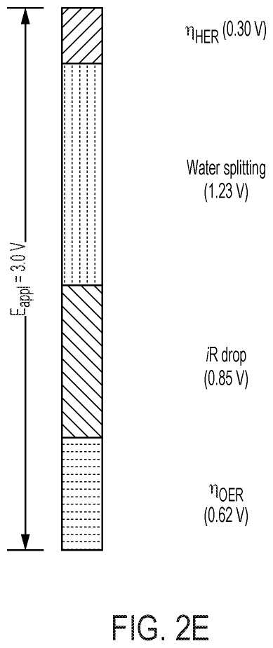

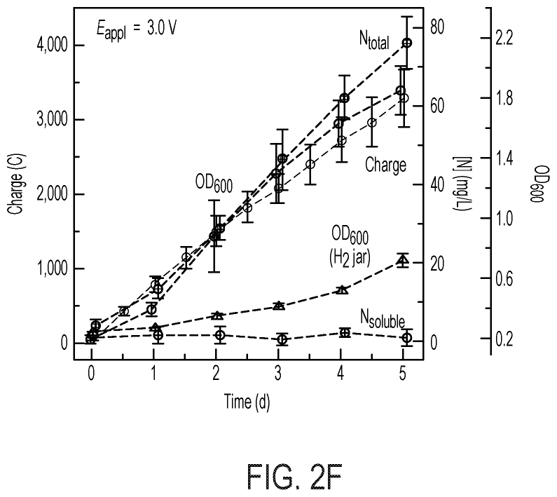

Overall, the X. autotrophicus medium (i) has higher electric resistivity than that of R. eutropha (iii). A higher applied potential, Eₐₚₚₗ, was therefore needed to drive reactions for X. autotrophicus as compared to R. eutropha. The large Rs in the dual-chamber configuration (ii) arises from the anion-exchange membrane, whose conductivity is lower than optimal because of the low salinity in the solution. The contribution of iR drop (FIG. 2D) was calculated based on the above Rs values.

### Bioelectrochemical Reactor.

The experiments were performed in a single-chamber or dual-chamber electrochemical cell (FIG. 7A, 7B). Unless noted specifically, experimental results from a single-compartment reactor were reported. In both scenarios, a controlled gas environment was achieved by bubbling a mixed gas of known composition. Unless noted, the gas mixture contains H₂/CO₂/N₂ (2/20/78). The mixed gas stream was passed through a 0.5 μm inline particulate filter (Swagelok), a check valve (⅓ psi cracking pressure, Swagelok), and lastly was pre-humidified by bubbling through sterilized deionized water before being purged into reactors. These electrochemical cells were immersed in a 30° C. water bath. A Gamry Reference 600 potentiostat coupled with an ECM8 electrochemical multiplexer allowed for parallel experiments of 8 reactors. In the case of the single-chamber electrochemical cell (FIG. 7A), the reactor consists of a 250 mL Duran® GL 45 glass bottle capped with a Duran® GL 45 3-ports (GL 14) connection system. Two of the GL 14 screw cap ports served as the feedthroughs for the HER and OER electrodes, and the third was used as the gas inlet and outlet. A 0.2 μm PVDF filter was attached at the gas outlet to prevent possible contamination. In the case of the dual-chamber electrochemical cell, two specially designed 100 mL glass bottles (Duran® GL 45) were connected and separated by an anion exchange membrane (FIG. 7B). For the chamber where reduction takes place (cathode chamber), the HER cathode was implemented with the same Duran® GL 45 3-port (GL 14) connection system. The OER anode was inserted in the other chamber with a similar connection system described in our previous work (2). An additional Ag/AgCl (1M KCl) reference electrode was added into the cathode chamber when needed.

For a typical experiment, 100 mL of inorganic N-free minimal medium (Table 4) was added into each chamber and water splitting was performed via a two-electrode system with each electrode possessing a 4 cm² geometric area. Eₐₚₚₗ is defined as the voltage difference between the working (OER) and counter/reference (HER) electrodes in a two-electrode configuration. After inoculation with X. autotrophicus (initial OD₆₀₀=0.2), the reactor was purged with the gas mixture at a flow rate between 5 to 20 mL min⁻¹. These electrochemical cells were stirred at 350 rpm to facilitate mass transport and were immersed in a 30° C. water bath. The electrolyte was sampled every 12 or 24 hr to quantify OD₆₀₀ and N accumulation. For time points in which glutamate synthetase (GS) inhibitor phosphinothricin (PPT) was added with final concentration of 50 μM, aliquots were sampled prior to inhibitor addition. The reported data are based on at least three biological replicates (n≥3).

### Bacterial Strains and Growth Protocols.

As noted in a previous report (2), the requirement of inorganic elements is not limiting the process under our experimental conditions. This medium composition has a phosphate buffer concentration of 9.4 mM. All solutions were filter-sterilized prior to use except for the components of the trace element solution, which was added after the filter sterilization step. The prepared media was fully equilibrated before any experiments take place. X. autotrophicus 7CT (DSM 432, ATCC 35674) was used in this study, although we also cultured several other strains of X. autotrophicus (7C SF, GJ10). Isolated strains were sequenced and mutations were compiled using Bowtie 2 (3), Samtools and Bcftools (4). The information of genome sequencing is listed in Table 3.

### Cobalt (Co2+) Leaching and its Biological Toxicity.

The leaching rates of cobalt from the HER electrodes were measured with inductively coupled plasma mass spectrometry (Thermo Electron, X-Series ICP-MS with collision cell technology, CCT). After running the abiotic water-splitting experiments for 24 hr in minimal medium at constant Eₐₚₚₗ, 0.5 mL of electrolyte was sampled and diluted with 3.5 mL of 2% double distilled nitric acid (Sigma-Aldrich). Samples along with calibration standards were scanned twice for 60 sec each for ⁵⁹Co. Experiments were conducted in both one- and two-compartment electrochemical cells as described above.

### Bioelectrochemical Assays and Analysis.

Spot assays were performed by diluting 100 μL of culture at an OD₆₀₀=0.70 by 1:10 in fresh minimal medium. Up to 6 serial 10-fold dilutions were made and 2 μL of each dilution was spotted on minimal media agar plates and allowed to dry. Plates were typically grown for 3 days at 30° C. before imaging. The half maximal inhibitory concentration (IC₅₀) was estimated based on the comparison at 1/100 dilution. The colony areas were compared with that of control samples.

### Definition and Quantification of Nitrogen Content.

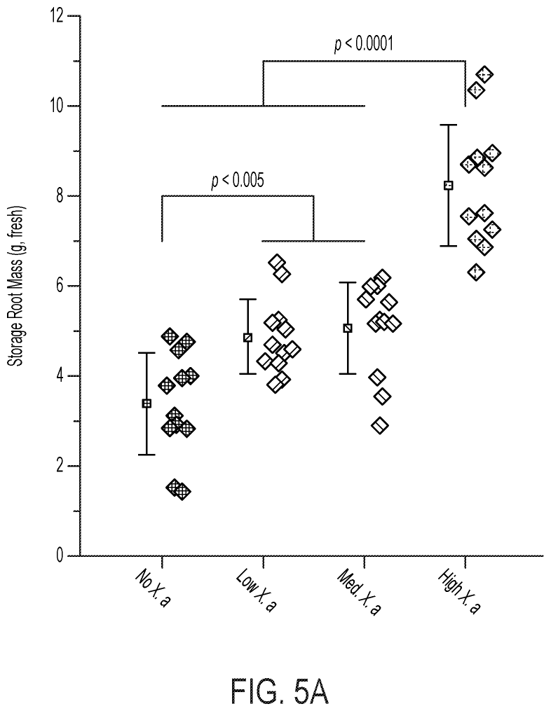

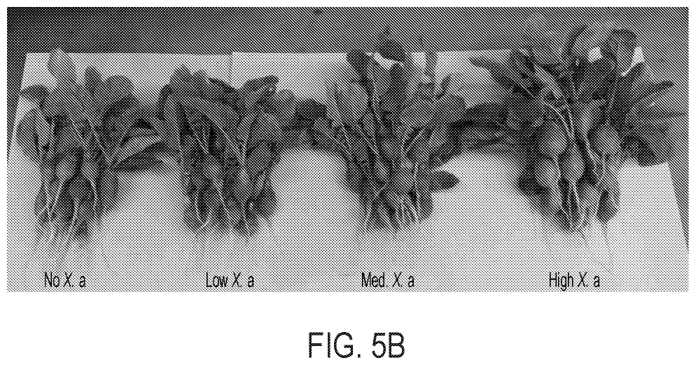

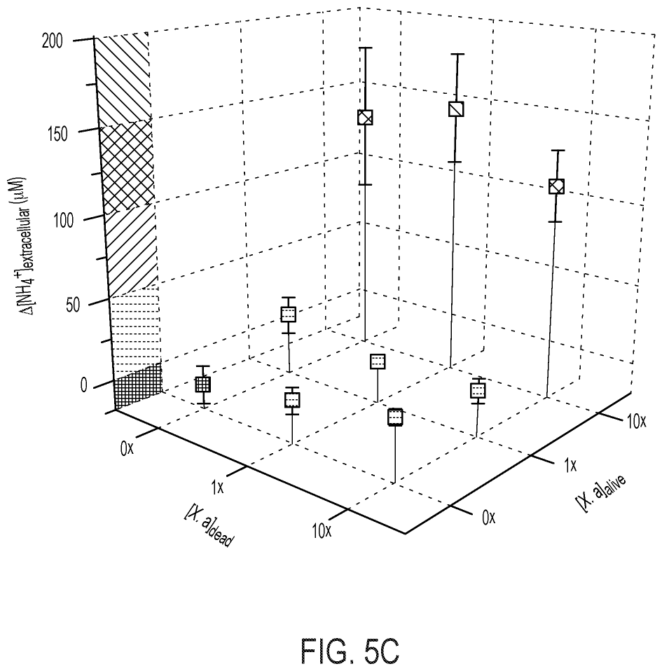

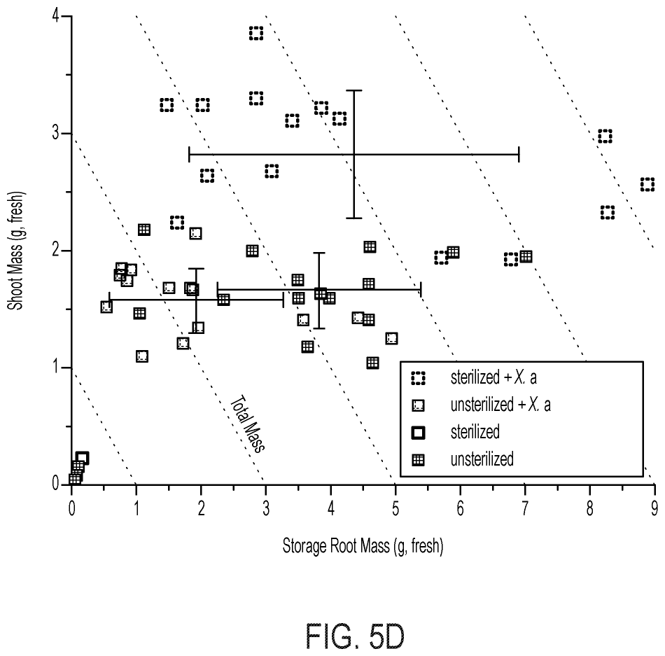

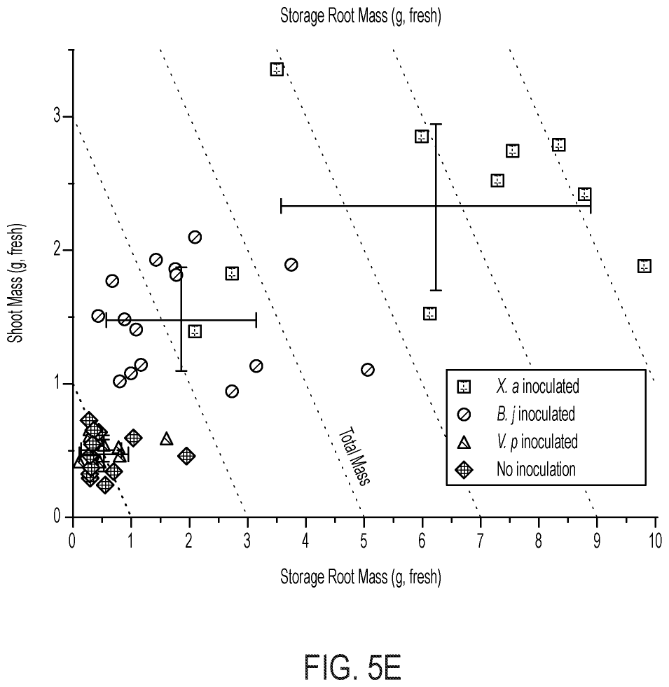

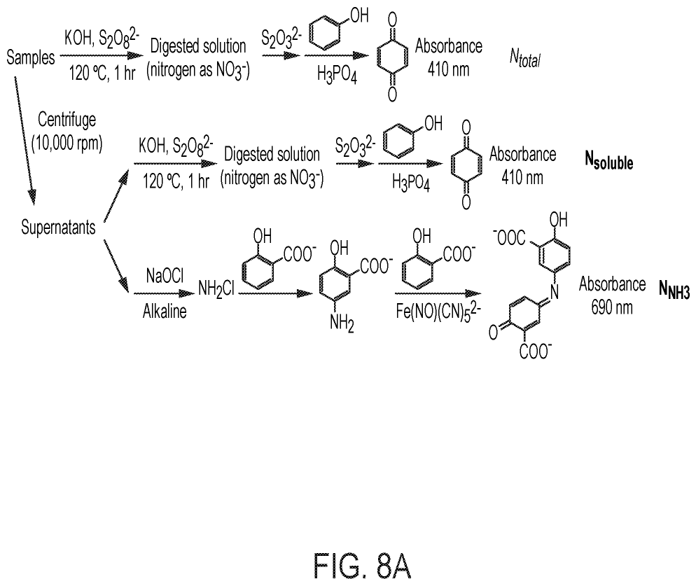

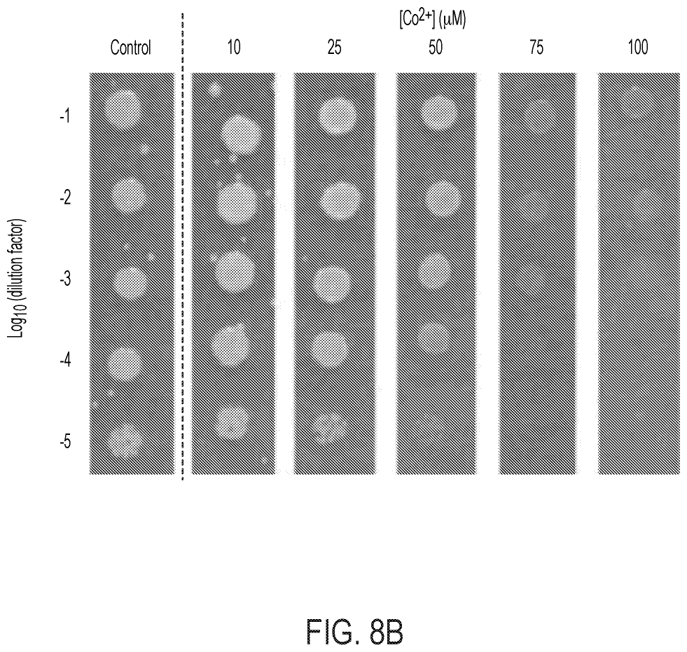

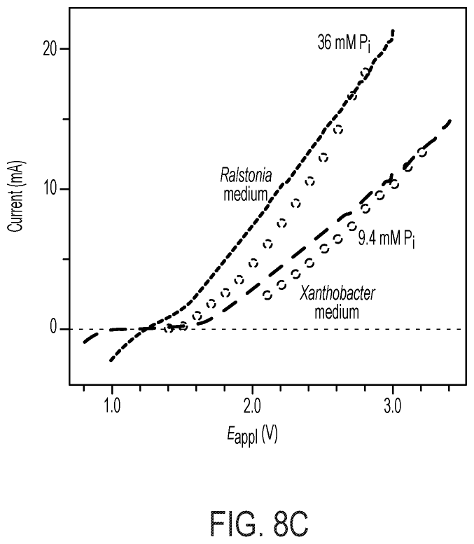

A general scheme for the assay protocol for the quantifications of Nₜₒₜₐₗ, N_{soluble}, and NH₃ is shown in FIG. 8A. Nₜₒₜₐₗ was determined from sampled aliquots after persulfate digestion and based on the absorption of oxidized phenol under acidic conditions (Hach Company 2672245). N_{soluble} was determined similarly as Nₜₒₜₐₗ, except that the supernatants after 10,000 rpm centrifugation were digested in persulfate and subsequently analyzed. NH₃ was also determined from the supernatants after centrifugation, but based on the salicylate method that is selective to ammonia (Hach Company TNT830). For the protocol to analyze Nₜₒₜₐₗ and N_{soluble}, it was determined that the measured total nitrogen content (within 10% relative uncertainty) was independent of nitrogen sources (ammonia PTSA, glycine PTSA and nicotinic acid PTSA), consistent with the protocol suggested by Hach Company. For the protocol to analyze NH₃, it was confirmed that glycine PTSA and nicotinic acid PTSA (Nₜₒₜₐₗ=100 mg L⁻¹ for each) do not interfere with the measurement unless NH₃ is lower than 0.1 mg L⁻¹. For each category of nitrogen content, the nitrogen concentrations were determined by comparing the solution absorbance with those in standard curves. When PPT was added to induce NH3 secretion, the measured nitrogen concentrations presented in FIG. 5B and Table 3 was subtracted from the nitrogen in PPT (2 nitrogen atoms per each PPT molecule for Nₜₒₜₐₗ, and 1 nitrogen atom per each PPT for NH₃). The PPT nitrogen content was also subtracted when calculating η_{elec}, NRR in Table 1.

The assays are based on analytical methods either used for water quality monitoring in environmental sciences (Hach Company methods 10208) or the salicylate method approved by United States Environmental Protection Agency (Methods EPA 350.1, EPA 350.2, EPA 350.3) in comparison to standard curves. When PPT was added to induce NH₃ secretion, the measured N concentrations presented in FIG. 5B and Table 3 was subtracted from the N in PPT (2 N atoms per each PPT molecule for Nₜₒₜₐₗ, and 1 N atom per each PPT molecule NH₃).

### Acetylene Reduction Assay.

The acetylene reductions of whole-cell cultures were conducted based on previous protocol (5). 0.5 mL whole-cell culture was sampled from the operating reactors of ammonia synthesis, and injected into 10 mL crimp top sealed vials equipped with 20 mm blue butyl septa (VWR). The vial contained 1.0 mL nitrogen-free minimal medium and filled with a pre-defined O₂/H₂/CO₂/Ar mixture (2/10/10/78). The inoculated vial was incubated at 30° C. for 1 hr before adding 1.0 mL C₂H₂ gas generated by reacting CaC₂ with H₂O. Acetylene reduction was performed at 30° C. for a variety of durations (from roughly 2 min to 2 hr), and was stopped with the addition of 0.5 mL 30% KOH.

The gas composition in the headspace was analyzed by a gas chromatograph (Agilent GCMS 6890/5975) with flame ionization detector. The instrument was equipped with a GSGasPro capillary column (Agilent) under a He carrier gas. 0.5 mL of gas sample was manually injected into the sampler (1:15 split ratio). After injection, the oven temperature was first maintained at 40° C. for 2 min, and was increased to 120° C. at a ramping rate of 10° C. min⁻¹. The measurement was compared with a standard sample that contains CH₄, C₂H₆, C₂H₄, and C₂H₂ (100 ppm each, diluted from a 1% analytical standard). C₂H₆ formation was not detected for X. autotrophicus within the detection limit of the instrument (˜0.1 ppm); this result is consistent with previous reports (5). The following control experiments were performed with negative activity of acetylene reduction: (i) omitting the injection of microbes; (ii) omitting the injection of C₂H₂; (iii) omitting the injection of both microbes and C₂H₂.

### Correlating OD₆₀₀ to Dry Cell Weight.

X. autotrophicus in Vacu-Quick jars was grown as described above for 3 to 10 days. 10 mL aliquots from jars of varying culture density were sampled, OD₆₀₀ was measured, and cells were pelleted and re-suspended in 1 mL minimal media in a pre-weighed 1.5 mL microcentrifuge tube. Cells were pelleted again and supernatant was discarded. Pellets were dried in a 100° C. heat block overnight with the microcentrifuge cap open. Once dried, the pre-weighed tubes were weighed again to determine the dry cell weight of each sample. We established X. autotrophicus of 1 OD₆₀₀=0.316 g L⁻¹ dry biomass (r=0.96, n=11).

### Correlating OD₆₀₀ to Volumetric Cell Density.

Biological replicates of X. autotrophicus at an OD₆₀₀=0.70 were spotted in 2 μL quantities on minimal media plates after serial dilutions ranging from 1 to 10⁷. Plates were grown in Vacu-Quick jars for about 4 days. Colonies were counted and multiplied by their dilution factor to conclude that 1 OD₆₀₀=3.8±0.7×10⁸ CFU/mL (n=5) (CFU: colony-forming unit). The bacterial density was also determined using flow cytometry, which was run on a BD LSR Fortessa cell analyzer. The analysis protocol used a bacteria-counting kit (Fisher Scientific B7277). From this method, it was determined a cell density of 2.8×10⁸ mL⁻¹ at OD₆₀₀=1.0.

### Efficiency Calculations.

The efficiency values reported in this work are based on the averages of at least three biological replicates. η_{elec},CO₂ and η_{elec},NRR are the energy efficiency for CO₂ reduction into biomass and N₂ reduction into ammonia, respectively. The calculations are performed similar to previous approaches (1,2). The energy efficiency is calculated with the following equation:

$${η}_{elec} = \frac{{Δ}_{r} G° gain from {N}_{2} or {CO}_{2} fixation}{charge passed through ( C ) \times applied voltage ( V )}$$

The Gibbs free energy gains (ΔrGº) for specific target products, along with the corresponding chemical reactions are:

Nitrogen Reduction into Ammonia:

$$0.5 {N}_{2} ( g ) + 1.5 {H}_{2} O ( 𝓁 ) \to {NH}_{3} ( aq ) + 0.75 {O}_{2} ( g )$$

$${Δ}_{r} G° = 329 kJ {mol}^{- 1} or {E}_{NRR}^{°} = + 1.14 V$$

### Biomass Formation:

CO₂(g)+0.24NH₃(aq)+0.525H₂O(l)→CH_{1.77}O_{0.49}N_{0.24}(s)+1.02O₂(g)ΔᵣGº=479 kJ mol⁻¹

The reported efficiencies were calculated based on the above thermodynamic values. The ΔrGº value and standard potential for ammonia synthesis is based on literature values (6).

The ΔrGº value for biomass is based on the report that the Gibbs free energy of formation of biomass in Escherichia coli is −46 kJ per mol carbon (7), and the efficiency was calculated based on the relationship experimentally determined by ourselves: 1 OD₆₀₀=0.316 g L⁻¹ dry biomass (r=0.96, n=11, see above).

### Turnover Frequency (TOF) Calculation.

The TOF per cell of X. autotrophicus, defined as the number of dinitrogen molecules reduced per second per bacterial cell, can be analyzed in two different approaches. The first approach is based on the acetylene reduction rate of whole-cell culture, with the assumption that the TOF of acetylene reduction is a good proxy to the nitrogen reduction. The second approach is based on the total fixed nitrogen (Nₜₒₜₐₗ) generated during the 5-day experiments, with the assumption that the number of N₂-fixing cells can be approximated by the average value between the initial and final cell numbers of the experiments. TOF values calculated via both approaches are provided here, while the values based on the first approach are reported in the main text.

The TOF value based on acetylene reduction (TOF₁) is calculated as,

$${TOF}_{1} ( {s}^{- 1} {cell}^{- 1} ) = \frac{{N}_{{C}_{2} {H}_{4}} ( mol ) \times 6.02 \times {10}^{23} {mol}^{- 1}}{3 \times t ( s ) \times {OD}_{600} \times 3.8 \times {10}^{8} cell {mL}^{- 1} \times V ( mL )}$$

The NC₂H₄ is the amount of C₂H₄ detected, t the duration of C₂H₂ exposure, OD₆₀₀ the optical density of measured cultured, and V=1.5 mL is the volume of culture in the assay. The factor of 3 in the denominator is based on the tenet that the reduction of one dinitrogen molecule is equivalent to the reduction of three acetylene molecules. As stated in the main text, the calculated TOF1 is 1.9×10⁴ s⁻¹ per bacterial cell from acetylene reduction experiment.

The TOF value based on the measurement of Nₜₒₜₐₗ (TOF₂) is calculated as,

$${TOF}_{2} ( {s}^{- 1} {cell}^{- 1} ) = \frac{\begin{matrix}[ {N}_{total , final} ( mg {L}^{- 1} ) - {N}_{total , initial} ( mg {L}^{- 1} ) ] \times \\ 6.02 \times {10}^{23} {mol}^{- 1}\end{matrix}}{\begin{matrix}2 \times 14 g {mol}^{- 1} \times t ( s ) \times 0.5 \times \\ ( {OD}_{600 , final} + {OD}_{600 , initial} ) \times 3.8 \times {10}^{8} cell {mL}^{- 1}\end{matrix}}$$

N_{total,initial} and OD₆₀₀,initial are the total nitrogen content and culture optical density at the beginning of experiment; N_{total,final} and OD₆₀₀, final are the values at the end of 5-day experiments. t is the duration of the 5-day experiment. The factor of 2 in the denominator is because every dinitrogen molecule contains two nitrogen atoms. The factor of 0.5 in the denominator is meant to calculate the averaged OD₆₀₀ value during the 5-day experiment. Here, a linear growth pattern of microbial culture was assumed, which is supported by the experimental data. The calculated TOF₂ based on the data in FIG. 2A is 2.2×10⁴ s⁻¹ per bacterial cell. The consistent TOF values from the above two different approaches support the argument that the rate of acetylene reduction is a proxy of nitrogen reduction rate in biological systems, and indicate that the NRR remain roughly constant during the 5-day experiment shown in FIG. 2A.

The TOF per nitrogenase enzyme in the bacterium was estimated, which requires the value of the average copy number of nitrogenases. The number of nitrogenase copies was estimated at about ˜5000, based on the reported processes to purify the nitrogenases in X. autotrophicus (5,8).

Therefore, the estimated TOF per nitrogenase enzyme was calculated as:

$$TOF ( {s}^{- 1} {protein}^{- 1} ) = \frac{TOF ( {s}^{- 1} {cell}^{- 1} )}{5000}$$

This yields the TOF per nitrogenase enzyme as 3.7 s⁻¹ protein⁻¹ (based on TOF1) and 4.3 s⁻¹ protein⁻¹ (based on TOF₂).

### Turnover Number (TON) Calculation.

The TON per bacterial cell was calculated based on the measured quantity of fixed nitrogen with the following equation.

$$TON ( {cell}^{- 1} ) = \frac{\begin{matrix}[ {N}_{total , final} ( mg {L}^{- 1} ) - {N}_{total , initial} ( mg {L}^{- 1} ) ] \times \\ 6.02 \times {10}^{23} {mol}^{- 1}\end{matrix}}{\begin{matrix}14 g {mol}^{- 1} \times 0.5 \times \\ ( {OD}_{600 , final} + {OD}_{600 , initial} ) \times 3.8 \times {10}^{8} cell {mL}^{- 1}\end{matrix}}$$

N_{total,initial} and OD₆₀₀,initial are the total nitrogen content and culture optical density at the beginning of experiment; N_{total,final} and OD_{600,final} are the values at the end of 5-day experiments. The factor of 0.5 in the denominator is meant to calculate the averaged OD₆₀₀ value during the 5-day experiment. As mentioned above, we assume a linear growth pattern of microbial culture, which is supported by our experimental data. The TON value calculated based on the data in FIG. 2A is 9×10⁹ per bacterial cell.

The TON value per nitrogenase enzyme was also estimated with the same assumption as mentioned above. The TON value per nitrogenase enzyme was calculated as:

$$TON ( {protein}^{- 1} ) = \frac{TON ( {cell}^{- 1} )}{5000}$$

This yields the TON value of 2×10⁶ per nitrogenase based on the data in FIG. 2A.

Estimates of theoretical ηelec,NRR at Eₐₚₚₗ=3.0 V.

The N2 reduction reaction of nitrogenase in X. autotrophicus is,

N₂+8e⁻+16MgATP+8H⁺→2NH₃+H₂+16MgADP+16Pᵢ

Depending on whether the produced H₂ can be recycled, either 4 (no recycle) or 3 (recycle) H₂ molecules are needed to provide the necessary equivalents to reduce 1 N₂ molecule. In addition, H₂ is the ATP source through H2 oxidation to generate the proton gradient and subsequent oxidative phosphorylation. The number of ATP generated per H₂ (the P/O ratio) can range between 1.5 and 2.5 based on oxidative phosphorylation reported mostly on eukaryotes (9). Subsequently, the value of theoretical H₂/N₂ ratio (NH₂/N₂) should fall between 14.7 (no recycle, P/O=1.5) and 9.4 (recycle, P/O=2.5). Based on above considerations, the theoretical maximum ηelec of nitrogen reduction to ammonia at Eₐₚₚₗ=3.0 V is calculated as

$$Theoretical {η}_{elec , NRR} = \frac{329 \times {10}^{3} J {mol}^{- 1}}{3.0 V \times {N}_{{H}_{2} / {N}_{2}} \times 96485 C {mol}^{- 1}}$$

This leads to a theoretical η_{elec,NRR} between 7.5% and 11.7%. The ratio between the experimentally obtained η_{elec,NRR} and theoretical η_{elec,NRR} at Eₐₚₚₗ=3.0 V is considered as the yield of NRR in our system (Table 1).

### Calculation of NRR Faradaic Efficiency.

The NRR faradaic efficiency is defined as the percentage of electrons used to reduce dinitrogen molecules in the hybrid electrochemical system. The evaluation of NRR faradaic efficiency provides a direct comparison to other electrochemical systems that applied synthetic NRR catalysts. The NRR faradaic efficiency is calculated as, NRR faradaic efficiency=

$$\frac{\begin{matrix}3 \times [ {N}_{total , final} ( mg {L}^{- 1} ) - {N}_{total , initial} ( mg {L}^{- 1} ) ] \times \\ 96485 C {mol}^{- 1} \times V ( L )\end{matrix}}{14 g {mol}^{- 1} \times charge passed ( C )} \times 100 \%$$

N_{total,initial} and N_{total,final} are the initial and final total nitrogen content during the experiments, and V the volume of electrochemical chamber. The factor of 3 in the nominator is because each N atom requires 3 electrons to reduce in NRR. The NRR faradaic efficiency is calculated to be 4.5% based on the data shown in FIG. 2A.

### Methods of Numerical Simulations.

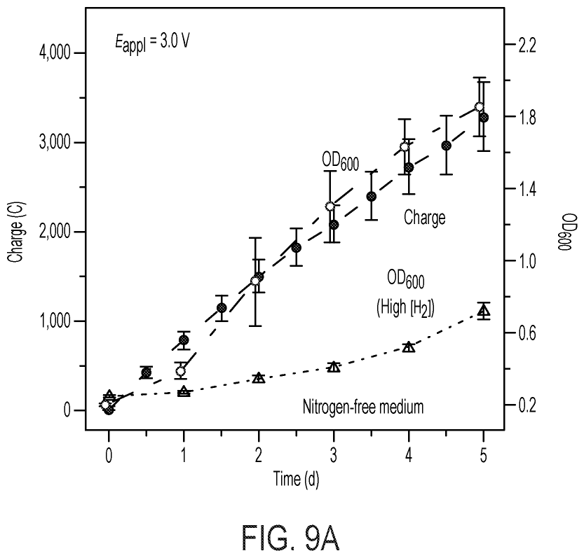

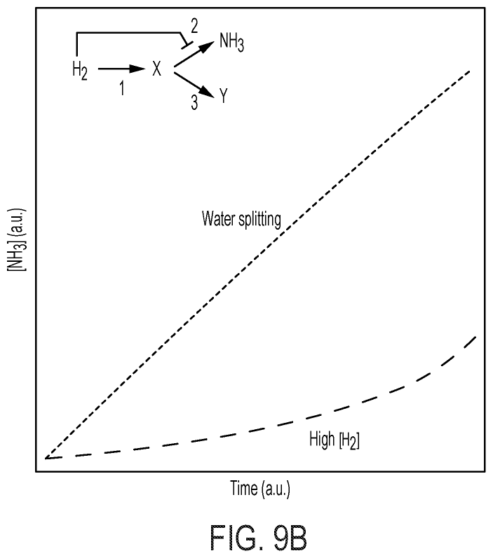

A simplified biochemical model consisting of 3 reactions is constructed to model the microbial growth of X. autotrophicus (depicted is FIG. 9B) in which “H₂” is the provided hydrogen gas, as the sole energy source of microbial growth; “X” is the general representation of the cellular energetic molecules (ATP, NADPH+, H+, etc.) that participates in the metabolism; “NH₃” is the intracellular NH₃ reduced from N₂ through the nitrogenases; “Y” is the other biochemical products generated from “X” through anabolism. “Y” refers to carbon-containing organic molecules that are generated from the CO₂-fixation process in X. autotrophicus. In the diagram, reaction 1 refers to the oxidation of H₂ through hydrogenases and the subsequent generation of energetic molecules “X”; reaction 2 is the N₂ reduction reaction on nitrogenases, which exhibit competitive inhibition by “H₂” (10,11); reaction 3 is other biochemical pathways that consume “X” and yield other molecules in the biomass.

In the context of this simplified model, the concentration of “NH₃”, i.e. [NH₃], was assumed as the limiting molecules for biomass accumulation when no external nitrogen-containing-ingredient is provided. This model was simulated by software COPASI 4.16, build 104 (12) with the following parameters in a single compartment: Reaction 1: irreversible Henri-; Michaelis-Menten. Km=0.01 mM, V=0.1 mM s⁻¹; Reaction 2: irreversible competitive inhibition. Km=1 mM, V=0.2 mM s⁻¹, Ki=0.79 mM; and Reaction 3: irreversible Henri-Michaelis-Menten. Km=1 mM, V=1.5 mM s⁻¹. The initial values of [X], [Y], and [NH3] are zero.

The initial value of [H₂] is 10 mM and changes as reaction progresses for supplying H₂ externally at higher H₂ concentrations (10% H₂, “High [H₂] curve” in FIG. 9B). To mimic the water-splitting conditions of the hybrid, the initial value of [H₂] is set as 0 mM; as simulation begins, [H₂] is reduced as reaction 1 proceeds but also supplemented at a constant rate of 0.1 mM s⁻¹ (“Water splitting” curve in FIG. 9B). The absolute values of these parameters are for analysis only and do not represent experimental values. A time course of 100 s was simulated.

The simulation in FIG. 9B illustrates that the “Water splitting” scenario yields more biomass, as illustrated as “NH₃”, than “high [H₂]” scenario as found experimentally in this study (FIG. 9A). The competitive inhibition of “H₂” on nitrogenases in reaction 3 slows down the synthesis of NH₃, which is limiting the biomass accumulation. This simplified model does not account for microbes multiplying so the kinetic rate constant V in reaction 2 and 3 will be larger as time elapses. Under this caveat, the qualitative conclusion drawn from the simulation is not affected.

¹⁵N₂ Isotope Labeling Experiment.

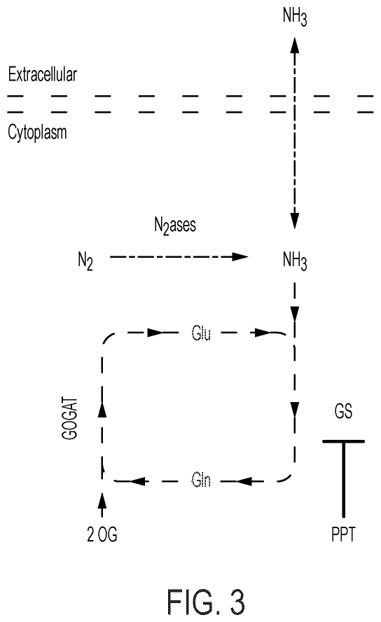

Because the water splitting-biosynthetic system of N₂ reaction is constantly bubbled with gas mixtures, the ¹⁵N labeling experiments were conducted by inoculating whole-cell cultures from functioning devices into a reactor filled with ¹⁵N-enriched N₂ gas. The reactors were prepared similar as mentioned above, except that the headspace was pumped into vacuum and filled with ¹⁵N-enriched N₂ (˜50% 15N abundance), 10% CO₂, 10% H₂, and 2% O₂. The pressure of the enclosed container was balanced with Ar. Inoculates were taken from N₂-fixing reactors at the second day of continuous operation. 3 mL of cultures were injected into the reactors of 5 mL nitrogen-free minimal medium. For NH₃ secretion experiment, PPT was injected into the hybrid device before inoculation. The reactors were incubated at 30° C. in a 200 rpm shaker. Aliquots were sampled at 0 hr, 4 hr, and 8 hr after inoculation and exposing to ¹⁵N-enriched N₂. In the case of biomass accumulation without inhibitor addition, increase of culture OD₆₀₀ values was observed. ¹⁵N-labeled NH₃ was analyzed by ¹H NMR. Aliquots were centrifuged at 10,000 rpm for 5 mins, and the supernatants (0.5 mL) were transferred to a NMR tube with DMSO-d6 (0.1 mL). HCl solution (10 μL, 2 M, H₂O) was injected to acidify the solution. An aqueous solution of dimethylformamide (10 μL, 15 mM) was added as an internal standard. All 1H NMR measurements were performed on a Varian 500 MHz spectrometer at room temperature and were externally referenced to the NMR solvent. Chemical shifts and coupling constants of ¹⁴NH₄⁺ (t, 6.95 ppm, J1NH=50.0 Hz) and ¹⁵NH₄⁺ (d, 6.91 ppm, J1NH=72.7 Hz) match literature values (13). Because of the low concentration and the interference from solvent peaks of H₂O, data shown in FIG. 3C is for qualitative analysis only. The initial ¹⁴NH₄⁺ peaks observed at 0 hr is from the N₂ reduction in the hybrid device after PPT addition and the NH₄⁺ from the added PPT. The detection of ¹⁵N isotopes was also attempted through ¹⁵N NMR. In this case the biomass was digested by persulfate in alkaline solution similar as mentioned above for Nₜₒₜₐₗ measurement, which converts all the nitrogen in the biomass into nitrate. However, the sensitivities of ¹⁵N NMR were not high enough to detect ¹⁵N-labelled nitrate and ammonia at ˜1 mM concentration within a reasonable NMR time.

In Vitro X. autotrophicus Biofertilizer Assays.

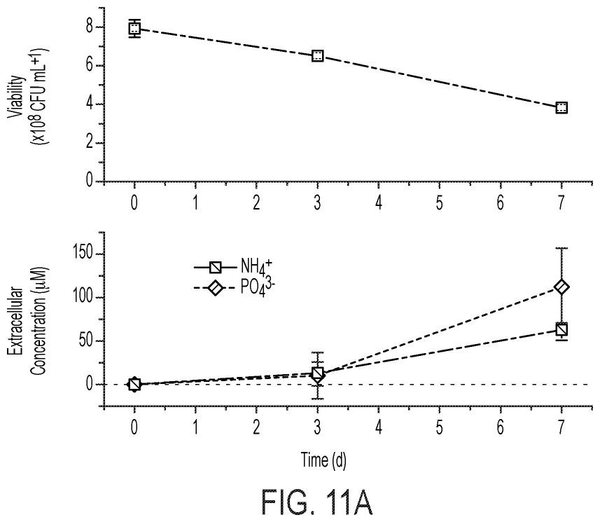

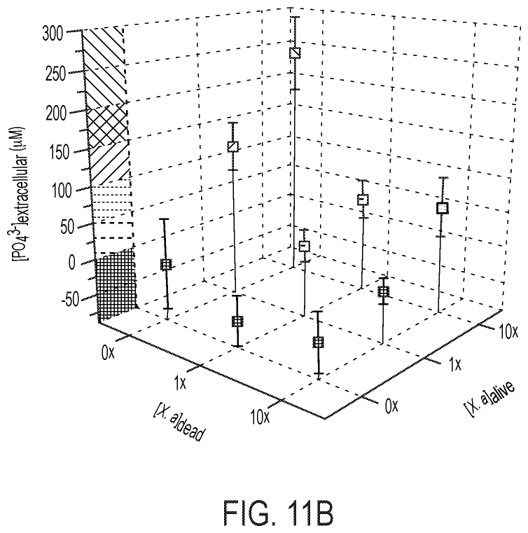

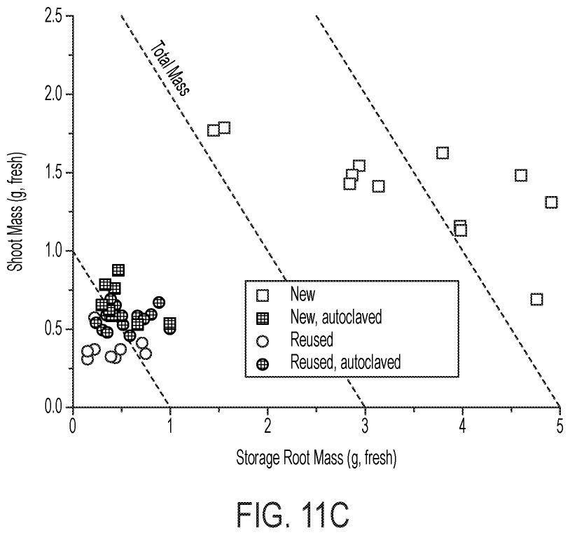

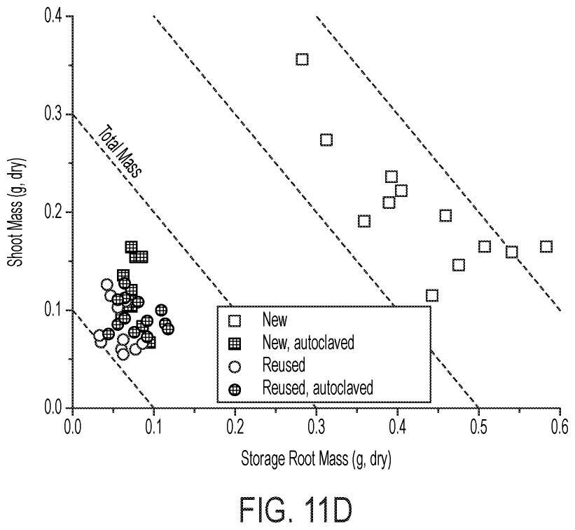

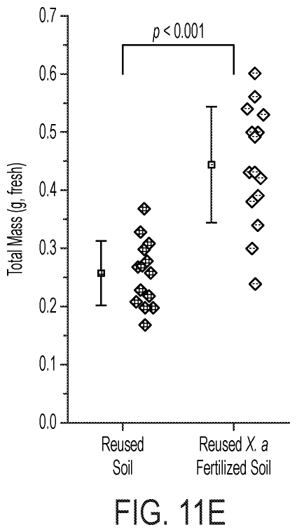

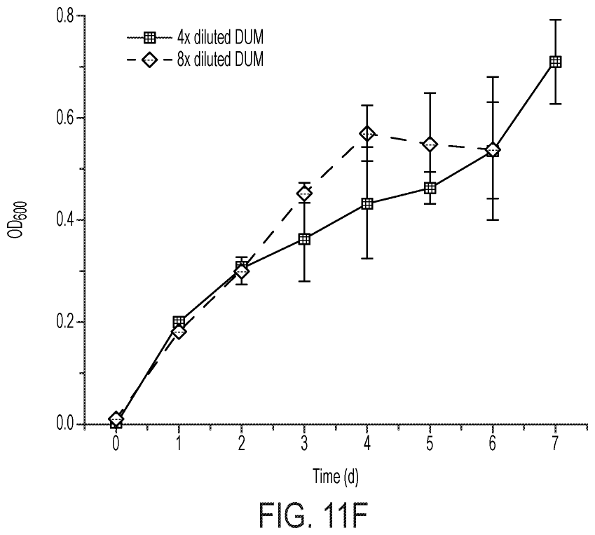

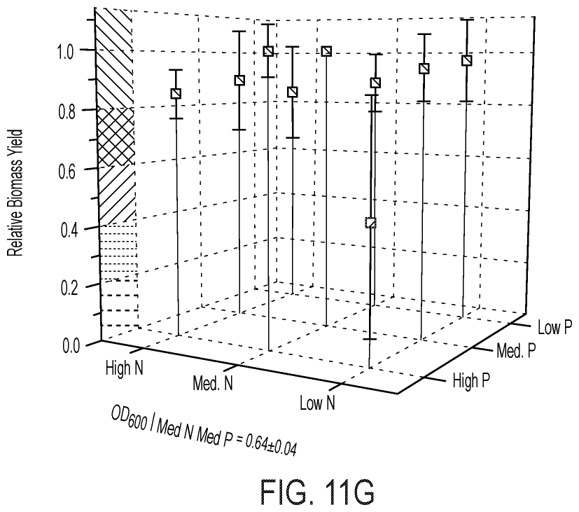

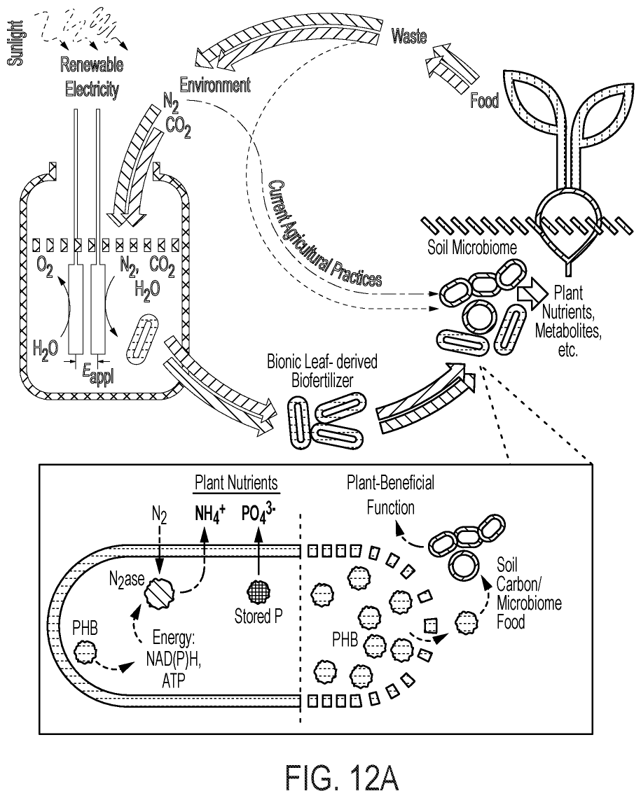

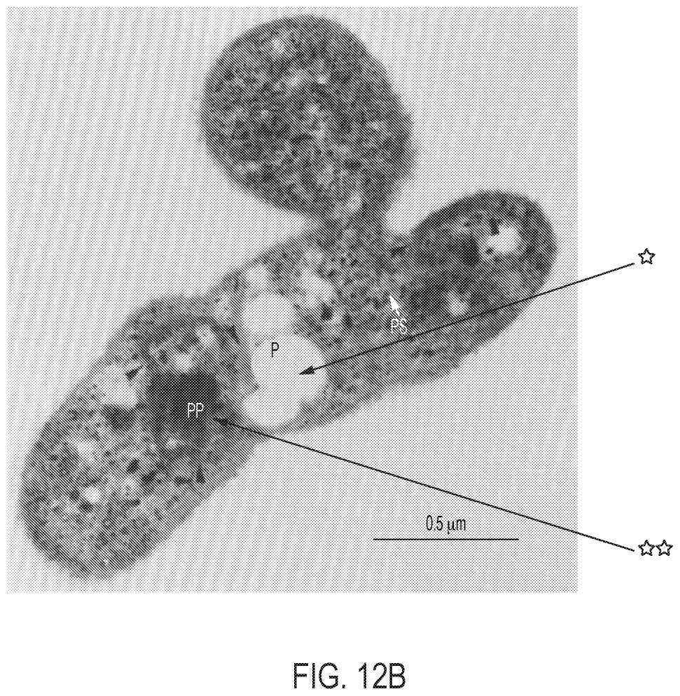

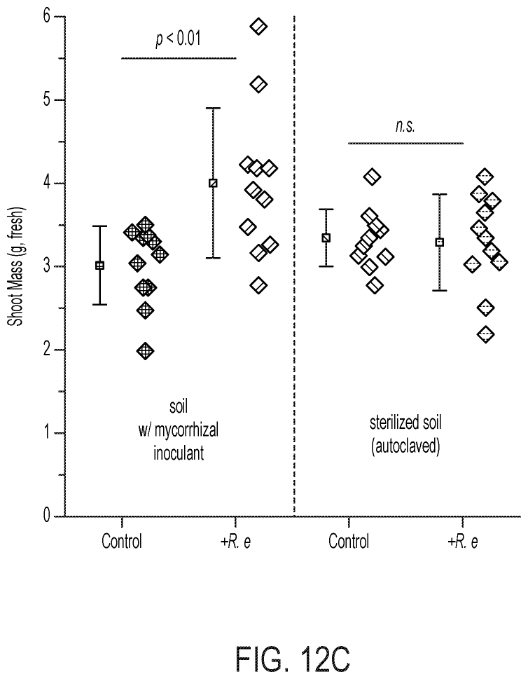

Quantification of X. autotrophicus viability was determined by plating on nutrient plates in serial 10-fold dilutions and counting colonies after 3 days to determine colony forming units (CFU) mL−1. Phosphate concentrations were determined colorimetrically as described in literature using the molybdenum blue test (14), and NH₄⁺ was assayed with 2-phenyl phenol as described previously (15) to minimize interferences from organic N species. The live vs. dead experiment presented in FIG. 5C and FIG. 11B was conducted by splitting an OD₆₀₀=0.5 culture of X. autotrophicus. Live cells were washed 3× with 50 mM NaCl before being resuspended to 1 or 1/10 the original volume (1× and 10× concentrations). Dead cells were similarly washed and resuspended following a 10 min treatment with 70% ethanol to sterilize. Equal volumes were mixed and 20 mL suspensions were incubated for 7 days in a 200 rpm, 30° C. shaking incubator.

### Radish Growth.

Radish seeds were sown ½ in deep into 4 in ×4 in ×4 in planters filled with the appropriate potting medium at 2-3 seeds planter−1. After 7 days of growth, radish seeds were thinned down to 1 radish shoot planter−1. Biofertilizer treatments were applied as 50 mL planter−1 distributed evenly over the planter surface, with X. autotrophicus at a concentration of OD₆₀₀=2 unless otherwise specified at t=7, 14 d after sowing. Radishes were grow in greenhouses with an average temperature of 21-27° C., 50-60% Rh, a 16/8 day/night cycle, and watered daily with reverse osmosis purified reclaimed water. After 25 days, radishes (storage root+shoot) were harvested, washed in water to remove potting media, and blotted dry with paper towels. Fresh masses were determined immediately, and then radishes were dried in a dehydrator (Excalibur 3900B 9 Tray Deluxe Dehydrator) at ˜60° C. overnight until radish mass remained constant, at which point dry masses were determined.

### Tables Cited in the Methods and Materials

TABLE 1
List of experiments for sustainable ammonia synthesis.

| | | | | | | | | | | NRR |
|---|---|---|---|---|---|---|---|---|---|---|
| | | | | | | | | | | faradai [symbol] |
| X. | | | | [N] [symbol] | | Δ[N] | η [symbol] | η [symbol] | NRR yield | yield |
| autotrophicus | E [symbol] (V) | N [symbol] | Microaerobic [symbol] | (mg L⁻¹) [symbol] | ΔOD [symbol] | (mg/L) ^{c} | (%) | (%) | (%) ^{f} | (%) [symbol] |
| Yes | 0.0 ^{k} | 1 | Yes | 7.6 ± 0.4 | −0.12 ± 0.10 | −5.6 ± 1.3 | — | — | | |
| No | 3.0 | 1 | Yes | 1.1 ± 1.5 | — | −0.2 ± 1.2 | — | — | | |
| Yes | −1.2 [symbol] | 2 [symbol] | Yes | 4.6 ± 2.5 | 0.33 ± 0.17 | 1.2 ± 1.6 | — | — | | |
| Yes | 3.0 | 1 | No ^{k} | 2.4 ± 1.6 | 0.42 ± 0.09 | 1.1 ± 2.0 | — | — | | |
| Yes | H₂ [symbol] | 1 [symbol] | Yes [symbol] | 6.2 ± 3.1 | 0.47 ± 0.04 | 28 ± 6 | — | — | | |
| Yes | 3.0 | 1 | Yes | 4.1 ± 1.5 | 1.75 ± 0.16 | 72 ± 5 | 11.6 ± 1.9 | 1.8 ± 0.3 | 15~23 | 4.5 |
| Yes [symbol] | 3.0 | 1 | Yes | 3.6 ± 1.1 | 0.71 ± 0.18 | 47 ± 3 (Nₜₒₜₐₗ) | 4.6 ± 1.3 | 1.0 ± 0.1 | 8~13 | 2.4 |
| | | | | | | 11 ± 2 (N [symbol] ) | | | | |

[symbol]

1: single-chamber electrochemical cell under 2-electrode setup; 2: duel-chamber electrochemical cell under 3-electrode setup
^{b} O₂ partial pressure under 1 atm.
^{c} Initial N [symbol] concentration of microbial culture at the beginning of experiments.
^{d} Changes of OD [symbol] during the experiments. Experimentally established that that 1 OD [symbol] = 0.316 g/L dry cell weight.
^{e} Unless noted specifically changes of Nₜₒₜₐₗ during the experiments.
^{f} Defined as the ratio between experimental and theoretical values of [symbol] [symbol]
Defined as the percentage of charge used for nitrogen reduction. [symbol]
Open-circuit condition. [symbol]
The electrochemical potential of Co-P cathode vs. Ag/AgCl (1M KCl) reference electrode in a 3-electrode setup, no R compensation. The voltage is set to maintain an initial current of about 12 mA on the Co-P HER cathode, which is comparable with condition in single-chamber systems as shown in FIG. 2D. [symbol]
An anion-exchange membrane was used as the separator.
^{k} 12 ± 4% O₂ partial pressure, average values measured by gas chromatography. For each biological replicate, gas samples were collected at day 1 and day 4 (6 samples overall). Maintained by daily refill of gas mixture from air and 100% CO₂. [symbol]
Refilled with H₂/O₂/CO₂/N₂ mixture (10/4/10/76) every 24 h [symbol]
Ammonia secretion experiment.
N = 3, biological replicates. Averages of 5-d experiments are listed unless noted specifically. Error bars are SEM (standard error of the mean). [symbol]
indicates data missing or illegible when filed

TABLE 2
Relevant N2 fixation processes in solution at low temperature (<100° C.).

| Catalyst ^{a} | Driving force | Half-reaction | Performance [symbol] | Source |
|---|---|---|---|---|
| [HIPTN [symbol] N]Mo(N₂) in heptane [symbol] | CrCp₂ [symbol] | Yes | TON = 7.56, ~25° C.; −1.4 V vs. Fc⁺/Fc | (16) |
| [(TPB)Fe(N₂)][Na(12-corwn-4)₂], Et₂O ^{d} | KC [symbol] | Yes | TON = 7.0, −78° C.; −3.0 V vs. Fc⁻/Fc | (17) |
| [Mo(N₂)₂(4-R-PNP)] [symbol] ( [symbol] -N₂) (R = H), toluene [symbol] | CoCp₂ | Yes | TON = 23 [symbol] , R.T.; −1.3 V vs. Fc⁺/Fc | (18) |
| Mo(N [symbol] )₂(4-R-PNP)]₂( [symbol] -N₂) (R = MeO), toluene [symbol] | CoCp₂ | Yes | TON = 52 [symbol] , R.T.; −1.3 V vs. Fc⁻/Fc | (19) |
| Pt \| Nafion | Electrocatalyst | No | Farada [symbol] efficiency: −0.5% | (20) |
| FeS-SnS chalcogel | Photocatalysis [symbol] | Yes [symbol] | TON = 17, R.T. | (21) |
| Hydrogen-terminated diamond | Photocatalysis [symbol] | Yes [symbol] | External QY ~0.6% (211 nm) | (22) |
| Au \| Si nanowire \| Cr [symbol] | Photocatalysis [symbol] | Yes [symbol] | External QY = 3 · 10⁻⁵ % (500 nm) | (23) |
| Au \| Nb—SrTiO₃ \| Zr/ZrO [symbol] | Photocatalysis | No [symbol] | External QY = 3 · 10⁻⁵ % (600 nm) | (24) |
| BiOBr nanosheet with oxygen-vacancy | Photocatalysis [symbol] | No | External QY = 0.23% (420 nm) | (25) |
| CdSiMoFe protein biohybrid [symbol] | Photocatalysis [symbol] | Yes [symbol] | TON = 1.1 × 10⁴ [symbol] Internal QY = 3.3% (405 nm) | (26) |
| MoFe protein [symbol] | Fe protein + ATP | Yes | TOP = 2 s⁻¹ | (25) |
| MoFe protein [symbol] | Electrocatalyst | Yes | Reduce Ns⁻ [symbol] NH₃ at −1.25 V vs. SCE (pH 7.4) | (27) |
| β-98 [symbol] MoFe protein | Eu(II)-L [symbol] | Yes | TON = 180 [symbol] −1.3 V vs. NHE | (28) |
| Mo-nitrogenase [symbol] | dithionite | Yes | TO [symbol] [symbol] 3 s⁻¹ [symbol] | (29) |
| CoP \| Co-P \| X. autotrophicus | E [symbol] = 3.0 V | No | TON = 9 × 10 [symbol] s⁻¹ cell⁻¹ | This work |
| | | | TOP = 1.9 × 10⁴ s⁻¹ cell⁻¹ or 4 s⁻¹ protein [symbol] | |
| | | | NRR [symbol] eff. = 4.5% | |

^{a} Unless stated, in aqueous solution.
^{b} TON: turnover number: TOF: turnover frequency: QY: quantum yield.
^{c}[HIPTN₃N]³ [symbol] [(3,5-(2,4,6- [symbol] -Pr₅C [symbol] H₂)₂C [symbol] H₃NCH₃CH₂)₃N)³⁻.
^{d} TPB: tris(phosphine)borans. [symbol]
4-R-PNP: 4-substituted 2,6-bis(di-t-butylphosphinomethyl)pyridine. [symbol]
per 2 equiv of Mo ato [symbol] [symbol]
150 xenon lamp, 100 mW/cm². [symbol]
5 mM sodium ascorbate and 50 mM pyridinium hydrochloride. [symbol]
450 W high-pressure Hg/Xe lamp. [symbol]
2 mM potassium iodide. [symbol]
An nanoparticles loaded on Si nanowire arrays, whose substrate is coated with Cr. [symbol]
300 W xenon lamp, 2 suns light intensity. [symbol]
~2 mM sodium sulfite. [symbol]
A chemical bias was applied by maintaining a pH gradient. [symbol]
300 W xenon lamp with a 420 nm cutoff filter. [symbol]
Azotobacter vinelandii D [symbol] 995 [symbol] [symbol]
3.5 mW/cm³, 405 nm. [symbol]
500 mM HEPES, 4-(2-hydroxyethyl)-1-piperazineethanesulfonic acid. [symbol]
per MoFe protein with 2 active sites. [symbol]
L [symbol] polyaminocarboxlate ligand. [symbol]
From N₂H₂ to NH₃. [symbol]
X. autotraphicus GZ29. [symbol]
Calculated based on acetylene reduction. [symbol]
Selectivity is defined as the ratio between experimental and theoretical values of [symbol] [symbol]
indicates data missing or illegible when filed

TABLE 3
Genetic information of X. autotrophicus strains.

| | Mutations in open | |
|---|---|---|
| Strain name | reading frames ^{a} | NCBI biosample |
| 7C^{T} | 32457 | SAMN05209880 |
| 7C SF (Slime Free) | 37147 | SAMN05209878 |
| GJ10 | 2924 | SAMN05209879 |

^{a} Values compared to the chromosomal sequence of X. autotrophicus Py2, NCBI reference sequence NC_009720.1. As such, sequences were aligned to the chromosomal segment of the X. autotrophicus genome only.

TABLE 4
Inorganic minimal medium for X. autotrophicus.

| | |
|---|---|
| Component | Concentration (g L⁻¹) |

Minimal Medium (MM) ^{a}

| | |
|---|---|
| K₂HPO₄ | 1 |
| KH₂PO₄ | 0.5 |
| NaHCO₃ | 2 |
| MgSO₄•7H₂O | 0.1 |
| CaSO₄•2H₂O | 0.04 |
| FeSO₄•5H₂O | 0.01 |
| trace mineral mix | 1 mL L⁻¹ |

Trace Mineral Mix

| | |
|---|---|
| H₃BO₃ | 2.8 |
| MnSO₄•4H₂O | 2.1 |
| Na₂MoO₄•2H₂O | 0.75 |
| ZnSO₄•7H₂O | 0.24 |
| Cu(NO₃)₂•3H₂O | 0.04 |
| NiSO₄•6H₂O | 0.13 |

^{a} Components were added to deionized water (DI) and stirred for 1 hr to dissolve. Solutions were sterilized by vacuum filtration through a 0.22 μm filter.

TABLE 5
Defined urine medium (DUM recipe^{a})

| | | | | | | |
|---|---|---|---|---|---|---|
| | Low loading | Medium loading | High loading | Low loading | Medium loading | High loading |
| Component | (gL⁻¹) ^{b} | (gL⁻¹) | (gL⁻¹) ^{b} | (mM) [symbol] | (mM) | (mM) ^{b} |

norganic Salts

| NaCl | 6.46 | 110 |
|---|---|---|
| KCl | 1.26 | 16.9 |
| K₂SO₄ | 2.34 | 13.4 |
| MgSO₄•7H₂O | 2.02 | 8.2 |
| CaCl₂•2H₂O | 0.0881 | 0.6 |
| NaHCO₃ | 0.647 | 7.7 |
| FeSO_{4•}5H₂O | 0.01 (final volume) | |
| trace mineral mix | 1 mL L−1 (final volume) | |

Nitrogen Sources

| | | | | | | |
|---|---|---|---|---|---|---|
| urea | 4.8 | 14.4 | 23.3 | 79.9 | 240 | 388 |
| NH₄Cl | 0.594 | 1.62 | 2.38 | 11.1 | 30.2 | 44.4 |
| creatinine | 0.67 | 1.5 | 2.15 | 5.92 | 13.3 | 19 |
| NaNO [symbol] ^{c} | 0.402 | 0.803 | 1.2 | 4.73 | 9.45 | 14.2 |
| hippuric acid | 0.05 | 1.14 | 2 | 0.279 | 6.37 | 11.2 |
| glycine | 0.09 | 0.315 | 0.45 | 1.19 | 4.19 | 6 |
| creatine H₂O | 0 | 0.424 | 0.53 | 0 | 2.85 | 3.55 |
| uric acid | 0.04 | 0.47 | 0.781 | 0.238 | 2.8 | 4.65 |
| tyrosine | 0.0056 | 0.381 | 0.56 | 0.0309 | 2.1 | 3.09 |
| imidazole ^{c} | 0.0715 | 0.143 | 0.215 | 1.05 | 2.1 | 3.15 |
| histidine | 0.33 | 0.233 | 0.0687 | 0.103 | 1.5 | 2.13 |
| glutamic acid | 0.32 | 0.22 | 0.0318 | 0.0476 | 1.5 | 2.17 |
| taurine ^{c} | 0.069 | 0.138 | 0.207 | 0.552 | 1.1 | 1.65 |
| aspartic acid ^{c} | 0.06 | 0.12 | 0.18 | 0.45 | 0.899 | 1.35 |

Phosphorus Sources

| | | | | | | |
|---|---|---|---|---|---|---|
| K₂HPO₄ | 2.64 | 6.54 | 9.00 | 15.16 | 37.5 | 51.6 |

Organic Components

| | | |
|---|---|---|
| sodium lactate | 0.412 | 3.68 |
| sodium glucuronate | 0.735 | 3.14 |
| phenol | 0.292 | 3.1 |
| sodium formate | 0.0948 | 1.39 |
| glucose | 0.156 | 0.866 |
| sodium pyruvate | 0.0461 | 0.419 |
| sodium oxalate | 0.04 | 0.298 |

[symbol]

DUM was formulated based on the NASA Advanced Life Support Baseline Values and Assumptions Document (30 [symbol] 31) with comparisons to literature. Unless otherwise specified, DUM was formulated as the Medium Loading composition. DUM was prepared by dissolving each component in deionized water (DI) and diluting 4× or 8 [symbol] in DI [symbol] and stirring for 1 h. Trace mineral mix was added at 1 mL L⁻¹ (final volume after dilution) and FeSO₄•5H₂O was added to 0.01 gL⁻¹ (final volume after dilution). Solutions were filter sterlized with 0.22 μm vacuum filters
^{b} Low and high loadings were based on Wydeven et al (32)
^{c} Low nitrogen loading of these were set as 0.5× the medium loading concentration and high nitrogen loading was set as 1.5× the medium loading concentration [symbol]
indicates data missing or illegible when filed

### REFERENCES CITED IN THE METHODS AND MATERIALS

Each of the following references are incorporated herein by reference in their entireties:
1. Torella J P, et al. (2015) Efficient solar-to-fuels production from a hybrid microbial water-splitting catalyst system. Proc Natl Acad Sci USA 112:2337-2342.
2. Liu C, Colon B C, Ziesack M, Silver P A, Nocera D G (2016) Water splitting—biosynthetic system with CO2 reduction efficiencies exceeding photosynthesis. Science 352:1210-1213.
3. Langmead B, Salzberg S L (2012) Fast gapped-read alignment with Bowtie 2. Nat Meth. 9:357-359.
4. Li H, et al. (2009) The sequence alignment/map format and SAMtools. Bioinformatics 25:2078-2079.
5. Schneider K, et al. (1995) The molybdenum nitrogenase from wild-type Xanthobacter autotrophicus exhibits properties reminiscent of alternative nitrogenases. Eur Biochem 230:666-675
6. Bard A J, Parsons R, Jordan J (1985) Standard Potentials in Aqueous Solution (Marcel Dekker, Inc.).
7. Grosz R, Stephanopoulos G (1983) Statistical mechanical estimation of the free energy of formation of E. coli Bbiomass for use with macroscopic bioreactor balances. Biotechnol Bioeng 25:2149-2163.
8. Berndt H, Lowe D J, Yates M G (1978) The nitrogen-fixing system of Corynebacterium autotrophicum: purification and properties of the nitrogenase components and two ferredoxins. Eur J Biochem 86:133-142.
9. Ferguson S J (2010) ATP synthase: From sequence to ring size to the P/O ratio. Proc Natl Acad Sci USA 107:16755-16756.
10. Hoffman B M, Lukoyanov D, Yang Z-Y, Dean D R, Seefeldt L C (2014) Mechanism of nitrogen fixation by nitrogenase: The next stage. Chem Rev 114:4041-4062.
11. Guth J H, Burris R H (1983) Inhibition of nitrogenase-catalyzed NH3 formation by H2. Biochemistry 22:5111-5122.
12. Hoops S, et al. (2006) COPASI—A COmplex PAthway SImulator. Bioinformatics 22:3067-3074.
13. Liu J, et al. (2016) Nitrogenase-mimic iron-containing chalcogels for photochemical reduction of dinitrogen to ammonia. Proc Natl Acad Sci USA 113:5530-5535.
14. Drueckes P, Schinzel R, Palm D (1995) Photometric microtiter assay of inorganic phosphate in the presence of acid-labile organic phosphates. Anal Biochem 230:173 177.
15. Rhine E D, Sims G K, Mulvaney R L, Pratt E J (1998) Improving the Berthelot reaction for determining ammonium in soil extracts and water. Soil Sci Soc Am J 62:473-480.
16. Yandulov D V., Schrock R P (2003) Catalytic reduction of dinitrogen to ammonia at a single molybdenum center. Science 301:76-78.
17. Anderson J S, Rittle J, Peters J C (2013) Catalytic conversion of nitrogen to ammonia by an iron model complex. Nature 501:84-87.
18. Arashiba K, Miyake Y, Nishibayashi Y (2011) A molybdenum complex bearing PNPtype pincer ligands leads to the catalytic reduction of dinitrogen into ammonia. Nat Chem 3:120-125.
19. Kuriyama S, et al. (2014) Catalytic formation of ammonia from molecular dinitrogen by use of dinitrogen-bridged dimolybdenum-dinitrogen complexes bearing PNP pincer ligands: remarkable effect of substituent at PNP-pincer ligand. J Am Chem Soc 136:9719-9731.
20. Lan R, Irvine J T S, Tao S (2013) Synthesis of ammonia directly from air and water at ambient temperature and pressure. Sci Rep 3:1145/1-7. 21 Liu J, et al. (2016) Nitrogenase-mimic iron-containing chalcogels for photochemical reduction of dinitrogen to ammonia. Proc Natl Acad Sci USA 113:5530-5535.
22. Zhu D, Zhang L, Ruther R E, Hamers R J (2013) Photo-illuminated diamond as a solid-state source of solvated electrons in water for nitrogen reduction. Nat Mater 12:836-841.
23. Ali M, et al. (2016) Nanostructured photoelectrochemical solar cell for nitrogen reduction using plasmon-enhanced black silicon. Nat Commun 7:11335.
24. Oshikiri T, Ueno K, Misawa H (2016) Selective dinitrogen conversion to ammonia using water and visible light through plasmon-induced charge separation. Angew Chem Int Ed 128:4010-4014
25. Li H, Shang J, Ai Z, Zhang L (2015) Efficient visible light nitrogen fixation with BiOBr nanosheets of oxygen vacancies on the exposed {001} facets. J Am Chem Soc 137:6393-6399.
26. Brown K A, et al. (2016) Light-driven dinitrogen reduction catalyzed by a CdS:nitrogenase MoFe protein biohybrid. Science 352:448-450.
27. Milton R D, et al. (2016) Nitrogenase bioelectrocatalysis: heterogeneous ammonia and hydrogen production by MoFe protein. Energy Environ Sci 9:2550-2554.
28. Danyal K, et al. (2010) Uncoupling nitrogenase: catalytic reduction of hydrazine to ammonia by a MoFe protein in the absence of Fe protein-ATP. J Am Chem Soc 132:13197-13199.
29. Schneider K, et al. (1995) The molybdenum nitrogenase from wild-type Xanthobacter autotrophicus exhibits properties reminiscent of alternative nitrogenases. Eur J Biochem 230:666-675.
30. Hanford A (2004) Advanced Life Support Baseline Values and Assumptions Document doi:CTSD-ADV-484 A.
31. Rose C, Parker A, Jefferson B, Cartmell E (2015) The characterization of feces and urine: A review of the literature to inform advanced treatment technology. Crit Rev Environ Sci Technol 45:1827-1879
32. Wydeven T, Golub M A (1990) Generation rates and chemical compositions of waste sreams in a typical crewed space habitat RI/LRA. NASA Tech Memo 102799 (August).

### Example 1. Bioreactor for the Bacterial Synthesis of NH₃ from N₂, H₂O, and Electricity

A reactor used in the experiments included a biocompatible water splitting catalyst system including a cobalt-phosphorous (Co—P) alloy cathode for the hydrogen evolution reaction (HER) and a cobalt phosphate (CoPᵢ) anode for the oxygen evolution reaction (OER). This system enabled the use of a low driving voltage (Eₐₚₚₗ) while producing the desired hydrogen for use in producing ammonia. Specifically, NH₃ synthesis from N₂ and H₂O was accomplished using the water splitting system and driving the N₂ reduction reaction within H₂-oxidizing, autotrophic microorganisms. In this case, Xanthobacter autotrophicus (X. autotrophicus) was used. X. autotrophicus is a gram-negative bacterium that belongs to a small group of diazotrophs, which at micro-aerobic condition (less than about 5% O₂) can use H₂ as their sole energy source to fix CO₂ and N₂ into biomass. Therefore, in this experimental setup, electrochemical water splitting generated H₂ as the biological energy source and in the same reactor X. autotrophicus acted as the room-temperature N₂ reduction reaction catalyst to convert H₂ and N₂ into NH₃.

FIG. 1B shows a schematic of the experimental setup including a single-chamber reactor that houses electrodes immersed in a water solution. The electrodes included a Co—P cathode for the hydrogen evolution reaction and a CoPᵢ anode for the oxygen evolution reaction. A gas mixture including 2% O₂, 20% CO₂, and 78% N₂ was bubbled through the solution at a flow rate of greater than or equal to 5 mL/min to maintain a micro-aerobic environment.

During the experiments, a constant voltage (Eₐₚₚₗ) was applied between the OER and HER electrodes for water splitting. The hydrogenases (H₂ases) of X. autotrophicus oxidized the generated H₂, fueling CO₂ reduction in the Calvin cycle and N₂ fixation by nitrogenases (N₂ases). Each turnover of N₂ reduction yields two NH₃ and one H₂ molecule(s), the latter of which may be recycled by the hydrogenases. The generated NH₃ is typically incorporated into biomass, but can also diffuse extracellularly as a result of accumulation from inhibiting NH₃ anabolism (pathway 2) as described previously.

At the beginning of each experiment, X. autotrophicus was inoculated into the organic-free minimal medium without any nitrogen supplement. A constant driving voltage (Eₐₚₚₗ=3.0 V) was applied to the CoPᵢ|Co—P catalyst system, and aliquots were periodically sampled for the quantification of biomass (optical density at 600 nm, OD₆₀₀) as well as fixed nitrogen (colorimetric assay).

The CoPᵢ|Co—P|X. autotrophicus hybrid bioreactor system used electricity to reduce N₂, as well as CO₂, into biomass without sacrificial reagents. FIG. 2F presents a graph of OD₆₀₀, the amount of charge passed through, the concentration of total nitrogen content (Nₜₒₜₐₗ), and soluble nitrogen content (N_{soluble}) plotted versus the duration of the experiments. The OD₆₀₀ in a H₂-fermentation experiment (“H₂ jar”) was also plotted as a comparison. The error bars in the graph denote standard error of the mean (SEM) with n≥3. As shown in FIG. 2F, the amount of charge passed into water splitting was proportional to biomass accumulation (OD₆₀₀) as well as the total nitrogen content in the medium (Nₜₒₜₐₗ) during the 5 day experiments.

FIG. 2B. presents the change of Nₜₒₜₐₗ and OD₆₀₀ under different experimental conditions during the 5 day experiments. As seen in the figure, the fixed nitrogen was assimilated into biomass, as there was no change in the extracellular soluble nitrogen content (N_{soluble}). 72±5 mg/L of Nₜₒₜₐₗ, as well as 553±51 mg/L of dry cell weight, accumulated continuously over the experiment (n=3, entry 1 in FIG. 2B). In contrast, no accumulation of Nₜₒₜₐₗ was observed in controls that omitted one of the following elements in the design: water splitting, X. autotrophicus, a single-chamber reactor, and a microaerobic environment (entry 2 to 5 in FIG. 2b). Particularly in the case of the dual-chamber experiment (entry 4 in FIG. 2B), the absence of Nₜₒₜₐₗ accumulation is concurrent with the increase of soluble Co²⁺ concentration in the medium from 0.9±0.2 μM to 40±6 μM within 24 hours as determined by inductively coupled plasma mass spectroscopy (ICP-MS), which is close to the ˜50 μM half maximum inhibitory concentration (IC₅₀) of X. autotrophicus. Without wishing to be bound by theory, this may indicate that the installation of an anion exchange membrane (AEM) prevented the deposition of leached Co²⁺ onto the CoPᵢ anode, illustrating that the biocompatibility of the materials used in the system may be a desirable system property. As also illustrated in the figure, increases in OD₆₀₀ that greatly exceed increases in Nₜₒₜₐₗ (entry 4 and 5 in FIG. 2B) are likely due to light scattering from the accumulation of poly(3-hydroxybutyrate), which is produced as a carbon storage polymer in conditions of nutrient constraints coupled with carbon excess.

The NRR activity of the described hybrid system is also supported by whole-cell acetylene reduction assays that were done. Specifically, aliquots were sampled directly from operating devices that were exposed to an O₂/H₂/CO₂/Ar gas environment (2/10/10/78) and were able to reduce injected C₂H₂ exclusively into C₂H₄ at a rate of 127±33 μM·h⁻¹·OD₆₀₀⁻¹ (n=3). If the kinetic rate of C₂H₂ reduction by nitrogenase is one fourth of N₂ reduction based on the reaction stoichiometry, this activity corresponds to ˜12 mg/L Nₜₒₜₐₗ per day for cultures of OD₆₀₀=1.0. This N₂-fixing rate is consistent with the measured Nₜₒₜₐₗ accumulation during the 5 day experiments and excludes the possibilities of other hypothetical nitrogen sources in conjunction with other controls (vide supra). This measurement corresponds to a NRR turnover frequency (TOF) of 1.4×10⁴ s⁻¹ per bacterial cell. If assuming a nitrogenase copy number of about 5000 based on previous literature, this NRR TOF corresponds to roughly ˜3 s⁻¹ per enzyme, which is consistent with previous studies. The equivalent turnover number (TON) is roughly 8×10⁹ per bacterial cell and 1×10⁶ per nitrogenase, at least 2 orders of magnitude higher than previously reported synthetic and biological catalysts.

FIG. 2D presents the results from linear scan voltammetry (line, 10 mV/sec) and chronoamperometry (circle, 30 min average) of Co—P HER cathode in X. autotrophicus medium, iR corrected. The thermodynamic values of HER and NRR (E_{HER}, E_{NRR}) are displayed. Voltage contributions from the applied Eₐₚₚₗ=3.0 V is shown below the I-V characterization. The NRR reaction operates with kinetic driving forces as low as 160 mV. The I-V characteristics of the Co—P HER cathode in X. autotrophicus medium indicate an apparent overpotential of about 0.43 V. Without wishing to be bound by theory, much of this value is not intrinsic to the catalytic properties of the electrodes, but originates from the build-up of a proton concentration gradient in the weakly buffered solution (9.4 mM phosphate). By subtracting the contribution of mass transport, the intrinsic NRR overpotential is about 0.16 V, much lower than previous reports in literature. The dilute medium salinity subsequently uses a driving voltage of Eₐₚₚₗ=3.0 V, which is higher than previous reported. The low ionic conductivity contributes to about 28% of Eₐₚₚₗ (˜0.85 V), which may likely be reduced by additional optimization. Regardless, the energy efficiency of NRR (η_{elec,NRR}) in the experiments is 1.8±0.3% (n=3) during the 5 day experiments, in addition to the 11.6±1.9% electrical CO₂ reduction efficiency (η_{elec,CO2}, n=3). This corresponds to ˜900 GJ per tonne NH₃, while the thermodynamic limit is 20.9 GJ per tonne NH₃. Based on the reaction stoichiometry of nitrogenase and upstream biochemical pathways, the theoretical number of H₂ molecules needed to reduce one N₂ molecule ranges in between 9.4˜14.7, which sets an upper bound of η_{elec,NRR} at 7.5˜11.7%. Therefore, the amount of nitrogen reduction reported in this experiment is 15˜23% of the theoretical yield, much higher than the faradaic efficiencies or quantum yields of other systems at ambient conditions.

The described experiments and systems exhibited faster N₂ reduction and microbial growth as compared to gas fermentation at similar conditions. In contrast to the observed linear growth in the hybrid system (FIG. 2F), gas fermentation in the same conditions supplemented with a headspace containing ˜10% H₂ (“H₂ jar” experiment in FIG. 2F) shows relatively slow, nonlinear growth. This difference is dependent on N₂ fixation, as growth under gas fermentation and electrolysis demonstrated no discernable difference when ammonia is supplemented into the medium. Without wishing to be bound by theory, it is believed that this is the result of competitive inhibition of H₂ on nitrogenase, with an inhibition constant Kᵢₛ(D₂) of ˜11 kPa. Where electrolysis maintains a low H₂ partial pressure at steady state in the hybrid device, the high H₂ concentration in gas fermentation may slow down the N₂ fixation rate and/or reduce the NRR energy efficiency. This hypothesis is supported by numerical simulations, which show slower biomass accumulation in the case of gas fermentation. Therefore, the current experiments indicate that the described hybrid device can provide additional benefits as compared to the simple combination of gas fermenters with a water-splitting electrolyzer, as the generated H₂ from water splitting can influence downstream biochemical pathways.

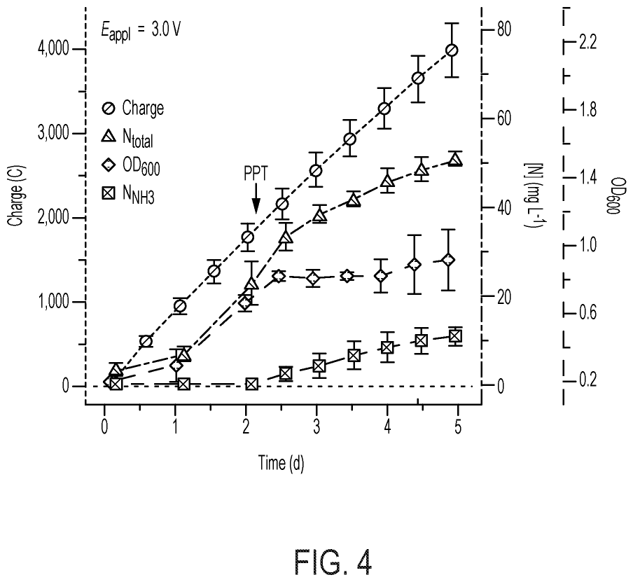

The hybrid device is capable of excreting synthesized NH₃ into an extracellular medium. Previous biochemical assays and genome sequencing on this strain indicate that the NH₃ generated from nitrogenase is incorporated into biomass via a two-step process mediated by glutamine synthetase (GS) and glutamate synthase (GOGAT) (FIG. 1B and FIG. 3). If the functionality of this NH₃ assimilation pathway is disrupted, direct production of an extracellular NH₃ fertilizer solution is realized. It has been reported that GS inhibitors can be used for NH₃ secretion in sugar-fementating diazotrophs. As a proof of principle, glufosinate (PPT), a specific GS inhibitor commercially used as herbicide, was used to block the NH₃ assimilation pathway and allow the synthesized NH₃ to passively diffuse out into the extracellular medium (pathway 2 in FIG. 1B, and FIG. 3). After the addition of PPT, the biomass of X. autotrophicus stagnated, while Nₜₒₜₐₗ and the concentration of free NH₃ in the solution (N_{NH3}) increased (FIG. 4). This indicates that nitrogen accumulation after PPT addition mostly took the form of extracellular NH₃. In the end of experiments, the concentration of N_{NH3} was 11±2 mg/L (˜0.8 mM) and the accumulated Nₜₒₜₐₗ reached 47±3 mg/L (n=3). The rate of N₂ fixation tends to slow down in the latter phase of the experiments, which may be related to nitrogen regulation at transcriptional and post-transcriptional levels. Further engineering in synthetic biology is capable of alleviating this limitation.

The above experiment of Example 1 demonstrates the production and use of an alternative NH₃ synthesis approach from N₂, H₂O, and electricity. The water splitting-biosynthetic process operates at ambient conditions and can be distributed for an on-demand supply of nitrogen fertilizer. When coupled with a renewable energy supply such as a photovoltaic device of 18% energy efficiency, solar-powered N₂ fixation into NH₃ can be achieved at up to a 0.3% solar-to-NH₃ efficiency along with a 2.1% solar CO₂ reduction efficiency. A typical cropping system annually reduces ˜11 g nitrogen per m², which corresponds to a ˜4×10⁻⁵ solar-to-NH₃ efficiency (assuming 2000 kWh/m² annual solar irradiance). Therefore, this approach yields a much higher efficiency and provides a sustainable route for fertilizer production without the use of fossil fuels. Though instances in which the various feeds stocks (i.e. gases) could be provided using fossil fuels as the current disclosure is not limited to only using renewable energies and/or splitting water directly in a reactor to produce the desire ammonia generation.

### Example 2. Hybrid Inorganic-Biological Bioreactor for Generating Ammonia and/or Carbon-Enriched Biofertilizer for Use in Enhancing Soil Microbiome and Boosting Crops

This example demonstrates the synthesis of NH₃ from N₂ and H₂O at ambient conditions in a single reactor by coupling hydrogen generation from catalytic water splitting to a H₂-oxidizing bacterium Xanthobacter autotrophicus, which performs N₂ and CO₂ reduction to solid biomass. Living cells of X. autotrophicus may be directly applied as a biofertilizer to improve growth of radishes, a model crop plant, by up to ˜1,440% in terms of storage root mass. The NH₃ generated from nitrogenase (N₂ase) in X. autotrophicus can be diverted from biomass formation to an extracellular ammonia production with the addition of a glutamate synthetase inhibitor. The N₂ reduction reaction proceeds at a low driving force with a turnover number of 9×10⁹ cell⁻¹ and turnover frequency of 1.9×10⁴ s⁻¹·cell⁻¹ without the use of sacrificial chemical reagents or carbon feedstocks other than CO₂. This approach can be powered by renewable electricity, enabling the sustainable and selective production of ammonia and biofertilizers in a distributed manner.

The reduction of N₂ into NH₃ is essential for maintaining the global biogeochemical nitrogen (N) cycle (1). Fixed, organic N in food, biomass, and waste is eventually returned to the atmosphere as N₂ through biological denitrification. As a ubiquitous, synthetic nitrogenous fertilizer, NH₃ synthesized from atmospheric N₂ via the Haber-Bosch process has been added to agricultural soils to drive global increases in crop yields (2). Despite its high efficiency and scalability, the Haber-Bosch process unsustainably employs natural gas as a H₂ feedstock, operates at high temperatures and pressures, and relies on a significant infrastructure for NH₃ distribution (1). A distributed approach toward NH₃ synthesis from renewable energy sources at ambient conditions would enable on-site deployment and reduce CO₂ emissions. To this end, significant effort has been devoted to promoting the reduction of nitrogen to NH₃ with the use of transition metal catalysts (3-5), electrocatalysts (6), photocatalysts (7-11), purified nitrogenases (N₂ases) (11, 12), and heterotrophic diazotrophs (13, 14), potentially powered by renewable energy and operating at ambient conditions. Such approaches, however, typically use sacrificial reductants to drive conversion at low turnover or suffer poor selectivity.

More broadly, the limitations of synthetic NH₃ as a fertilizer have become apparent in recent years as decreasing efficiency of fertilizer use, coupled to environmental damage, has provided an imperative for the development of sustainable biofertilizers (15, 16). Soil microorganisms facilitate efficient nutrient uptake and recycling (17), pathogen resistance (18), environmental adaptation (19), and long-term soil productivity (15). However, the diminished yields of organic/sustainable agriculture have demonstrated that nutrient cycling alone, accentuated by natural variabilities in the soil microbiome, is insufficient to meet an increasing worldwide food demand (20). Attempts to establish robust, productive soil communities through microbial inocula have shown promise (21), but the limited natural flow of organic carbon into these soils results in a bottleneck in the biological activity of these largely heterotrophic biomes (22). An alternative solution would leverage the increasing abundance of renewable energy to cultivate and feed such soil microbiomes, effectively supplementing the natural process of microbial N₂ fixation and plant beneficial interactions.

To further the development of distributed fertilization and natural N cycling, this example demonstrates the reduction of N₂ coupled to H₂O oxidation by interfacing biocompatible water-splitting catalysts with the growth of N₂-reducing, autotrophic, biofertilizing microorganisms in a single reactor (FIG. 1A-F). The biocompatible catalysts, a cobalt-phosphorus (Co—P) alloy for the hydrogen evolution reaction (HER) and an oxidic cobalt phosphate (CoPᵢ) for the oxygen evolution reaction (OER), permit low driving voltages (Eₐₚₚₗ) under mild conditions (pH 7, 30° C.). The combination of these electrocatalysts with H₂-oxidizing microbes yields CO₂ reduction efficiencies (η_{elec,CO2}) up to ˜50% (24). The modular design of this renewable synthesis platform may be leveraged beyond fuel production, toward more complex reactions such as the nitrogen reduction reaction (NRR), as well as cultivation of living whole-cell biofertilizers depending on the specific synthetic capabilities of the microorganism. This design flexibility is exploited to perform the efficient synthesis of NH₃ from N₂ and H₂O by driving the NRR within the H₂-oxidizing, autotrophic microorganism Xanthobacter autotrophicus. This Gram-negative diazotrophic bacterium can use H₂ under microaerobic conditions (<5% O₂) as its sole energy source to fix CO₂ and N₂ into biomass (25). This experiment further demonstrates that X. autotrophicus functions as a potent electrogenerated biofertilizer, increasing yields of radishes (Raphanus sativus L. var. “Cherry Belle”), a fast-growing model food crop.

When interfaced with CoPᵢ|Co—P water-splitting catalysts (FIG. 1A), X. autotrophicus accumulates fixed N derived from the NRR. An O₂/CO₂/N₂ gas mixture (2/20/78) was maintained in the single-chamber reactor housing the Co—P HER cathode and the CoPᵢ OER anode (FIG. 7). At the beginning of each experiment, X. autotrophicus was inoculated into the organic-free, N-free minimal medium. A constant driving voltage (Eₐₚₚₗ=3.0 V) was applied to the CoPᵢ|Co—P catalyst system, and aliquots from the reactor were periodically sampled for the quantification of biomass (optical density at 600 nm, OD₆₀₀) as well as fixed N (detected by two colorimetric assays (FIG. 8A). The H₂ generated from water splitting provides the biological energy supply for X. autotrophicus to perform the NRR, as well as CO₂ reduction, into biomass without the need for sacrificial reagents (FIG. 2). The amount of faradaic charge passed into water splitting was proportional to biomass accumulation (OD₆₀₀) as well as the total N content in the medium (Nₜₒₜₐₗ) during 5-d experiments (FIG. 2A). No biofilm formation was observed on either electrode. The fixed N was assimilated into biomass as evidenced by no change in the extracellular soluble N content (N_{soluble}). Over the course of the experiment, 72±5 mg L⁻¹ of Nₜₒₜₐₗ, as well as 553±51 mg L⁻¹ of dry cell weight accumulated (n=3, entry 1 in FIG. 2B and Table 1).

In contrast, no accumulation of Ntotal is observed in controls that omit one of the following elements in our experiment: H2 from water splitting, X. autotrophicus, a single-chamber reactor, or a microaerobic environment (entry 2-5 in FIG. 2B and Table 1). The small increases in OD₆₀₀ for entries 4 and 5 in FIG. 2B are likely due to light scattering from the accumulation of poly(3-hydroxybutyrate) (PHB). In the dual-chamber experiment where cathode and anode are separated by an anion-exchange membrane (AEM) (entry 4 in FIG. 2B), the absence of Nₜₒₜₐₗ accumulation is concurrent with an increase of soluble Co2+(as determined by inductively coupled plasma mass spectroscopy, ICP-MS) in the medium from 0.9±0.2 μM to 40±6 μM over the course of 24 h, which approaches the ˜50-μM half-maximum inhibitory concentration (IC50) of X. autotrophicus (FIG. 8B). As the AEM is not permeable to cations including Co2+, its use prevents the redeposition of adventitious Co₂₊ onto the CoPi anode via self-healing, as we have previously described (24, 26), emphasizing the importance of biocompatibility in our system. Open in a separate window

Whole-cell acetylene (C₂H₂) reduction (FIG. 2C) demonstrated high N₂ase activity in X. autotrophicus grown in our hybrid system. This assay provides a measure of the NRR turnover number (TON) by using C₂H₂ as an isoelectronic surrogate of N₂ (25, 27). Aliquots of X. autotrophicus sampled directly from our hybrid system reduced C₂H₂ exclusively to C₂H₄ at a rate of 127±33 μM h⁻¹ OD₆₀₀⁻¹ (n=3), when the whole-cell aliquots were incubated under a C₂H₂/O₂/H₂/CO₂/Ar gas environment (10/2/9/9/70). The measured C₂H₂-reduction activity corresponds to a rate of N₂ fixation at ˜12 mg Nₜₒₜₐₗ L⁻¹·d⁻¹ for cultures of OD₆₀₀=1.0, consistent with the measured Nₜₒₜₐₗ accumulation during the 5-d experiments (entry 1 in FIG. 2B and Table 1). Combining a measured cell density of 3.8±0.7×10⁸ cells mL⁻¹, this C₂H₂-reduction activity translates to an NRR turnover frequency (TOF) of 1.9×10⁴ s⁻¹ per bacterial cell, or roughly ˜4 s⁻¹·N₂ase⁻¹, assuming a N₂ase copy number of about 5,000 (28). The similarity between the measured NRR TOF per N₂ase and the values reported in previous studies (12, 27, 29) indicated that the N₂ases are fully functional in our experiments, highlighting the biocompatibility of the water-splitting catalysts in the CoPᵢ|Co—P|X. autotrophicus hybrid system. The equivalent TON is ˜9×10⁹ bacterial cell⁻¹ and 2×10⁶ N₂ase⁻¹, at least two orders of magnitude higher than that previously reported for synthetic (3-5, 7) and biological (11, 29) catalysts (Table 2).

This hybrid system displays high faradaic efficiency for the NRR. A current of 10-12 mA for 100 mL of X. autotrophicus culture was needed to maintain sufficient microbial growth. This current was achieved with a cell potential of Eₐₚₚₗ=3.0 V (FIG. 8C); this high driving voltage is due to the dilute medium salinity as X. autotrophicus is sensitive to high salt concentrations (25). The contributions of the HER and the OER overpotentials were determined by examining these half-reactions in the low salinity culture medium. FIG. 2D shows the I-V characteristics of the Co—P cathode for the HER vs. the normal hydrogen electrode (NHE). A 12-mA current is achieved for a driving voltage of −0.72 V vs. NHE or at a 0.3-V HER overpotential (η_{HER}) (E_{HER}=−0.41 V at pH=7). Following a similar procedure for the OER half-reaction, we determined that the OER overpotential (η_{OER}) is 0.62 V. As summarized in FIG. 2E, with the measured overpotentials, the contribution of ohmic resistance due to low ionic conductivity is ˜28% of Eₐₚₚₗ (˜0.85 V). Given the standard potential difference between the HER and the NRR (E_{HER}=−0.28 V), the driving force for the NRR by X. autotrophicus is ˜0.43 V, which is lower than the previously reported values that are summarized in Table 2 (3-5, 29, 30). Based on the overall cell potential of 3.0 V, the energy efficiency of NRR (η_{elec,NRR}) is 1.8±0.3% (n=3) for a 5-d experiment (Table 1). Parallel to NRR, X. autotrophicus fixes CO₂ into cellular biomass (FIG. 2A) at a measured η_{elec,CO2}=11.6±1.9% (n=3). The theoretical value of η_{elec,NRR} at Eₐₚₚₗ=3.0 V is 7.5˜11.7% based on the reaction stoichiometry of N₂ase and upstream biochemical pathways. Thus, our observation of η_{elec,NRR}=1.8±0.3% is 15˜23% of the theoretical η_{elec,NRR}. The calculated NRR faradaic efficiency is 4.5%, higher than the faradaic efficiencies or quantum yields of other reported NRR systems (6-11) at ambient conditions (Table 2).

Modeling shows that linear microbial growth may be achieved by controlling the H₂ concentration relative to the Michaelis constant of H₂ase (24). FIG. 2A shows that linear growth conditions may be achieved for X. autotrophicus by balancing the H₂ produced from water splitting and microbial H₂ oxidation. Importantly, the H₂ inhibition constant of N₂ase is Kᵢ(D₂)˜11 kPa (31); the low H₂ partial pressure generated by water splitting (roughly 0.3% or 0.3 kPa H₂, depending on gas flow rate) does not impede N₂ fixation and/or reduce the NRR energy efficiency. When the reactor is pressurized with an external H₂ source, microbial growth is attenuated (FIG. 9A). This contention is illustrated by numerical simulations (FIG. 9B), which show slower biomass accumulation in the case of microbes under high H₂ concentration but linear growth in CoPᵢ|Co—P water splitting. In this regard, the direct hybrid device provides potential benefit, as the generated H₂ from water splitting not only provides cellular energy but also controls metabolic pathways, thus allowing growth conditions to be controlled with fidelity.

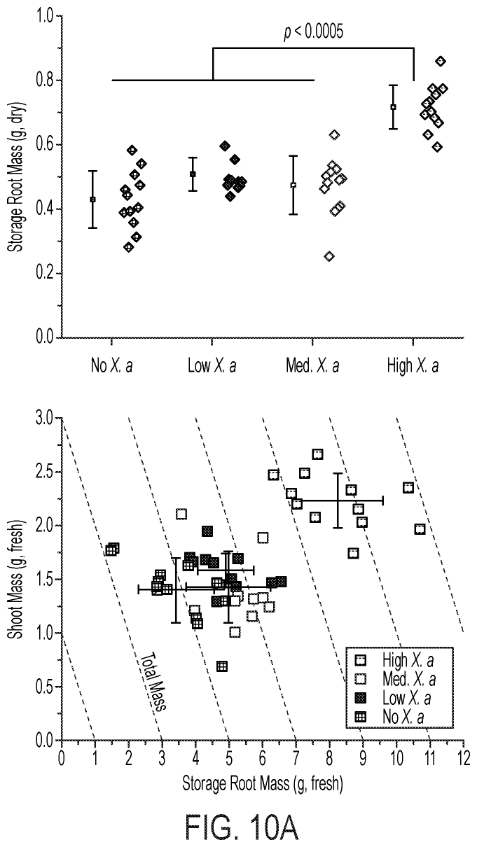

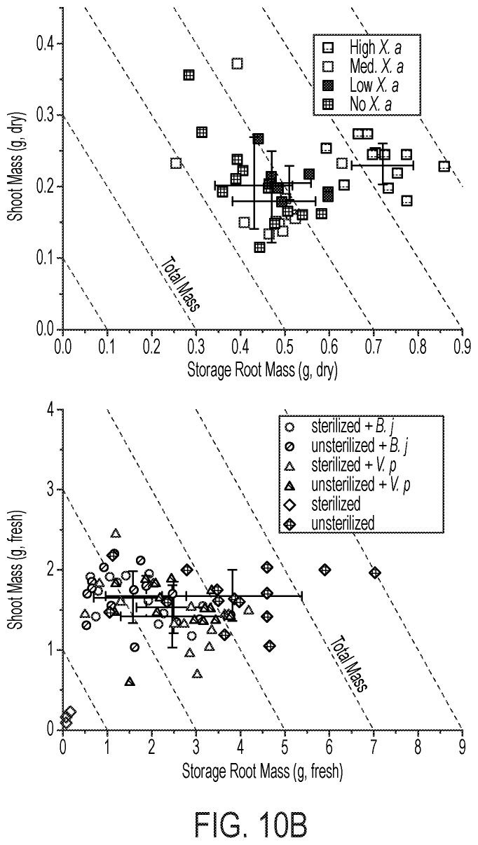

X. autotrophicus cells can be applied directly to promote plant growth and in this regard is, in effect, a living biofertilizer. Cultures of X. autotrophicus were collected, washed, resuspended in 50 mM NaCl saline, and applied to greenhouse radish growth experiments to assess their ability to improve harvest yields (FIG. 5). Increasing amounts of X. autotrophicus, applied weekly, increased edible radish storage root mass by up to ˜130% compared with unfertilized controls from 3.4±1.2 g plant⁻¹ to 8.2±1.4 g plant⁻¹ (n=12 radishes for both) (FIGS. 5A and B, and FIG. 10A), and total mass by up to ˜100% (FIGS. 10B and C). To evaluate a potential mechanism of improving plant growth, in vitro fertilization assays were conducted by suspending X. autotrophicus cells in a 50 mM NaCl solution and measuring extracellular secretion of N and P. Only living cells of X. autotrophicus released NH₄⁺ and PO₄³⁻ over the course of the 7-d experiment, with ethanol-killed controls displaying no or negative nutrient release behavior (FIG. 5C, FIG. 11A, 11B). Under these saline “starvation” conditions, these bacteria maintained ˜50% cell viability, likely metabolizing stored PHB carbon reserves (FIG. 11A) (32, 33), demonstrating their capacity to be self-sustaining even in the absence of external energy inputs. Whereas actively growing X. autotrophicus cells do not secrete N_{soluble} (FIG. 2A), under these starvation conditions, leaky reutilization pathways potentially slowly release N and P from polyglutaminyl-rich cell membranes (34) and polyphosphate granules (32). From this, we contend that living X. autotrophicus cells improve plant growth as a slow-release source of bioavailable N and P, demonstrating the capability of this hybrid inorganic-biological NRR cycle to effectively bridge the gap between atmospheric N₂ and plant biomass.

X. autotrophicus engages in specific plant-microbe and soil microbe-microbe interactions. To study this, the effect of soil microbiome composition on X. autotrophicus biofertilizer performance was evaluated. As-supplied potting media (Promix HP MYCORRHIZAE) contains a plant-growth-promoting fungal inoculant. Reuse of the potting media or sterilization by autoclaving effectively removes these microbial species (FIGS. 11C and D), allowing more direct assessment of radish-X. autotrophicus interactions. Interestingly, reused potting media previously fertilized with X. autotrophicus exhibit a carryover effect, demonstrating that this biofertilizer improves plant yields over multiple planting cycles (FIG. 11E), although comparatively lower yields from cycle 1 to cycle 2 suggest continued biofertilization produces the best radish growth. Radish seeds themselves also carry along native microbial inoculants on their seed coat and can be sterilized by quick treatment with a dilute hypochlorite solution (35). Radish seeds sterilized by this method showed lower growth yields (FIG. 3D) compared with unsterilized controls, attesting to the importance of plant-microbe commensal interactions. Radish seeds preincubated with X. autotrophicus before sowing, in the method of biopriming (35), were able to compensate for the loss of the native radish microbiome, and in fact improve total plant mass by ˜40% compared with unsterilized controls (FIG. 3D). This interaction was found to be somewhat specific to X. autotrophicus as inoculation of sterilized and unsterilized radish seeds with another diazotroph, Bradyrhizobium japonicum [American Type Culture Collection (ATCC) 10324], and a plant-growth-promoting bacterium, Variovorax paradoxus (ATCC 17713) (36), showed similar yields as unsterilized radish seeds (FIG. 4D). To discern the soil microbe-microbe interactions, radish seeds were inoculated with different plant-growth-promoting bacteria, and fertilized weekly with X. autotrophicus cells (FIG. 5E). Uninoculated radish seeds in sterile soil showed poor growth even with X. autotrophicus fertilization, suggesting that biofertilization is most effective in cooperation with preestablished plant-microbe relationships (from biopriming or soil fungal inoculants) to facilitate nutrient uptake. Growth improved upon inoculation with B. japonicum and no significant change was observed with V. paradoxus, although the greatest growth increase was for X. autotrophicus inoculated and fertilized radishes, at an average storage root mass of 6.2±2.7 g plant⁻¹ (n=10) compared with 0.4±0.2 g plant⁻¹ (n=14) for uninoculated controls, an improvement of ˜1,440%. These results suggest that X. autotrophicus not only works as a biofertilizer in conjunction with other members of the soil microbiome (as represented by B. japonicum), but that X. autotrophicus itself engages in a unique plant-growth-promoting mechanism with radishes to realize increased yields. Its function as a soil and seed inoculant in addition to acting as a N and P source positions it as a potential strategy to revive biologically degraded and nonarable soils (21). Further studies will be required to unambiguously define the mechanism of X. autotrophicus-plant interactions.

X. autotrophicus interacts favorably with sustainable abiotic fertilizers. One such natural fertilizer is human urine, which is an attractive alternative soluble N and P fertilizer (37), as well as a potential growth substrate for soil bacteria. X. autotrophicus was found to grow autotrophically in a synthetic defined urine medium (38) diluted to an appropriate ionic concentration (FIG. 11F). This bacterium was also tolerant to the variable loading of N and P associated with their concentration in natural urine sources (FIG. 11G) (39, 40). These results suggest that this biofertilizer is compatible with existing sustainable fertilizers as a potential medium for X. autotrophicus cultivation and in-soil propagation. As observed for other soil bacteria (15), the ability of X. autotrophicus to transform the labile N and P in urine into stable, slow-release forms is an intriguing prospect for future longitudinal field studies (20).

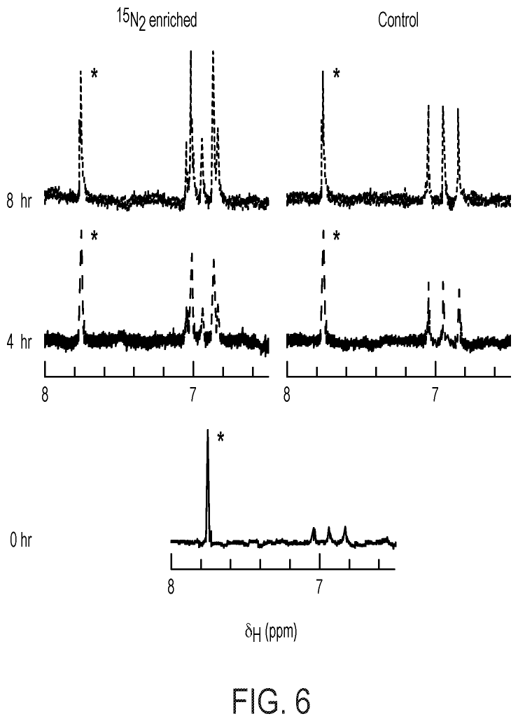

In addition to fixing N₂ in the form of soluble biomass, the hybrid device can be induced to excrete synthesized NH₃ directly into the extracellular medium. Genome sequencing of the strain of X. autotrophicus used here (Table 3) indicates that the NH₃ generated from N₂ase is incorporated into biomass via a two-step process mediated by glutamine synthetase (GS) and glutamate synthase (GOGAT) (FIG. 3), as is consistent with previous biochemical assays (41). If the functionality of this NH₃ assimilation pathway is disrupted, direct production of extracellular NH₃ should occur. Noting that GS inhibitors can induce NH₃ secretion in sugar-fermenting diazotrophs (14), we turned to the specific GS inhibitor phosphinothricin (PPT) (42) to block the NH₃ assimilation pathway and allow NH₃ to passively diffuse out into the extracellular medium (pathway 2 in FIG. 1 and FIG. 3). After adding a sufficiently high concentration of phosphinothricin (50 μM) to inhibit GS (42), the biomass accumulation of X. autotrophicus slows, while Nₜₒₜₐₗ and the concentration of free NH₃ in the solution (N_{NH3}) continues to increase (FIG. 4), indicating that N₂ fixation after phosphinothricin addition is in the form of extracellular NH₃. ¹⁵N isotope labeling experiments confirm that the generated NH₃ is from N₂ (FIG. 6). After exposing the microbes to ¹⁵N-enriched N₂, the intensity of the ¹⁵NH₄⁺ doublet peaks (6.91 ppm, J¹_{NH}=72.7 Hz) in the ¹H NMR spectrum of the supernatant monotonically increases. This ¹⁵NH₄⁺ signal is not detectable in control samples under N₂ of natural abundance; the ¹H NMR exhibits only the triplet signal of ¹⁴NH₄⁺ (6.95 ppm, J¹_{NH}=50.0 Hz). The concentration of N in NH₃ (N_{NH3}) after terminating the experiment was 11±2 mg L⁻¹ (˜0.8 mM) and the accumulated Nₜₒₜₐₗreached 47±3 mg L⁻¹ (n=3, Table 1). The rate of N₂ fixation decreases in the latter phase of experiment due to down-regulation at transcriptional and posttranscriptional levels (43).

This experiment demonstrates the synthesis of solid N biomass and NH₃ from N₂, driven by water splitting at appreciable TON and TOF, under ambient conditions. By driving water splitting with solar energy and renewable electricity, the approach can potentially provide a renewable synthesis platform for the NRR. The experiment demonstrates that the production of NH₃ and X. autotrophicus biofertilizer allows this hybrid inorganic-biological NRR system to effectively connect atmospheric N₂ to plant biomass. The hybrid inorganic-biological approach illustrated for the NRR may be generalized to a renewable biological and chemical synthesis platform, depending on the biomachinery to which water splitting is coupled.

### Other Embodiments

The foregoing has been a description of certain non-limiting embodiments of the invention. Those of ordinary skill in the art will appreciate that various changes and modifications to this description may be made without departing from the spirit or scope of the present invention, as defined in the following claims.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

### REFERENCES

The following references are cited in the specification and/or the Examples and are incorporated herein by reference in their entireties.
1. Smil V. Detonator of the population explosion. Nature. 1999; 400:415.
2. Tilman D, Cassman K G, Matson P A, Naylor R, Polasky S. Agricultural sustainability and intensive production practices. Nature. 2002; 418:671-677.
3. Yandulov D V, Schrock R R. Catalytic reduction of dinitrogen to ammonia at a single molybdenum center. Science. 2003; 301:76-78.
4. Arashiba K, Miyake Y, Nishibayashi Y. A molybdenum complex bearing PNP-type pincer ligands leads to the catalytic reduction of dinitrogen into ammonia. Nat Chem. 2011; 3:120-125.
5. Anderson J S, Rittle J, Peters J C. Catalytic conversion of nitrogen to ammonia by an iron model complex. Nature. 2013; 501:84-87.
6. Lan R, Irvine J T S, Tao S. Synthesis of ammonia directly from air and water at ambient temperature and pressure. Sci Rep. 2013; 3:1145.
7. Liu J, et al. Nitrogenase-mimic iron-containing chalcogels for photochemical reduction of dinitrogen to ammonia. Proc Natl Acad Sci USA. 2016; 113:5530-5535.
8. Zhu D, Zhang L, Ruther R E, Hamers R J. Photo-illuminated diamond as a solid-state source of solvated electrons in water for nitrogen reduction. Nat Mater. 2013; 12:836-841.
9. Oshikiri T, Ueno K, Misawa H. Selective dinitrogen conversion to ammonia using water and visible light through plasmon-induced charge separation. Angew Chem Int Ed Engl. 2016; 55:3942-3946.
10. Ali M, et al. Nanostructured photoelectrochemical solar cell for nitrogen reduction using plasmon-enhanced black silicon. Nat Commun. 2016; 7:11335.
11. Brown K A, et al. Light-driven dinitrogen reduction catalyzed by a CdS:nitrogenase MoFe protein biohybrid. Science. 2016; 352:448-450.
12. Milton R D, et al. Nitrogenase bioelectrocatalysis: Heterogeneous ammonia and hydrogen production by MoFe protein. Energy Environ Sci. 2016; 9:2550-2554.
13. Shanmugam K T, Valentine R C. Microbial production of ammonium ion from nitrogen. Proc Natl Acad Sci USA. 1975; 72:136-139.
14. Ortiz-Marquez J C F, Do Nascimento M, Curatti L. Metabolic engineering of ammonium release for nitrogen-fixing multispecies microbial cell-factories. Metab Eng. 2014; 23:154-164.
15. Chaparro J M, Sheflin A M, Manter D K, Vivanco J M. Manipulating the soil microbiome to increase soil health and plant fertility. Biol Fertil Soils. 2012; 48:489-499.
16. Tilman D, Balzer C, Hill J, Befort B L. Global food demand and the sustainable intensification of agriculture. Proc Natl Acad Sci USA. 2011; 108:20260-20264.
17. Carvalho T L G, Balsemão-Pires E, Saraiva R M, Ferreira P C G, Hemerly A S. Nitrogen signalling in plant interactions with associative and endophytic diazotrophic bacteria. J Exp Bot. 2014; 65:5631-5642.
18. Rudrappa T, Czymmek K J, Paré P W, Bais H P. Root-secreted malic acid recruits beneficial soil bacteria. Plant Physiol. 2008; 148:1547-1556.
19. Rodriguez R J, et al. Stress tolerance in plants via habitat-adapted symbiosis. ISME J. 2008; 2:404-416.
20. Mäder P, et al. Soil fertility and biodiversity in organic farming. Science. 2002; 296:1694-1697.
21. Wubs E R J, van der Putten W H, Bosch M, Bezemer T M. Soil inoculation steers restoration of terrestrial ecosystems. Nat Plants. 2016; 2:16107.
22. Kramer C, Gleixner G. Variable use of plant- and soil-derived carbon by microorganisms in agricultural soils. Soil Biol Biochem. 2006; 38:3267-3278.
23. Torella J P, et al. Efficient solar-to-fuels production from a hybrid microbial-water-splitting catalyst system. Proc Natl Acad Sci USA. 2015; 112:2337-2342.
24. Liu C, Colón B C, Ziesack M, Silver P A, Nocera D G. Water splitting-biosynthetic system with CO₂ reduction efficiencies exceeding photosynthesis. Science. 2016; 352:1210-1213.
25. Malik K A, Schlegel H G. Enrichment and isolation of new nitrogen-fixing hydrogen bacteria. FEMS Microbiol Lett. 1980; 8:101-104.
26. Bediako D K, Ullman A M, Nocera D G. Catalytic oxygen evolution by cobalt oxido thin films. Top Curr Chem. 2016; 371:173-213.
27. Hoffman B M, Lukoyanov D, Yang Z-Y, Dean D R, Seefeldt L C. Mechanism of nitrogen fixation by nitrogenase: The next stage. Chem Rev. 2014; 114:4041-4062.
28. Schneider K, et al. The molybdenum nitrogenase from wild-type Xanthobacter autotrophicus exhibits properties reminiscent of alternative nitrogenases. Eur J Biochem. 1995; 230:666-675.
29. Danyal K, et al. Uncoupling nitrogenase: Catalytic reduction of hydrazine to ammonia by a MoFe protein in the absence of Fe protein-ATP. J Am Chem Soc. 2010; 132:13197-13199.
30. Kuriyama S, et al. Catalytic formation of ammonia from molecular dinitrogen by use of dinitrogen-bridged dimolybdenum-dinitrogen complexes bearing PNP-pincer ligands: Remarkable effect of substituent at PNP-pincer ligand. J Am Chem Soc. 2014; 136:9719-9731.
31. Guth J H, Burris R H. Inhibition of nitrogenase-catalyzed NH₃ formation by H₂. Biochemistry. 1983; 22:5111-5122.
32. Wiegel J, Wilke D, Baumgarten J, Opitz R, Sschlegel H G. Transfer of the nitrogen-fixing hydrogen bacterium Corynebacterium autotrophicum Baumgarten et al. to Xanthobacter gen. nov. Int J Syst Bacteriol. 1978; 28:573-581.
33. Trainer M A, Charles T C. The role of PHB metabolism in the symbiosis of rhizobia with legumes. Appl Microbiol Biotechnol. 2006; 71:377-386.
34. Kandler O, König H, Wiegel J, Claus D. Occurrence of poly-γ-D-glutamic acid and poly-α-L-Glutamine in the genera Xanthobacter, Flexithrix, Sporosarcina and Planococcus. Syst Appl Microbiol. 1983; 4:34-41.
35. Mahmood A, Turgay O C, Farooq M, Hayat R. 2016. Seed biopriming with plant growth promoting rhizobacteria: A review FEMS Microbiol Ecol 92: fiw112 10.1093/femsec/fiw112.
36. Satola B, Wiibbeler J H, Steinbüchel A. Metabolic characteristics of the species Variovorax paradoxus. Appl Microbiol Biotechnol. 2013; 97:541-560.
37. Heinonen-Tanski H, van Wijk-Sijbesma C. Human excreta for plant production. Bioresour Technol. 2005; 96:403-411.
38. Anderson M S, Ewert M K, Keener J F, Wagner S A, editors. Life Support Baseline Values and Assumptions Document. NASA; Houston: 2015. Tech Rep NASA/TP-2015-218570, Document ID 20150002905.
39. Wydeven T, Golub M A. Generation Rates and Chemical Compositions of Waste Streams in a Typical Crewed Space Habitat. NASA, Moffett Field; CA: 1990. Tech Rep NASA/TM-102799, Document ID 19900019017.
40. Rose C, Parker A, Jefferson B, Cartmell E. The characterization of feces and urine: A review of the literature to inform advanced treatment technology. Crit Rev Environ Sci Technol. 2015; 45:1827-1879.
41. Murrell J C, Lidstrom M E. Nitrogen metabolism in Xanthobacter H4-14. Arch Microbiol. 1983; 136:219-221.
42. Gill H S, Eisenberg D. The crystal structure of phosphinothricin in the active site of glutamine synthetase illuminates the mechanism of enzymatic inhibition. Biochemistry. 2001; 40:1903-1912.
43. Dixon R, Kahn D. Genetic regulation of biological nitrogen fixation. Nat Rev Microbiol. 2004; 2:621-631.

What is claimed is:

1. A method of producing a biofertilizer in a bioreactor, comprising:
(a) generating H₂ in a bioreactor comprising one or more microorganisms which express a hydrogenase and a nitrogenase, wherein the bioreactor further comprises a source of N₂ and CO₂; and
(b) growing the one or more microorganisms in the bioreactor in culture media in the presence of the H₂ to produce a biofertilizer.

2. The method of claim 1, wherein the one or more microorganisms couple hydrogenase-dependent H₂-oxidation with nitrogenase-dependent N₂ fixation to form NH₃.

3. The method of claim 2, wherein the one or more microorganisms assimilate the NH₃ into biomass intracellularly by glutamine synthetase.

4. The method of claim 2, further comprising the step of inhibiting glutamine synthetase, thereby inhibiting the assimilation of NH₃ into biomass.

5. The method of claim 4, wherein the NH₃ accumulates extracellularly in the bioreactor culture media.

6. The method of claim 1, wherein the one or more microorganisms couple hydrogenase-dependent H₂-oxidation with CO₂ reduction through a carbon fixation pathway.

7. The method claim 1, wherein the biofertilizer comprises a microbial biomass.

8. The method of claim 1, wherein the biofertilizer comprises a microbial biomass and culture media.

9. The method of claim 1, wherein the biofertilizer is enriched with ammonia and/or a carbon energy source.

10. The method of claim 1, wherein the one or more microorganisms accumulate a carbon energy source.

11. The method of claim 10, wherein the carbon energy source is polyhydroxybutyric acid (PHB).

12. The method of claims 7 or 8, wherein the microbial biomass is a liquid microbial suspension.

13. The method of claims 7 or 8, wherein the microbial biomass is a solid microbial biomass.

14. The method of claim 1, wherein the bioreactor is a single or a multi-chamber bioreactor.

15. The method of claim 1, wherein the one or more microorganisms are of a single type.

16. The method of claim 1, wherein the one or more microorganisms are of two or more types.

17. The method of claim 1, wherein the hydrogenase and a nitrogenase are expressed from the same microorganism cell.

18. The method of claim 1, wherein the hydrogenase and a nitrogenase are expressed from different microorganism cells.

19. The method of claim 1, wherein the biofertilizer comprises X. autotrophicus.

20. The method of claim 1, wherein the one or more microorganisms comprise bacteria.

21. The method of claim 1, wherein the one or more microorganisms comprise archea.

22. The method of claim 1, wherein the one or more microorganisms comprise fungi.

23. The method of claim 1, wherein the biofertilizer comprises one or more of Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

24. The method of claim 1, wherein the N₂ and CO₂ are obtained from the environment.

25. The method of claim 1, wherein the bioreactor comprises a means to obtain the N₂ and CO₂ from the environment.

26. The method of claim 1, wherein the step of generating H₂ in the bioreactor is by water-splitting.

27. The method of claim 26, wherein the water-splitting is powered by electricity.

28. The method of claim 26, wherein the water-splitting is powered by renewable electricity.

29. The method of claim 26, wherein the water-splitting is powered by solar-based electricity.

30. The method of claim 1, wherein bioreactor comprises an anode and a cathode capable of catalyzing water-splitting.

31. The method of claim 30, wherein the anode is an oxygen evolving electrode (OER).

32. The method of claim 30, wherein the cathode is a hydrogen evolving electrode (HER).

33. The method claim 30, wherein the anode and/or the cathode are coated with a catalyst.

34. The method of claim 33, wherein the catalyst is capable of minimizing the production of reactive oxygen species (ROS) during water-splitting.

35. The method of claim 30, wherein the cathode comprises a cobalt-phosphorous (Co—P) alloy catalyst.

36. The method of claim 30, wherein the anode comprises a cobalt-phosphate (Co—Pi) catalyst.

37. The method of claim 1, wherein the bioreactor comprises electrodes comprising Co—Pi and Co—P water-splitting catalysts.

38. The method of claim 4, wherein the glutamine synthetase is inhibited by an inhibitor.

39. The method of claim 38, wherein the inhibitor is methionine sulfoximine or phosphinothricin.

40. The method of claim 1, further comprising the step of obtaining the biomass for use as a biofertilizer.

41. A biofertilizer prepared by the method of claim 1.

42. The biofertilizer of claim 41, wherein the biofertilizer is a liquid suspension.

43. A method of enriching a soil microbiome comprising contacting a soil microbiome with a biofertilizer prepared by the method of claim 1.

44. The method of claim 43, comprising mixing the biofertilizer with soil.

45. The method claim 43, further comprising contacting the soil microbiome with a PHB-producing bacteria.

46. The method of claim 45, wherein the PHB-producing bacteria is R. eutropha.

47. The method of claim 43, further comprising contacting the soil microbiome with a microorganism which expresses both a nitrogenase and accumulates PHB.

48. The method of claim 47, wherein the microorganism is X. autotrophicus.

49. A method of increasing the yield of a crop grown in soil, comprising treating the soil with a biofertilizer prepared by the method of claim 1.

50. The method of claim 49, comprising mixing the soil with the biofertilizer.

51. The method claim 49, further comprising contacting the soil with a PHB-producing bacteria.

52. The method of claim 51, wherein the PHB-producing bacteria is R. eutropha.

53. The method of claim 49, wherein the method results in one or more enhanced plant characteristic as compared to crop growth without the treatment.

54. The method of claim 49, further comprising contacting the soil microbiome with a microorganism which expresses both a nitrogenase and accumulates PHB.

55. The method of claim 54, wherein the microorganism is X. autotrophicus.

56. The method of claim 49, wherein the crop is wheat, corn, soybean, rice, potatoes, sweet potatoes, cassava, sorghum, yams, or plantains.

57. A system for generating a biofertilizer, comprising a bioreactor, culture medium, a source of H₂ generated by water-splitting, and a culture of one or more microorganisms which express a hydrogenase and a nitrogenase and are capable of metabolically coupling H₂-oxidation with nitrogen-fixation to produce NH₃.

58. The system of claim 57, wherein the source of H₂ generated by water-splitting is generated by renewable electricity.

59. The system of claim 58, wherein the renewable electricity is provided by solar power.

60. The system of claim 57, wherein the H₂ is generated by a water-splitting device comprising a least one pair of hydrogen-splitting electrodes and a source of solar-generated electricity.

61. The system of claim 60, wherein the electricity comprises a voltage of at least between 0.1 V and 0.2 V, 0.4 V, 0.8 V, 1.0 V, 2.0 V, 3.0 V, 4.0 V, 5.0 V, 6.0 V, 7.0 V, 8.0 V, 9.0 V, 10.0 V, 20.0 V, 30.0 V, 40.0 V, 50.0 V, 60.0 V, 70.0 V, 80.0 V, 90.0 V, and 100.0 V.

62. The system of claim 57, wherein the one or more microorganisms comprises X. autotrophicus.

63. The system of claim 57, wherein the one or more microorganisms comprises one or more of Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

64. The system of claim 57, wherein the NH₃ is produced intracellularly and assimilates into biomass.

65. The system of claim 57, further comprising an inhibitor of glutamine synthetase.

66. The system of claim 65, wherein the NH₃ accumulates extracellular in the culture media.

67. The system of claim 57, wherein the bioreactor further comprises a source of N₂ and CO₂.

68. The system of claim 57, wherein the one or more microorganisms undergo growth in the bioreactor to form a biomass.

69. The system of claim 68, wherein the biomass is a microbial liquid suspension.

70. The system of claim 68, wherein the biomass is a solid biomass.

71. A biofertilizer comprising an effective amount of X. autotrophicus for enhancing a soil microbiome.

72. The biofertilizer of claim 71, further comprising a PHB-producing microorganism.

73. A biofertilizer comprising an effective amount of X. autotrophicus for increasing crop yields and optionally one or more of the following microorganisms selected from the group consisting of: Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclusspecies, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, and a different Xanthobacter species.

74. The biofertilizer of claim 71, further comprising a PHB-producing microorganism.

75. A plant seed comprising a coating of an effective amount of X. autotrophicus and optionally one or more of the following microorganisms selected from the group consisting of: Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, and a different Xanthobacter species.

76. A plant seed comprising a coating of an effective amount of a biofertilizer prepared in accordance with claim 1.

77. The plant seed of claims 75 or 76, wherein the plant seed is a radish plant seed.

78. The plant seed of claim 76, wherein the plant seed is a wheat, corn, soybean, rice, potato, sweet potato, cassava, sorghum, yams, radish, or plantain plant seed.

79. A method for improving crop yield comprising preincubating a plant seed with an effective amount of X. autotrophicus before sowing the plant seed.

80. A method for improving crop yield comprising preincubating a plant seed with an effective amount of a biofertilizer produced in accordance with the method of claim 1 before sowing the plant seed.

81. An engineered soil for growing plants or crops comprising naturally-occurring soil mixed with a biofertilizer comprising X. autotrophicus and optionally one or more of the following microorganisms selected from the group consisting of: Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, and a different Xanthobacter species.

82. An engineered soil for growing plants or crops comprising naturally-occurring soil mixed with a biofertilizer comprising Acidiphilium species, Acidiphilium multivorum, Alcaligenes species, Alcaligenes paradoxus, Arthrobacter species, Azohydromonas species, Azohydromonas australica, Azohydromonas species, Azohydromonas lata, Azospirillum species, Azospirillum amazonsense, Azospirillum lipoferum, Azospirillum lipoferum, Azospirillum thiophilum, Azospirillum thiophilum, Beggiatoa species, Beggiatoa alba, Beijerinckia species, Beijerinckia mobilis, Bradyrhizobium species, Bradyrhizobium elnakii, Bradyrhizobium japonicum, Bradyrhizobium japonicum (strain USDA 122), Burkholderia species, Burkholderia vietnameiensis, Cupriavidus species, Cupriavidus necator, Derxia species, Derxia gummosa, Herbaspirillum species, Herbaspirillum autrotrophicum, Hydrogenophaga species, Hydrogenophaga pseudoflava, Mesorhizobium species, Mesorhizobium alhagi, Methylibium species, Methylibium petroleiphilum, Methylocapsa species, Methylocapsa aurea, Methyloferula species, Methyloferula stellate, Methyloversatilis species, Methyloversatilis universalis, Microcyclus species, Microcyclus aquaticus, Microcyclus species, Microcyclus ebruneus, Nitrosococcus species, Nitrosococcus oceani, Nitrosomonas communis, Nitrospirillum amazonense, Nocardia species, Nocardia autotrophica, Nocardia opaca, Oligotropha species, Oligotropha carboxidovorans, Pannonibacter species, Pannonibacter phragmitetus, Paracoccus species, Paracoccus denitrificans, Paracoccus pantrophus, Paracoccus yeei, Pelagibaca species, Pelagibaca bermudensis, Pseudomonas species, Pseudomonas facilis, Pseudooceanicola species, Pseudooceanicola atlanticus, Ralstonia species, Ralstonia eutropha, Renobacter species, Renobacter vacuolatum, Rhizobium species, Rhizobium gallicum, Rhizobium japonicum, Rhodobacter species, Rhodobacter capsulatus, Rhodobacter sphaeroides, Rhodomicrobium species, Rhodomicrobium vannielii, Rubrivivax species, Rubrivivax gelatinosus, Salipiger species, Salipiger mucosus, Sinorhizobium species, Sinorhizobium americanum, Sinorhizobium fredii, Sinorhizobium meliloti, Skermanella species, Skermanella stibiiresistens, Stappia species, Stappia aggregate, Thauera species, Thauera humireducens, Variovorax species, Variovorax paradoxus, Xanthobacter species, and Xanthobacter autotrophicus, and any combinations thereof.

83. An engineered soil for growing plants or crops comprising naturally-occurring soil mixed with a biofertilizer obtained from the method of claim 1.

84. The engineered soil of claims 81, 82, or 83 further comprising R. eutropha or another PHB-producing microorganism.
